(19) United States
(12) Patent Application Publication
(10) Pub. No.: US 2026/0029624 A1
(43) Pub. Date: Jan. 29, 2026

(54) OPTICAL SYSTEM AND CAMERA MODULE

(71) Applicant: NINGBO SUNNY OPOTECH CO., LTD., Ningbo City (CN)

(72) Inventors: Meishan Guo, Ningbo City (CN); Yu Wu, Ningbo City (CN); Takehiko Tanaka, Ningbo City (CN); Liguo Liu, Ningbo City (CN); Hansheng Cen, Ningbo City (CN); Tongji Jiang, Ningbo City (CN); Haipeng Pei, Ningbo City (CN); Anan Wu, Ningbo City (CN); Hao Zhang, Ningbo City (CN); Hang Yu, Ningbo City (CN); Xiuxiu Zhou, Ningbo City (CN); Yuxiang Wang, Ningbo City (CN); Dandan Ge, Ningbo City (CN); Xipu Dong, Ningbo City (CN)

(21) Appl. No.: 18/979,547

(22) Filed: Dec. 12, 2024

(30) Foreign Application Priority Data
Jul. 23, 2024 (CN) 202410990534.7

(51) Int. Cl. G02B 13/00; G02B 7/02; G02B 15/14; G03B 17/17

(52) U.S. Cl. CPC G02B 13/0065; G02B 7/021; G02B 13/009; G02B 15/142; G03B 17/17

(57) ABSTRACT

An optical system and a camera module are provided. In an implementation, the optical system, along an optical axis from an object side to an image side sequentially includes, a first element group and a second element group. The first element group includes a first lens having positive refractive power, the first lens is configured to converge incident light propagating along a first optical axis; and a reflective element configured to redirect the light emitting from the first lens from propagating along the first optical axis to propagating along a second optical axis. The second element group comprises at least one lens arranged sequentially from the object side to the image side along the second optical axis. The optical system satisfies: 1.7<f1/FG2<2.5, wherein f1 is an effective focal length of the first lens, and FG2 is an effective focal length of the second element group.

### CROSS-REFERENCE TO RELATED APPLICATIONS

This application claims the priority from Chinese Patent Application No. 202410990534.7, filed in the National Intellectual Property Administration (CNIPA) on Jul. 23, 2024, the contents of which are hereby incorporated by reference in their entirety.

### TECHNICAL FIELD

The present disclosure relates to the field of optical devices, in particular to an optical system and a camera module.

### BACKGROUND

With the rapid development of portable devices such as smartphones, telephoto lens assemblies have been widely used due to their advantages such as clear imaging of distant objects, providing high magnification, or presenting detailed features of objects.

The effective focal length of an optical system is an important criterion for determining whether the optical system is a telephoto lens assembly. The larger the effective focal length of the optical system, the clearer the distant objects photographed by the optical system. However, the effective focal length of the optical system is directly proportional to an optical path length required by the optical system, i.e., the larger the effective focal length of the optical system, the greater the optical path length required by the optical system. Therefore, in order to achieve the telephoto characteristic of the optical system, a total length of the existing optical systems is usually large, which may severely limit application of the optical systems in portable devices.

### SUMMARY

An aspect of the present disclosure provides an optical system, including a first element group and a second element group. The first element group includes a first lens having a positive refractive power, and a reflective element. The first lens is used to converge incident light propagating along a first optical axis, and the reflective element is used to redirect the light emitting from the first lens from propagating along the first optical axis to propagating along a second optical axis, the light remaining in a converged state after being reflected by the reflective element. The second element group has a positive refractive power, and includes at least one lens arranged sequentially from the object side to the image side along the second optical axis. Here, the optical system satisfies: 1.7<f1/FG2<2.5, wherein f1 is an effective focal length of the first lens, and FG2 is an effective focal length of the second element group.

According to an implementation of the present disclosure, there is a spacing distance along the first optical axis between the first lens and the reflective element.

According to an implementation of the present disclosure, the first element group further comprises a second lens having a negative refractive power, the second lens is located on the second optical axis and disposed between the reflective element and the second element group, and the second lens is configured to diverge the light propagating along the second optical axis.

ing to an implementation of the present disclosure, there is a spacing distance along the second optical axis between the second lens and the reflective element.

According to an implementation of the present disclosure, the optical system satisfies: Tan(FOV/2)<0.38, where, FOV is a maximal field-of-view of the optical system 10.

According to an implementation of the present disclosure, the optical system satisfies: 3.0<D1/CT1<6.0, where, D1 is a maximal effective half diameter of the first lens, and CT1 is a center thickness of the first lens on the optical axis.

According to an implementation of the present disclosure, the optical system satisfies: 3.0<FG1/EFL<5.0, where, FG1 is an effective focal length of the first element group G1, and EFL is an effective focal length of the optical system.

According to an implementation of the present disclosure, the optical system satisfies: 2.5<FG1/FG2<4.5, where, FG1 is the effective focal length of the first element group, and FG2 is the effective focal length of the second element group.

According to an implementation of the present disclosure, the optical system satisfies: 7.5 mm<EFL/(FG1/FG2)<11.5 mm, where, FG1 is the effective focal length of the first element group, FG2 is the effective focal length of the second element group, and EFL is the effective focal length of the optical system.

According to an implementation of the present disclosure, the optical system satisfies: 0.04 mm⁻¹<D2x/EPDx/d12<0.12 mm⁻¹, where, D2x is a maximal effective half diameter of the second lens in the first direction, EPDx is an entrance pupil diameter of the optical system in the first direction, and d12 is an on-axis distance from the image-side surface of the first lens to the object-side surface of the second lens.

According to an implementation of the present disclosure, the optical system satisfies: 0.04 mm⁻¹<D2y/EPDy/d12<0.12 mm⁻¹, where, D2y is a maximal effective half diameter of the second lens in the second direction, EPDy is an entrance pupil diameter of the optical system in the second direction, and d12 is the on-axis distance from the image-side surface of the first lens to the object-side surface of the second lens.

According to an implementation of the present disclosure, the optical system satisfies: −0.15<fs1/fs2<0.8, where, fs1 is an effective focal length of the object-side surface of the first lens, and fs2 is an effective focal length of the image-side surface of the first lens.

According to an implementation of the present disclosure, the optical system satisfies: 0.5<EFL/SL<0.7, where, EFL is the effective focal length of the optical system, and SL is a total length of the optical system along the direction of a preset principle optical axis.

According to an implementation of the present disclosure, the optical system satisfies: OBJmin≥15.0 cm, where OBJmin is a minimal value of an object distance of the optical system.

According to an implementation of the present disclosure, the first element group is fixed in a position relative to an image plane disposed on the image side, and a distance between the second element group and the first element group on the optical axis is adjustable, enabling the optical system to switch between a first state and a second state.

According to an implementation of the present disclosure, the second element group comprises a third lens having a positive refractive power, a fourth lens having a negative refractive power, a fifth lens having a positive refractive power, a sixth lens having a positive refractive power, and a seventh lens having a negative refractive power.

According to an implementation of the present disclosure, the optical system further comprises a lens barrel assembly, the lens barrel assembly comprises a first lens barrel and a second lens barrel, the first element group is fixed within the first lens barrel, and the second element group is fixed within the second lens barrel; during focusing of the optical system, the first lens barrel and the first element group are fixed in a position on the second optical axis relative to an image plane, and the second lens barrel and the second element group move along the second optical axis towards a direction close to or away from the first element group.

According to an implementation of the present disclosure, the optical axis comprises the first optical axis and the second optical axis, the first optical axis is at a preset angle to the second axis.

Another aspect of the present disclosure provides a camera module, including the above optical system and an imaging element for converting an optical image formed by the optical system into an electrical signal.

### BRIEF DESCRIPTION OF THE DRAWINGS

After reading detailed descriptions of non-limiting embodiments given with reference to the following accompanying drawings, other features, objectives and advantages of the present disclosure will become more apparent.

FIG. 1 illustrates a schematic structural diagram of an optical system according to an embodiment of the present disclosure;

FIG. 2 illustrates a schematic structural diagram of an optical system in a first state according to Embodiment 1 of the present disclosure;

FIG. 3 illustrates a schematic structural diagram of the optical system in a second state according to Embodiment 1 of the present disclosure;

FIG. 4A, FIG. 4B and FIG. 4C respectively illustrate a longitudinal aberration curve, an astigmatic curve and a distortion curve of the optical system in the first state according to Embodiment 1 of the present disclosure;

FIG. 5 illustrates a schematic structural diagram of an optical system in a first state according to Embodiment 2 of the present disclosure;

FIG. 6 illustrates a schematic structural diagram of the optical system in a second state according to Embodiment 2 of the present disclosure;

FIG. 7A, FIG. 7B and FIG. 7C respectively illustrate a longitudinal aberration curve, an astigmatic curve and a distortion curve of the optical system in the first state according to Embodiment 2 of the present disclosure;

FIG. 8 illustrates a schematic structural diagram of an optical system in a first state according to Embodiment 3 of the present disclosure;

FIG. 9 illustrates a schematic structural diagram of the optical system in a second state according to Embodiment 3 of the present disclosure;

FIG. 10A, FIG. 10B and FIG. 10C respectively illustrate a longitudinal aberration curve, an astigmatic curve and a distortion curve of the optical system in the first state according to Embodiment 3 of the present disclosure;

FIG. 11 illustrates a schematic structural diagram of an optical system in a first state according to Embodiment 4 of the present disclosure;

FIG. 12 illustrates a schematic structural diagram of the optical system in a second state according to Embodiment 4 of the present disclosure;

FIG. 13A, FIG. 13B and FIG. 13C respectively illustrate a longitudinal aberration curve, an astigmatic curve and a distortion curve of the optical system in the first state according to Embodiment 4 of the present disclosure;

FIG. 14 illustrates a schematic structural diagram of an optical system in a first state according to Embodiment 5 of the present disclosure;

FIG. 15 illustrates a schematic structural diagram of the optical system in a second state according to Embodiment 5 of the present disclosure;

FIG. 16A, FIG. 16B and FIG. 16C respectively illustrate a longitudinal aberration curve, an astigmatic curve and a distortion curve of the optical system in the first state according to Embodiment 5 of the present disclosure;

FIG. 17 illustrates a schematic structural diagram of an optical system in a first state according to Embodiment 6 of the present disclosure;

FIG. 18 illustrates a schematic structural diagram of the optical system in a second state according to Embodiment 6 of the present disclosure;

FIG. 19A, FIG. 19B and FIG. 19C respectively illustrate a longitudinal aberration curve, an astigmatic curve and a distortion curve of the optical system in the first state according to Embodiment 6 of the present disclosure;

FIG. 20 illustrates a schematic structural diagram of an optical system in a first state according to Embodiment 7 of the present disclosure;

FIG. 21 illustrates a schematic structural diagram of the optical system in a second state according to Embodiment 7 of the present disclosure;

FIG. 22A, FIG. 22B and FIG. 22C respectively illustrate a longitudinal aberration curve, an astigmatic curve and a distortion curve of the optical system in the first state according to Embodiment 7 of the present disclosure;

FIG. 23 illustrates a schematic structural diagram of an optical system in a first state according to Embodiment 8 of the present disclosure;

FIG. 24 illustrates a schematic structural diagram of the optical system in a second state according to Embodiment 8 of the present disclosure;

FIG. 25A, FIG. 25B and FIG. 25C respectively illustrate a longitudinal aberration curve, an astigmatic curve and a distortion curve of the optical system in the first state according to Embodiment 8 of the present disclosure;

FIG. 26 illustrates a schematic structural diagram of an optical system in a first state according to Embodiment 9 of the present disclosure;

FIG. 27 illustrates a schematic structural diagram of the optical system in a second state according to Embodiment 9 of the present disclosure;

FIG. 28A, FIG. 28B and FIG. 28C respectively illustrate a longitudinal aberration curve, an astigmatic curve and a distortion curve of the optical system in the first state according to Embodiment 9 of the present disclosure;

FIG. 29 illustrates a schematic structural diagram of an optical system in a first state according to Embodiment 10 of the present disclosure;

FIG. 30 illustrates a schematic structural diagram of the optical system in a second state according to Embodiment 10 of the present disclosure;

FIG. 31A, FIG. 31B and FIG. 31C respectively illustrate a longitudinal aberration curve, an astigmatic curve and a distortion curve of the optical system in the first state according to Embodiment 10 of the present disclosure;

FIG. 32 illustrates a schematic structural diagram of an optical system in a first state according to Embodiment 11 of the present disclosure;

FIG. 33 illustrates a schematic structural diagram of the optical system in a second state according to Embodiment 11 of the present disclosure;

FIG. 34A, FIG. 34B and FIG. 34C respectively illustrate a longitudinal aberration curve, an astigmatic curve and a distortion curve of the optical system in the first state according to Embodiment 11 of the present disclosure;

FIG. 35 illustrates a schematic structural diagram of an optical system in a first state according to Embodiment 12 of the present disclosure;

FIG. 36 illustrates a schematic structural diagram of the optical system in a second state according to Embodiment 12 of the present disclosure; and

FIG. 37A, FIG. 37B and FIG. 37C respectively illustrate a longitudinal aberration curve, an astigmatic curve and a distortion curve of the optical system in the first state according to Embodiment 12 of the present disclosure.

Reference signs: 10, 100, 200, 300, 400, 500, 600, 700, 800, 900, 1000, 1100, 1200: optical system; E1: first lens; E2: second lens; E3: third lens; E4: fourth lens; E5: fifth lens; E6: sixth lens; E7: seventh lens; E8: optical filter; P: reflective element; STO: diaphragm; G1: first element group; G2: second element group; and IMA: image plane.

### DETAILED DESCRIPTION OF EMBODIMENTS

For a better understanding of the present disclosure, various aspects of the present disclosure will be described in more detail with reference to the accompanying drawings. It should be understood that the detailed description is merely an illustration for the exemplary implementations of the present disclosure, rather than a limitation to the scope of the present disclosure in any way. Throughout the specification, the same reference signs designate the same elements.

It should be noted that, in the specification, the expressions such as “first,” “second” and “third” are only used to distinguish one feature from another, rather than represent any limitations to the features. Thus, the first lens discussed below may also be referred to as the second lens or the third lens without departing from the teachings of the present disclosure.

In the accompanying drawings, the thicknesses, sizes and shapes of the lenses are slightly exaggerated for the convenience of explanation. Specifically, the shapes of spherical surfaces or aspheric surfaces shown in the accompanying drawings are shown by examples. That is, the shapes of the spherical surfaces or the aspheric surfaces are not limited to the shapes of the spherical surfaces or the aspheric surfaces shown in the accompanying drawings. The accompanying drawings are merely illustrative and not strictly drawn to scale.

Herein, a paraxial area refers to an area near an optical axis. If a lens surface is a convex surface and the position of the convex surface is not defined, it represents that the lens surface is a convex surface at least at the paraxial area. If the lens surface is a concave surface and the position of the concave surface is not defined, it represents that the lens surface is a concave surface at least at the paraxial area. The surface of each lens closest to the photographed object is referred to as the object-side surface of the lens, and the surface closest to the image plane is referred to as the image-side surface of the lens.

It should be further understood that the terms “comprise,” “comprising,” “having,” “include” and/or “including,” when used in the specification, specify the presence of stated features, elements and/or components, but do not exclude the presence or addition of one or more other features, elements, components and/or combinations thereof. In addition, the use of “may,” when describing implementations of the present disclosure, represents “one or more implementations of the present disclosure.” Also, the terms “exemplary” and/or “example” is intended to refer to an example or illustration.

Unless otherwise defined, all terms (including technical and scientific terms) used herein have the same meaning as commonly understood by those of ordinary skill in the art to which the present disclosure belongs. It should be further understood that terms (e.g., those defined in commonly used dictionaries) should be interpreted as having a meaning that is consistent with their meaning in the context of the relevant art and will not be interpreted in an idealized or overly formal sense unless expressly so defined herein.

It should be noted that implementations in the present disclosure and the features in the implementations may be combined with each other on a non-conflict basis. Implementations of the present disclosure will be described below in detail with reference to the accompanying drawings.

Periscope camera modules are common camera modules for long-distance photographing. For an optical system in a periscope camera module, a prism may be provided. The prism increases an effective focal length of the periscope camera module by refracting the optical path, so that the periscope camera module may meet the requirement for telephoto photographing, while shortening a total length of the periscope camera module, thus achieving miniaturization of the periscope camera module.

Aperture is an important parameter of the periscope camera module, and the aperture may directly affect functions of the periscope camera module such as night scene, snapshot capturing, background blurring, or video recording. For example, a large-aperture periscope camera module may enhance a blurring effect on the background of a photo and highlight the subject, while also increasing a shutter speed and a focusing speed, ensuring that the periscope camera module obtains a good imaging quality.

However, currently the optical system of the periscope camera module still has some deficiencies. Due to limitations on sizes of a light entry surface and a light exit surface of the prism, an area for the prism to receive light is restricted, which leads to small amount of light entering the optical system, and thus a small effective aperture of the optical system, causing the periscope camera module to have problems such as poor darkness effect and poor blurring effect. When the aperture of the periscope camera module becomes larger, the size and weight of the prism increases accordingly, leading to an increase in the size and weight of the periscope camera module. It can be seen that the large aperture requirement for the periscope camera module contradicts the trend towards miniaturization of the periscope camera module.

In addition, the periscope camera module typically achieves an optical image stabilization function by driving the prism to move via a motor. A larger and heavier prism may put forward higher demands on thrust of the motor, and a larger and heavier prism may occupy more space in the periscope camera module, which may result in less space available for the motor, affecting a driving effect of the motor. The dual demands of high driving force and small installation space undoubtedly puts forward higher demands on the motor.

In order to at least partially solve one or more of the above problems as well as other potential problems, embodiments of the present disclosure provide an optical system, in particular, it may reduce a total height and a total length of the optical system while achieving a large aperture, and improve an imaging quality as well as an optical image stabilization performance of the optical system.

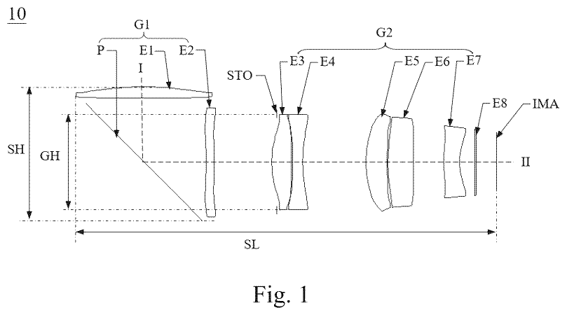

FIG. 1 illustrates a schematic structural diagram of an optical system according to an implementation of the present disclosure. The optical system may, for example, be applied to a camera module, the camera module may, for example, be a periscope camera module. It should be understood that the optical system may also be applied to other camera modules, which is not limited herein.

Referring to FIG. 1, the optical system 10 may sequentially include a first element group G1 and a second element group G2 along an optical axis from an object side to an image side. In an exemplary implementation, the first element group G1 may include a first lens E1 and a reflective element P. In yet another exemplary implementation, the first element group G1 may include a first lens E1, a reflective element P, and a second lens E2. The first lens E1 may have a positive refractive power. The reflective element P may be used to reflect the light emitting from the first lens E1. The second lens E2 may have a negative refractive power. The second element group G2 may include at least one lens. An image plane IMA may be provided on the image side of the optical system 10.

The first lens E1 may converge light, so that the light remains in a converged state after being reflected by the reflective element P, increasing the amount of light entering the second lens E2, thereby enlarging an effective aperture of the optical system 10, and improving an imaging quality of the optical system 10, in addition, it can reduce an optical effective diameter of the lenses within the second element group G2, reduce a shoulder height of the second element group G2, thereby reducing a total height of the optical system 10. The second lens E2 may diverge the light, improving an optical image stabilization performance of the optical system 10.

In an exemplary implementation, referring to FIG. 1, the reflective element P may be set at any desired angle to refract an optical path. The reflective element P may be set to cause a preset degree of deviation (e.g., but not limited to) 90° of the incident optical path, such as changing propagation of the incident optical path from being along a first optical axis (referred to as, optical axis I) to being along a second optical axis (referred to as, optical axis II). It should be understood that the optical axes herein may include the first optical axis and the second optical axis at a preset angle to each other.

In an exemplary implementation, referring to FIG. 1, the reflective element P may be disposed between the first lens E1 and the second lens E2. That is, the first lens E1 may be located on the optical axis I and disposed between the object side and the reflective element P, and the second lens E2 may be located on the optical axis II and disposed between the reflective element P and the second element group G2. The reflective element P may receive the light emitted by the first lens E1 in a direction of the optical axis I, and reflect the light so that the light is emitted in a direction of the optical axis II and entries into the second lens E2. Here, the optical axis I is at a preset angle to the optical axis II, for example, but not limited to, the optical axis I is perpendicular to the optical axis II.

In an exemplary implementation, referring to FIG. 1, the reflective element P may be a planar reflector, and the planar reflector may have a reflective surface. Light emitted by the first lens E1 in the direction of the optical axis I is totally reflected and turned by the reflective surface of the reflective element P, and then entries into the second lens E2 in the direction of the optical axis II. The reflective surface of the reflective element P passes through an intersection of the optical axis I and the optical axis II, i.e., the reflective surface of the reflective element P is located on both the optical axis I and the optical axis II. By adopting a planar reflector of light weight and small size as the reflective element P, the weight and size of the first element group G1 can be constrained within a certain range, minimizing the weight and size of the optical system 10, and reducing a driving burden on the reflective element P, in the case of the optical system 10 achieving a large aperture.

In an exemplary implementation, the first lens E1 may be used to converge light. By enabling the first lens E1 to have a converging effect on the light, the light can be remain in a converged state after being reflected by the reflective element P, increasing the amount of light entering the second lens E2, thereby enlarging the effective aperture of the optical system 10; at the same time, under the converging effect of the first lens E1 on the light, even if the light is subsequently diverged by the second lens E2, a diameter of the diverged light when entering the second element group G2 may still be smaller than a diameter of the light when it enters the first lens E1, which is conducive to reducing the optical effective diameter of the lenses within the second element group G2, thus reducing the shoulder height of the second element group G2.

In an exemplary implementation, the second lens E2 may diverge the light reflected by the reflective element P. By enabling the second lens E2 to have a diverging effect on the light, the light emitted from the second lens E2 can be incident on the second element group G2 in a direction that is nearly parallel to the optical axis II, i.e., light at each edge position propagates in the direction that is nearly parallel to the optical axis II. When the reflective element P is driven to achieve optical image stabilization, the movement generated by the reflective element P has small influence on the position of the light on the second element group G2, and a drop value of an MTF of the optical system 10 is small, i.e., the sensitivity to image stabilization is low.

If the second lens E2 does not have a refractive power or has a positive refractive power, the light is still in a state of converging towards the center when reaching the second element group G2, and when the reflective element P is driven to achieve optical image stabilization, the reflective element P moves, thus resulting in deflection angles of the light at edge positions being different. In particular, when the reflective element P is driven to move for optical image stabilization, the light may shift in the same direction, thus leading to the different deflection angles of the light at the edge positions after passing through the reflective element P. The deflection angles of the light reaching the various edge positions of the second element group G2 are different, so that the drop value of the MTF of the optical system 10 is large, i.e., the sensitivity to image stabilization is high.

In an exemplary implementation, there may be a spacing distance between the first lens E1 and the reflective element P. There may be a spacing distance between the second lens E2 and the reflective element P. By spacing the first lens E1, the second lens E2 and the reflective element P apart, a variety of options can be provided for the design of surface type of side surfaces, which are close to the reflective element P, of the first lens E1 and the second lens E2, improving flexibility in the design of the surface type of the side surfaces of the first lens E1 and the second lens E2 that are close to the reflective element P.

It should be understood that, the first lens E1 and the reflective element P have a spacing distance therebetween indicates that the side surface of the first lens E1 close to the reflective element P has a certain interval with at least a portion of the reflective element P, rather than that the first lens E1 and the reflective element P are completely out of contact with each other. Similarly, the second lens E2 and the reflective element P have a spacing distance therebetween indicates that the side surface of the second lens E2 close to the reflective element P has a certain interval with at least a portion of the reflective element P, rather than that the second lens E2 and the reflective element P are completely out of contact with each other.

In an exemplary implementation, at least one of the surfaces of the first lens E1 and/or the second lens E2 is an aspheric surface. An aspheric lens is characterized in that the curvature continuously changes from the center of the lens to the periphery. Different from a spherical lens having a constant curvature from the center of the lens to the periphery, the aspheric lens has a better radius-of-curvature characteristic, and has advantages of improving a distortion aberration and an astigmatic aberration. The use of the aspheric lens can eliminate as much as possible aberrations that occur during imaging, thereby improving the imaging quality.

As an example, an object-side surface of the first lens E1 may be a convex surface, and an image-side surface of the first lens E1 may be a convex surface or a concave surface.

As an example, an object-side surface of the second lens E2 may be a concave surface, and an image-side surface of the second lens E2 may be a convex surface or a concave surface.

In an exemplary implementation, referring to FIG. 1, the second element group G2 may include a third lens E3, a fourth lens E4, a fifth lens E5, a sixth lens E6, and a seventh lens E7 arranged sequentially from the object side to the image side. The third lens E3, the fourth lens E4, the fifth lens E5, the sixth lens E6, and the seventh lens E7 may be arranged sequentially along the optical axis II from the second lens E2 to the image side.

As an example, the third lens E3 may have a positive refractive power. The fourth lens E4 may have a negative refractive power. The fifth lens E5 may have a positive refractive power. The sixth lens E6 may have a positive refractive power. The seventh lens E7 may have a negative refractive power.

As an example, the second element group G2 may further include a diaphragm STO. For example, the diaphragm STO may be disposed between the second lens E2 and the third lens E3.

It should be understood that the number of lenses contained in the second element group G2 is only exemplary, and the present disclosure does not impose any limitation on the number of lenses contained in the second element group G2.

In an exemplary implementation, referring to FIG. 1, the optical system 10 may further include an optical filter E8. The optical filter E8 may be disposed on an image side of the second element group G2, and is used to filter light emitted from the second element group G2. The optical filter E8 may be, for example, an infrared optical filter.

In an exemplary implementation, referring to FIG. 1, when light enters the optical system 10, first, the light enters the first lens E1 in the direction of the optical axis I, then is converged by the first lens E1, and reaches the reflective element P, then is totally reflected and turned by the reflective element P, enters the second lens E2 in the direction of the optical axis II and is diverged by the second lens E2; then, after being diverged by the second lens E2, the light enters the second element group G2 and sequentially passes through the third lens E3, the fourth lens E4, the fifth lens E5, the sixth lens E6, the seventh lens E7, reaches the optical filter E8, and finally reaches the image plane IMA after passing through the optical filter E8.

By adopting the first lens E1, the reflective element P and the second lens E2, the aperture of the optical system 10 can be enlarged, so that the optical system 10 obtains a higher brightness of image plane, and the imaging quality and the optical image stabilization performance of the optical system 10 may be improved, while also reducing the weight and size of the optical system 10.

In an exemplary implementation, referring to FIG. 1, the first element group G1 may be fixed in a position relative to the image plane IMA on the optical axis (such as the optical axis II). The second element group G2 may move along the optical axis (such as the optical axis II) relative to the first element group G1, i.e., a distance between the second element group G2 and the first element group G1 on the optical axis (such as the optical axis II) is adjustable. When a distance between a photographed object and the optical system 10 changes from far to near, adjusting the distance between the second element group G2 and the first element group G1 on the optical axis (such as the optical axis II) enables the optical system 10 to switch between a first state and a second state to achieve a focusing function of the optical system 10. For example, when the photographed object is infinitely far from the optical system 10, the optical system 10 is in the first state (e.g., long-distance state); when the photographed object is at a preset distance from the optical system 10, the optical system 10 is in the second state (e.g., close-distance state).

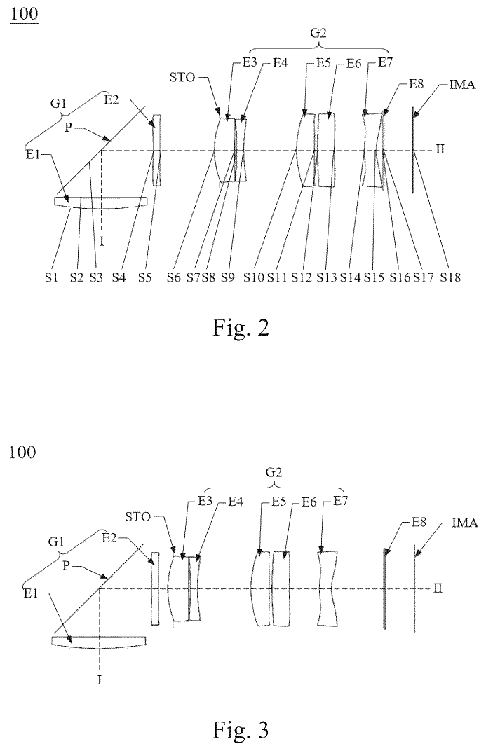

In an exemplary implementation, referring to FIG. 2 and FIG. 3, when the distance between the photographed object and the optical system 10 is decreased, the second element group G2 may move along the optical axis II towards a direction close to the first element group G1 to cause the optical system 10 to switch from the first state to the second state. When the distance between the photographed object and the optical system 10 is increased, the second element group G2 may move along the optical axis II towards a direction away from the first element group G1 to cause the optical system 10 to switch from the second state to the first state.

In an exemplary implementation, during focusing of the optical system 10, a maximal travelling distance of the second element group G2 may be within a range of 5.5 mm to 7.0 mm.

In an exemplary implementation, the optical system 10 may further include a lens barrel assembly (not shown). The lens barrel assembly may include a first lens barrel and a second lens barrel. The first element group G1 may be fixed within the first lens barrel. The second element group G2 may be fixed within the second lens barrel. During focusing of the optical system 10, the first lens barrel and the first element group G1 may be fixed in a position on the optical axis II relative to the image plane IMA, and the second lens barrel and the second element group G2 may move along the optical axis II towards the direction close to the first element group G1, alternatively, the second lens barrel and the second element group G2 may move along the optical axis II towards the direction away from the first element group G1. It should be understood that when the optical system 10 achieves the focusing function, the second lens barrel and the second element group G2 may be driven by the motor (not shown) to move along the optical axis II, and the first lens barrel and the first element group G1 do not move.

In an exemplary implementation, the optical system 10 may further include a lens barrel assembly (not shown). The first element group G1 may be fixed within the lens barrel assembly. The second element group G2 may be movably disposed within the lens barrel assembly. During focusing of the optical system 10, the lens barrel assembly and the first element group G1 may be fixed in a position on the optical axis II relative to the image plane IMA, and the second element group G2 may move along the optical axis II towards the direction close to the first element group G1, alternatively, the second element group G2 may move along the optical axis II towards the direction away from the first element group G1. It should be understood that when the optical system 10 achieves the focusing function, the second element group G2 may be driven by the motor (not shown) to move along the optical axis II, and the lens barrel assembly and the first element group G1 do not move.

In an exemplary implementation, the optical system 10 may further satisfy: 1.7<f1/FG2<2.5, where f1 is an effective focal length of the first lens, and FG2 is an effective focal length of the second element group. By reasonably distributing the refractive powers of the first lens and the second element group, at the first aspect, the first lens E1 can have a strong converging ability for light, realizing a significant enlargement effect on the aperture; at the second aspect, after passing through the first lens and then reflected by the reflective element, the light can have a smooth transition in the lenses of the second element group, and it is also conducive to controlling the aberration of the light from the first lens and the reflecting element, so that at least one lens in the second element group are more conducive to aberration correction and improve the image quality of the lens. If the value of f1/FG2 is less than 1.7, the processing of the first lens is difficult and is not conducive to the machinability of the first lens. If the value of f1/FG2 is greater than 2.5, the light from the first lens and the reflective element may not transition smoothly into at least one lens in the second element group, affecting the imaging effect.

In an exemplary implementation, the optical system 10 may further satisfy: OBJmin≥15.0 cm, where OBJmin is a minimal value of an object distance of the optical system 10. The object distance may be, for example, the distance between the photographed object and the optical system 10. As an example, 15.0 cm≤OBJmin<25 cm. By controlling the above conditional expression, the optical system 10 can image an object under the condition that the object distance is greater than or equal to 15.0 cm, and obtain a good imaging effect.

In an exemplary implementation, a magnification of the optical system 10 may be greater than or equal to 5× and less than or equal to 10×.

In an exemplary implementation, the optical system 10 may satisfy: −0.6<f1/f2<−0.3, where, f1 is an effective focal length of the first lens E1, and f2 is an effective focal length of the second lens E2. By reasonably configurating the ratio of the effective focal length of the first lens E1 to the effective focal length of the second lens E2, the first lens E1 can have a strong converging ability for light, a significant enlargement effect on the aperture, to ensure that the light is still in a converged state after being reflected by the reflective element P, which is conducive to reducing a diameter of the second lens E2, thereby reducing the optical effective diameter of the lenses within the second element group G2, and reducing the shoulder height of the second element group G2; at the same time, an included angle between the light emitted by the second lens E2 and the optical axis II can be within a small range, thus improving the optical image stabilization performance of the optical system 10. If the value of f1/f2 is too small, it may result in an excessively strong converging ability of the first lens E1 for light, causing the light to enter the second lens E2 and the second element group G2 at an overly small incident angle, thus resulting in an increase in an interval between the second lens E2 and the second element group G2 or an increase in the shoulder height of the second element group G2, and an increase in the total length or total height of the optical system 10.

In an exemplary implementation, the optical system 10 may further satisfy: 3.0<D1/CT1<6.0, where, D1 is a maximal effective half diameter of the first lens, and CT1 is a center thickness of the first lens on the optical axis (such as the optical axis I). D1 may be, for example, a maximal value in the effective half diameter of the object-side surface of the first lens E1 and the effective half diameter of the image-side surface of the first lens E1. By reasonably configuring the ratio of the maximal effective half diameter of the first lens E1 to the center thickness of the first lens E1, it can reduce the total height of the optical system 10 and enable a structure of the optical system 10 to be more compact, thereby reducing a volume of the optical system 10, provided that machinability of the first lens E1 meets the requirements; at the same time it also facilitates a large aperture of the optical system 10.

In an exemplary implementation, at least one of the first lens E1 to the seventh lens E7 may be a cut-edge lens. Effective half diameters of the cut-edge lens in a first direction and a second direction may be different. The first direction may be, for example, a direction perpendicular to the plane formed by the optical axis I and the optical axis II. The second direction may be, for example, a direction parallel to the optical axis I. By providing the cut-edge lens, a total width of the second element group G2 in the first direction or the shoulder height of the second element group G2 may be further reduced, thereby reducing a total width of the optical system 10 in the first direction or the total height of the optical system 10.

In an exemplary implementation, the optical system 10 may further satisfy: 0.04 mm⁻¹<D2x/EPDx/d12<0.12 mm⁻¹, where, D2x is a maximal effective half diameter of the second lens E2 in the first direction, EPDx is an entrance pupil diameter of the optical system 10 in the first direction, and d12 is an on-axis distance from the image-side surface of the first lens E1 to the object-side surface of the second lens E2. D2x may be, for example, a maximal value in the effective half diameter of the object-side surface of the second lens E2 and the effective half diameter of the image-side surface of the second lens E2 in the first direction. The first direction may be, for example, the direction perpendicular to the plane formed by the optical axis I and the optical axis II. By controlling the above conditional expression, the effective diameter of the second lens E2 can be constrained within a reasonable range while satisfying the large aperture requirement for the optical system 10, which is conducive to reducing the total width of the second element group G2 in the first direction, thereby reducing the total width of the optical system 10 in the first direction.

In an exemplary implementation, the optical system 10 may further satisfy: 0.04 mm⁻¹<D2y/EPDy/d12<0.12 mm⁻¹, where, D2y is a maximal effective half diameter of the second lens E2 in the second direction, EPDy is an entrance pupil diameter of the optical system 10 in the second direction, and d12 is the on-axis distance from the image-side surface of the first lens E1 to the object-side surface of the second lens E2. D2y may be, for example, a maximal value in the effective half diameter of the object-side surface of the second lens E2 and the effective half diameter of the image-side surface of the second lens E2 in the second direction. The second direction may be, for example, the direction parallel to the optical axis I. By controlling the above conditional expression, the effective diameter of the second lens E2 can be constrained within a reasonable range while satisfying the large aperture requirement for the optical system 10, which is conducive to reducing the shoulder height of the second element group G2, thereby reducing the total height of the optical system 10.

In an exemplary implementation, the optical system 10 may further satisfy: 3.0<FG1/EFL<5.0, where, FG1 is an effective focal length of the first element group G1, and EFL is an effective focal length of the optical system 10. By reasonably configuring the ratio of the effective focal length of the first element group G1 to the effective focal length of the optical system 10, the optical system 10 can image an object that is close to the optical system 10, ensuring that the optical system 10 has a large range of imaging object distances (the range of imaging object distances refers to a distance range between an object that can be clearly imaged by an optical system and the optical system); at the same time, it also enables the first element group G1 to have a certain converging ability for the light, reducing the total width of the second element group G2 in the first direction and the shoulder height of the second element group G2, ensuring that the light, after passing through the first element group G1, enters the second element group G2 in a direction that is at a small included angle to the optical axis II, which is conducive to improving the optical image stabilization performance of the optical system 10.

In an exemplary implementation, the optical system 10 may further satisfy: 2.5<FG1/FG2<4.5, where, FG1 is the effective focal length of the first element group G1, and FG2 is the effective focal length of the second element group G2. By controlling the ratio of the effective focal length of the first element group G1 to the effective focal length of the second element group G2, refractive powers of the first element group G1 and the second element group G2 can be reasonably distributed, so that the optical system 10 may image an object that is close to the optical system 10, ensuring that the optical system 10 has a large range of imaging object distances, and ensuring that the optical system 10 has a good imaging quality on an object at close range.

In an exemplary implementation, the optical system 10 may further satisfy: 7.5 mm<EFL/(FG1/FG2)<11.5 mm, where, FG1 is the effective focal length of the first element group G1, FG2 is the effective focal length of the second element group G2, and EFL is the effective focal length of the optical system 10. By controlling the above conditional expression, the refractive powers of the first element group G1 and the second element group G2 can be reasonably distributed, to ensure that the optical system 10 can achieve optimal focusing through finite movement of the second element group G2 when photographing objects at different object distances, and that the optical system 10 has good imaging performance at different object distances, thereby improving the range of imaging object distances of the optical system 10.

In an exemplary implementation, the optical system 10 may further satisfy: −0.15<fs1/fs2<0.8, where, fs1 is an effective focal length of the object-side surface of the first lens E1, and fs2 is an effective focal length of the image-side surface of the first lens E1. By reasonably configuring the ratio of the effective focal lengths of the object-side surface and the image-side surface of the first lens E1, the first lens E1 can have sufficient converging ability, and surface type trends of both the object-side surface and the image-side surface of the first lens E1 can be restricted, thereby reducing the shoulder height of the second element group G2, and reducing the total height of the optical system 10.

In an exemplary implementation, the optical system 10 may further satisfy: 0.5<EFL/SL<0.7, where, EFL is the effective focal length of the optical system 10, and SL is a total length of the optical system 10 along the direction of a preset principle optical axis. SL may be, for example, the total length of the optical system 10 along the direction of the optical axis II (such as in FIG. 1). By reasonably configuring the ratio of the effective focal length of the optical system 10 to the total length of the optical system 10 along the direction of the preset principle optical axis, it is conducive to shortening the total length of the optical system 10, thereby reducing the volume of the optical system 10, when the optical system 10 achieves the characteristics such as telephoto, large aperture, or certain image plane size.

In an exemplary implementation, the optical system 10 may further satisfy: Tan(FOV/2)<0.38, where, FOV is a maximal field-of-view of the optical system 10. As an example, 0.05<Tan(FOV/2)<0.25. By reasonably configuring a tangent value of half of the maximal field-of-view of the optical system 10, it enables the optical system 10 to have a small field-of-view, which is conducive for the optical system 10 to imaging an object at a long distance, thereby ensuring that the optical system 10 has a good imaging quality when imaging at a long distance.

The optical system 10 according to the above implementations of the present disclosure may adopt seven lenses and one reflective element P. By reasonably distributing the optical parameters of each lens and the reflective element P, under the condition that the size of the optical system 10 satisfying the requirements, it is conducive for the optical system 10 to achieving the characteristics such as telephoto or large aperture, to improving the imaging quality and the optical image stabilization performance of the optical system 10, and to reducing the weight of the optical system 10.

In implementations of the present disclosure, SL represents the total length of the optical system 10 along the direction of the preset principle optical axis, in particular, SL is a distance between the first lens E1 and the image plane IMA along the optical axis II, and the preset principle optical axis may be the optical axis II. GH represents the shoulder height of the second element group G2, in particular, GH is determined by the maximal effective diameter in the lenses within the second element group G2 in the second direction (e.g., the direction parallel to the optical axis I). SH represents the total height of the optical system 10, in particular, SH is the total height of the optical system 10 in the second direction (e.g., the direction parallel to the optical axis I). Modulation Transfer Function (MTF) is an important metric describing the imaging quality of the optical system 10, and the MTF may be derived by simulation. Optical Image Stabilizer (OIS) sensitivity refers to a drop value of the MTF, representing a difference between the MTF per unit jitter angle and a static MTF design value.

It should be understood by those skilled in the art that the various results and advantages described in implementations of the present disclosure may be obtained by changing the number of the lenses constituting the optical system 10 without departing from the technical solution claimed by the present disclosure.

Detailed embodiments of the optical system 10 that may be applicable to the above implementations are further described below with reference to the accompanying drawings.

### Embodiment 1

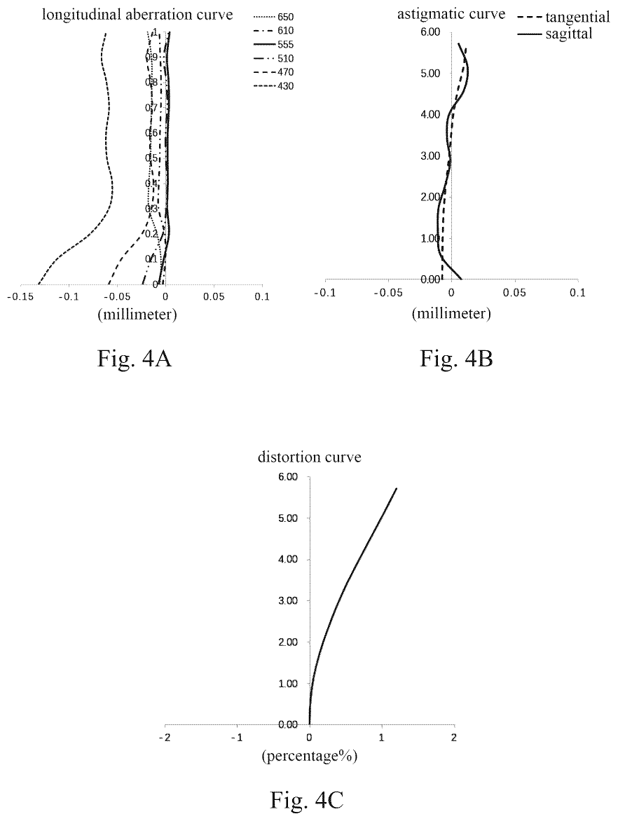

An optical system according to Embodiment 1 is described below with reference to FIG. 2, FIG. 3, FIG. 4A, FIG. 4B, and FIG. 4C.

As shown in FIG. 2 and FIG. 3, the optical system 100 may include a first element group G1 and a second element group G2 arranged sequentially from an object side to an image side. The image side may be provided with, for example, an image plane IMA. The range of imaging object distances of the optical system 100 may be from 18 cm to infinity. A magnification of the optical system 100 may be 5×.

The first element group G1 may include a first lens E1, a reflective element P and a second lens E2. The second element group G2 may include a diaphragm STO, a third lens E3, a fourth lens E4, a fifth lens E5, a sixth lens E6 and a seventh lens E7. In particular, the first lens E1 is located on the optical axis I and is disposed between the object side and the reflective element P. The second lens E2, the diaphragm STO, the third lens E3, the fourth lens E4, the fifth lens E5, the sixth lens E6, and the seventh lens E7 are arranged sequentially along the optical axis II from the reflective element P to the image side. In an example, an optical filter E8 may be provided between the seventh lens E7 and the image plane IMA.

The first element group G1 is fixed in a position relative to the image plane IMA on the optical axis II. The second element group G2 may move along the optical axis II relative to the first element group G1. When the distance between a photographed object and the optical system 100 is decreased, adjusting the distance between the second element group G2 and the first element group G1 on the optical axis II enables the optical system 100 to switch between a first state and a second state to achieve a focusing function of the optical system 100. During the focusing of the optical system 100, a maximal travelling distance of the second element group G2 may be 6.5478 mm.

The first lens E1 may have a positive refractive power, an object-side surface S1 of the first lens E1 is a convex surface, and an image-side surface S2 of the first lens E1 is a concave surface. The reflective element P may have a reflective surface S3, and the reflective surface S3 is a planar surface. The second lens E2 may have a negative refractive power, an object-side surface S4 of the second lens E2 is a concave surface, and an image-side surface S5 of the second lens E2 is a convex surface. The third lens E3 may have a positive refractive power, an object-side surface S6 of the third lens E3 is a convex surface, and an image-side surface S7 of the third lens E3 is a concave surface. The fourth lens E4 may have a negative refractive power, an object-side surface S8 of the fourth lens E4 is a concave surface, and an image-side surface S9 of the fourth lens E4 is a concave surface. The fifth lens E5 may have a positive refractive power, an object-side surface S10 of the fifth lens E5 is a convex surface, and an image-side surface S11 of the fifth lens E5 is a concave surface. The sixth lens E6 may have a positive refractive power, an object-side surface S12 of the sixth lens E6 is a convex surface, and an image-side surface S13 of the sixth lens E6 is a concave surface. The seventh lens E7 may have a negative refractive power, an object-side surface S14 of the seventh lens E7 is a convex surface, and an image-side surface S15 of the seventh lens E7 is a concave surface. The optical filter E8 may have an object-side surface S16 and an image-side surface S17. Light from an object sequentially passes through the surfaces S1-S17 and finally forms an image on an image plane S18.

Table 1 shows a table of basic parameters of the optical system 100 in Embodiment 1. Here, the units of the radius of curvature and the thickness/distance are millimeters (mm).

TABLE 1

| | | | | | | material | |
|---|---|---|---|---|---|---|---|
| surface | | surface | radius of | thickness/ | | refractive | abbe |
| number | element | type | curvature | distance | texture | index | number |
| S1 | first lens | aspheric | 37.5303 | 1.6556 | plastic | 1.5350 | 55.7290 |
| S2 | | aspheric | 395.7521 | 6.8757 | | | |
| S3 | reflective | | infinite | −7.5621 | | | |
| | element | | | | | | |
| S4 | second | aspheric | 72.6951 | −0.9808 | plastic | 1.6259 | 25.1738 |
| | lens | | | | | | |
| S5 | | aspheric | 149.2686 | W1 | | | |
| STO | aperture | | infinite | 0.8823 | | | |
| S6 | third lens | aspheric | −11.4674 | −2.9291 | plastic | 1.5350 | 55.7290 |
| S7 | | aspheric | −107.5094 | −0.2834 | | | |
| S8 | fourth | aspheric | 330.8952 | −1.0070 | plastic | 1.6551 | 20.9883 |
| | lens | | | | | | |
| S9 | | aspheric | −14.9128 | −7.6644 | | | |
| S10 | fifth lens | aspheric | −11.8598 | −2.5918 | plastic | 1.5776 | 33.8921 |
| S11 | | aspheric | −140.1819 | −0.4335 | | | |
| S12 | sixth lens | aspheric | −49.0759 | −2.4600 | plastic | 1.6161 | 25.0605 |
| S13 | | aspheric | −49.0768 | −4.3237 | | | |
| S14 | seventh | aspheric | −9.9554 | −1.7071 | plastic | 1.5676 | 37.6511 |
| | lens | | | | | | |
| S15 | | aspheric | −5.5992 | W2 | | | |
| S16 | optical | | infinite | −0.2100 | glass | 1.5168 | 51.4060 |
| | filter | | | | | | |
| S17 | | | infinite | −4.2005 | | | |
| S18 | image | | infinite | | | | |
| | plane | | | | | | |

In this embodiment, the positive or negative sign of the numerical value of the radius of curvature of each surface indicates only a bending direction of the surface. When a surface of a lens on the optical axis I and a surface of a lens on the optical axis II have the same bending direction, the numerical signs (positive or negative) of the radii of curvature of the surfaces are opposite to each other. Similarly, in the table, the positive or negative sign of the numerical value of the thickness/distance corresponding to each surface indicates the direction only. When a surface of a lens on the optical axis I and a surface of a lens on the optical axis II correspond to thicknesses/distances extending towards the same direction (e.g., towards the image plane), the numerical signs (positive or negative) of the thicknesses/distances are opposite to each other. The bending direction of each surface and the thickness/distance of each surface may be referred to in FIG. 2 and FIG. 3.

Here, an on-axis distance W1 from the first element group G1 to the second element group G2, and an on-axis distance W2 from the second element group G2 to the optical filter E8 are variables, which may change as the distance between the photographed object and the optical system 100 changes.

When the photographed object is at infinity from the optical system 100, the optical system 100 is in the first state, and a structural diagram of the optical system 100 may be referred to in FIG. 2, where, W1=−8.6302 mm, W2=−0.9286 mm, an effective focal length of the optical system 100 EFL=31.699 mm, an aperture value of the optical system 100 in a first direction Fnox=1.72, an aperture value of the optical system 100 in a second direction Fnoy=2.45, and a maximal field-of-view of the optical system 100 FOV=20.2282°. When the photographed object is at a preset distance from the optical system 100, the optical system 100 is in the second state, and a structural diagram of the optical system 100 may be referred to in FIG. 3.

In this embodiment, the object-side surface and the image-side surface of any lens in the first lens E1 to the seventh lens E7 are both aspheric surfaces, and the surface type of each aspheric lens may be defined using, but not limited to, the following aspheric formula:

$$X ( Y ) = \frac{( {Y}^{2} / R )}{1 + \sqrt{1 - ( 1 + K ) \cdot ( {Y}^{2} / {R}^{2} )}} + {( u )}^{4} {\sum }_{m = 0}^{8} {A}_{m} {Q}_{m}^{con} ( {u}^{2} ) \qquad ( 1 )$$

Here, X(Y) represents the relative distance between a point on the aspheric surface at a distance Y from the optical axis and a tangent plane to an intersection on the optical axis on the aspheric surface; Y represents the perpendicular distance between a point on an aspheric curve and the optical axis; R represents the radius of curvature; K represents the conic coefficient; Aₘ represents the Qcon aspheric coefficient of an i-th order; u=(Y/NR), where NR represents the normalized radius of curvature of the Qcon aspheric surface; and Qₘ^{con} represents the Qcon polynomial of an m-th order. Table 2 gives the conic coefficient K and the high-order coefficients A₄, A₆, A₈, A₁₀, A₁₂, A₁₄, A₁₆, A₁₈ and A₂₀ applicable to the aspheric surfaces S1-S2, S4-S15 in Embodiment 1.

TABLE 2

| surface | | | | | | |
|---|---|---|---|---|---|---|
| number | K | A₄ | A₆ | A₈ | A₁₀ | |
| S1 | −9.5075 | 2.22E−02 | −1.94E−02 | −6.68E−03 | −1.48E−03 | |
| S2 | −99.0000 | −1.05E−01 | −1.58E−02 | −7.79E−03 | −1.49E−03 | |
| S4 | 15.8366 | −6.43E−01 | 1.11E−02 | 4.80E−05 | −8.19E−04 | |
| S5 | −74.8214 | −5.70E−01 | 6.62E−03 | 1.29E−04 | −8.03E−04 | |
| S6 | −1.7792 | 2.86E−01 | 7.49E−02 | −3.76E−03 | −1.38E−03 | |
| S7 | −83.9603 | 4.05E−01 | 1.28E−01 | −1.78E−02 | 1.06E−02 | |
| S8 | 99.0000 | 4.69E−01 | −2.80E−03 | 3.46E−02 | 2.92E−03 | |
| S9 | −19.7259 | 3.04E−01 | −1.70E−02 | 3.92E−02 | −7.17E−03 | |
| S10 | 1.9073 | 6.94E−01 | −1.39E−01 | −1.59E−03 | 9.25E−03 | |
| S11 | 99.0000 | −8.02E−02 | 1−2.40E−01 | −2.38E−02 | 8.00E−03 | |
| S12 | 12.6980 | 8.02E−02 | 1.05E−02 | 4.75E−03 | 6.90E−03 | |
| S13 | −99.0000 | 3.91E−01 | 2.72E−02 | 1.39E−03 | −5.31E−03 | |
| S14 | −13.8932 | 1.56E+00 | −2.59E−01 | 1.41E−02 | −4.42E−04 | |
| S15 | −6.7807 | 8.86E−01 | −1.92E−01 | 1.79E−02 | 2.13E−03 | |
| | surface | | | | | |
| | number | A₁₂ | A₁₄ | A₁₆ | A₁₈ | A₂₀ |
| | S1 | −3.97E−04 | −9.70E−05 | −3.60E−05 | 0.00E+00 | 0.00E+00 |
| | S2 | −4.22E−04 | −9.70E−05 | −3.20E−05 | 0.00E+00 | 0.00E+00 |
| | S4 | 1.12E−04 | −7.50E−05 | 4.90E−05 | −8.00E−06 | 0.00E+00 |
| | S5 | 7.50E−05 | −6.70E−05 | 4.90E−05 | −8.00E−06 | 0.00E+00 |
| | S6 | −2.40E−05 | 2.65E−04 | 4.70E−05 | 8.10E−05 | 0.00E+00 |
| | S7 | −3.92E−03 | 2.54E−03 | −1.39E−03 | 2.78E−04 | −1.70E−05 |
| | S8 | −3.34E−03 | 2.42E−03 | −1.68E−03 | 3.46E−04 | −4.40E−05 |
| | S9 | −7.74E−04 | 5.80E−04 | −4.69E−04 | 2.14E−04 | −4.10E−05 |
| | S10 | −1.59E−03 | 3.49E−04 | 1.82E−04 | 5.80E−05 | 2.00E−06 |
| | S11 | −1.06E−02 | 2.18E−03 | −8.84E−04 | 2.84E−04 | 0.00E+00 |
| | S12 | −6.49E−03 | 1.58E−03 | −5.09E−04 | 9.40E−05 | 4.00E−06 |
| | S13 | −3.88E−04 | 1.71E−04 | −3.60E−05 | 5.60E−05 | −1.84E−07 |
| | S14 | 2.28E−04 | 8.92E−04 | −1.54E−04 | 6.60E−05 | 1.00E−06 |
| | S15 | 5.26E−04 | 1.83E−03 | −1.97E−04 | 2.24E−04 | −1.00E−04 |

FIG. 4A illustrates a longitudinal aberration curve of the optical system 100 in the first state in Embodiment 1, representing deviations of focal points of light of different wavelengths converged after passing through the optical system 100. FIG. 4B illustrates an astigmatic curve of the optical system 100 in the first state in Embodiment 1, representing a curvature of a tangential image plane and a curvature of a sagittal image plane corresponding to different image heights. FIG. 4C illustrates a distortion curve of the optical system 100 in the first state in Embodiment 1, representing amounts of distortion corresponding to different image heights. It can be seen from FIG. 4A, FIG. 4B and FIG. 4C that the optical system 100 in Embodiment 1 can achieve a good imaging quality in the first state.

### Embodiment 2

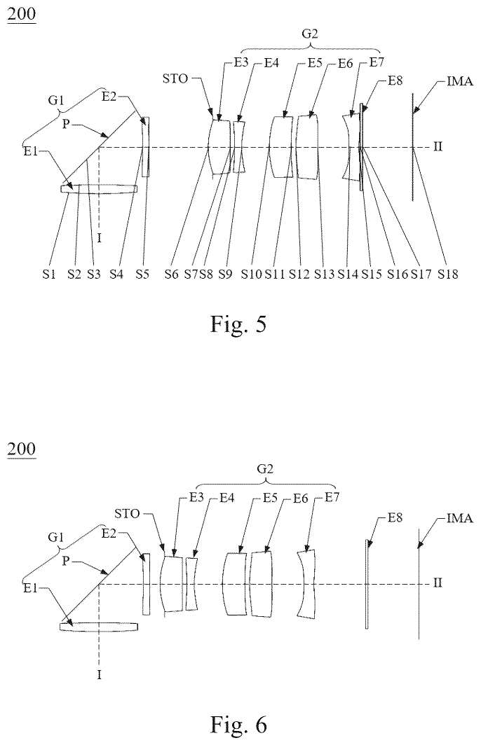

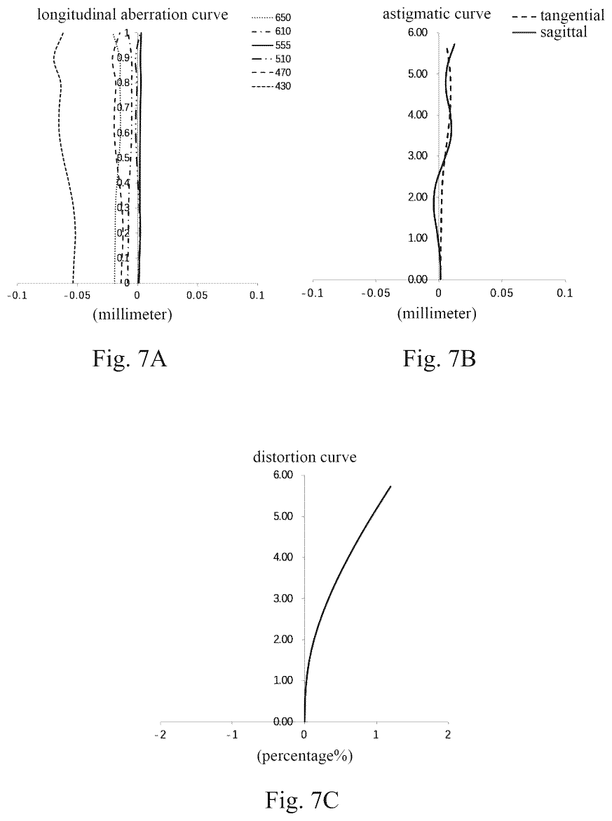

An optical system according to Embodiment 2 is described below with reference to FIG. 5, FIG. 6, FIG. 7A, FIG. 7B, and FIG. 7C.

As shown in FIG. 5 and FIG. 6, the optical system 200 may include a first element group G1 and a second element group G2 arranged sequentially from an object side to an image side. The image side may be provided with, for example, an image plane IMA. The range of imaging object distances of the optical system 200 may be from 18 cm to infinity. A magnification of the optical system 200 may be 5×.

The first element group G1 may include a first lens E1, a reflective element P and a second lens E2. The second element group G2 may include a diaphragm STO, a third lens E3, a fourth lens E4, a fifth lens E5, a sixth lens E6 and a seventh lens E7. In particular, the first lens E1 is located on the optical axis I and is disposed between the object side and the reflective element P. The second lens E2, the diaphragm STO, the third lens E3, the fourth lens E4, the fifth lens E5, the sixth lens E6, and the seventh lens E7 are arranged sequentially along the optical axis II from the reflective element P to the image side. In an example, an optical filter E8 may be provided between the seventh lens E7 and the image plane IMA.

The first element group G1 is fixed in a position relative to the image plane IMA on the optical axis II. The second element group G2 may move along the optical axis II relative to the first element group G1. When the distance between a photographed object and the optical system 200 is decreased, adjusting the distance between the second element group G2 and the first element group G1 on the optical axis II enables the optical system 200 to switch between a first state and a second state to achieve a focusing function of the optical system 200. During the focusing of the optical system 200, a maximal travelling distance of the second element group G2 may be 6.7252 mm.

The first lens E1 may have a positive refractive power, an object-side surface S1 of the first lens E1 is a convex surface, and an image-side surface S2 of the first lens E1 is a convex surface. The reflective element P may have a reflective surface S3, and the reflective surface S3 is a planar surface. The second lens E2 may have a negative refractive power, an object-side surface S4 of the second lens E2 is a concave surface, and an image-side surface S5 of the second lens E2 is a convex surface. The third lens E3 may have a positive refractive power, an object-side surface S6 of the third lens E3 is a convex surface, and an image-side surface S7 of the third lens E3 is a convex surface. The fourth lens E4 may have a negative refractive power, an object-side surface S8 of the fourth lens E4 is a concave surface, and an image-side surface S9 of the fourth lens E4 is a concave surface. The fifth lens E5 may have a positive refractive power, an object-side surface S10 of the fifth lens E5 is a convex surface, and an image-side surface S11 of the fifth lens E5 is a concave surface. The sixth lens E6 may have a positive refractive power, an object-side surface S12 of the sixth lens E6 is a convex surface, and an image-side surface S13 of the sixth lens E6 is a concave surface. The seventh lens E7 may have a negative refractive power, an object-side surface S14 of the seventh lens E7 is a concave surface, and an image-side surface S15 of the seventh lens E7 is a concave surface. The optical filter E8 may have an object-side surface S16 and an image-side surface S17. Light from an object sequentially passes through the surfaces S1-S17 and finally forms an image on an image plane S18.

Table 3 shows a table of basic parameters of the optical system 200 in Embodiment 2. Here, the units of the radius of curvature and the thickness/distance are millimeters (mm).

TABLE 3

| | | | | | | material | |
|---|---|---|---|---|---|---|---|
| surface | | surface | radius of | thickness/ | | refractive | abbe |
| number | element | type | curvature | distance | texture | index | number |
| S1 | first lens | aspheric | 60.8658 | 1.1942 | plastic | 1.5350 | 55.7290 |
| S2 | | aspheric | −127.1100 | 5.1799 | | | |
| S3 | reflective | | infinite | −5.9683 | | | |
| | element | | | | | | |
| S4 | second | aspheric | 43.6594 | −0.8619 | plastic | 1.5663 | 36.6694 |
| | lens | | | | | | |
| S5 | | aspheric | 99.0761 | W1 | | | |
| STO | aperture | | infinite | 0.7873 | | | |
| S6 | third lens | aspheric | −10.0571 | −3.0000 | plastic | 1.5350 | 55.7290 |
| S7 | | aspheric | 237.7141 | −0.5744 | | | |
| S8 | fourth | aspheric | 74.6517 | −1.0032 | plastic | 1.6211 | 24.3948 |
| | lens | | | | | | |
| S9 | | aspheric | −10.3143 | −3.7667 | | | |
| S10 | fifth lens | aspheric | −11.8768 | −3.0000 | plastic | 1.5350 | 55.7290 |
| S11 | | aspheric | −28.9816 | −0.6366 | | | |
| S12 | sixth | aspheric | −15.3583 | −3.0000 | plastic | 1.6401 | 22.0673 |
| | lens | | | | | | |
| S13 | | aspheric | −95.9383 | −4.2713 | | | |
| S14 | seventh | aspheric | 122.6105 | −1.3545 | plastic | 1.5618 | 39.8242 |
| | lens | | | | | | |
| S15 | | aspheric | −12.1027 | W2 | | | |
| S16 | optical | | infinite | −0.3416 | glass | 1.5168 | 64.2124 |
| | filter | | | | | | |
| S17 | | | infinite | −6.8518 | | | |
| S18 | image | | infinite | | | | |
| | plane | | | | | | |

In this embodiment, the positive or negative sign of the numerical value of the radius of curvature of each surface indicates only a bending direction of curvature of the surface. When a surface of a lens on the optical axis I and a surface of a lens on the optical axis II have the same bending direction, the numerical signs (positive or negative) of the radii of curvature of the surfaces are opposite to each other. Similarly, the positive or negative sign of the numerical value of the thickness/distance for each surface indicates the direction only. The bending direction of each surface and the thickness/distance of each surface may be referred to in FIG. 5 and FIG. 6.

Here, an on-axis distance W1 from the first element group G1 to the second element group G2, and an on-axis distance W2 from the second element group G2 to the optical filter E8 are variables, which may change as the distance between the photographed object and the optical system 200 changes.

When the photographed object is at infinity from the optical system 200, the optical system 200 is in the first state, and a structural diagram of the optical system 200 may be referred to in FIG. 5, where, W1=−8.7125 mm, W2=−0.1506 mm, an effective focal length of the optical system 200 EFL=31.7 mm, an aperture value of the optical system 200 in a first direction Fnox=2.35, an aperture value of the optical system 200 in a second direction Fnoy=3.35, and a maximal field-of-view of the optical system 200 FOV=20.2178°. When the photographed object is at a preset distance from the optical system 200, the optical system 200 is in the second state, and a structural diagram of the optical system 200 may be referred to in FIG. 6.

In this embodiment, the object-side surface and the image-side surface of any lens in the first lens E1 to the seventh lens E7 are both aspheric surfaces. Table 4 gives the conic coefficient K and the high-order coefficients A₄, A₆, A₈, A₁₀, A₁₂, A₁₄, A₁₆, A₁₈ and A₂₀ applicable to the aspheric surfaces S1-S2, S4-S15 in Embodiment 2.

TABLE 4

| surface | | | | | | |
|---|---|---|---|---|---|---|
| number | K | A₄ | A₆ | A₈ | A₁₀ | |
| S1 | −56.2862 | −1.35E−02 | −9.85E−03 | −1.97E−03 | 1.58E−04 | |
| S2 | 83.4455 | −4.40E−02 | −8.48E−03 | −2.68E−03 | 2.13E−04 | |
| S4 | 1.2959 | −4.20E−01 | 1.29E−02 | −9.49E−04 | −3.67E−04 | |
| S5 | 87.5989 | −3.86E−01 | 9.90E−03 | −7.80E−04 | −3.59E−04 | |
| S6 | −1.8173 | 1.34E−01 | 5.28E−02 | 2.85E−03 | 7.21E−04 | |
| S7 | 94.2861 | 2.09E−01 | 6.95E−02 | −9.03E−03 | 3.24E−03 | |
| S8 | 55.5675 | 1.34E−01 | −3.80E−02 | 2.19E−02 | −3.63E−03 | |
| S9 | −8.6061 | 3.84E−02 | −6.35E−02 | 2.78E−02 | −3.39E−03 | |
| S10 | 2.0602 | 1.23E−01 | −1.08E−01 | 1.79E−03 | 8.94E−04 | |
| S11 | −63.154 | −5.57E−02 | −1.16E−01 | 5.27E−03 | −1.19E−03 | |
| S12 | 0.0221 | 3.73E−01 | −5.52E−03 | 2.45E−02 | 9.71E−04 | |
| S13 | −27.4973 | 4.61E−01 | 1.75E−02 | 1.30E−02 | −2.46E−03 | |
| S14 | 99.0000 | 1.23E+00 | −1.91E−01 | 2.34E−02 | −5.68E−03 | |
| S15 | −37.4598 | 6.90E−01 | −1.53E−01 | 2.39E−02 | −4.74E−03 | |
| | surface | | | | | |
| | number | A₁₂ | A₁₄ | A₁₆ | A₁₈ | A₂₀ |
| | S1 | −9.80E−05 | −4.00E−06 | 0.00E+00 | 0.00E+00 | 0.00E+00 |
| | S2 | −1.70E−04 | 0.00E+00 | 0.00E+00 | 0.00E+00 | 0.00E+00 |
| | S4 | 1.67E−04 | −6.50E−05 | 2.80E−05 | −4.00E−06 | 0.00E+00 |
| | S5 | 1.46E−04 | −6.10E−05 | 2.70E−05 | −4.00E−06 | 0.00E+00 |
| | S6 | −1.12E−04 | −1.13E−04 | −4.10E−05 | 1.00E−06 | 0.00E+00 |
| | S7 | −2.73E−03 | 5.10E−04 | −8.40E−05 | 7.20E−05 | −3.60E−05 |
| | S8 | −1.92E−03 | 6.67E−04 | −2.71E−04 | 1.33E−04 | −5.00E−05 |
| | S9 | −8.40E−05 | 1.66E−04 | −1.41E−04 | 4.50E−05 | −1.00E−05 |
| | S10 | −1.90E−04 | −1.02E−04 | −1.00E−06 | −2.00E−06 | −5.00E−06 |
| | S11 | 2.50E−03 | −1.10E−05 | 2.23E−04 | 2.20E−05 | 0.00E+00 |
| | S12 | 3.01E−03 | 1.93E−04 | 2.78E−04 | 6.80E−05 | 1.50E−05 |
| | S13 | 6.14E−04 | −3.66E−04 | 4.90E−05 | −1.20E−05 | 0.00E+00 |
| | S14 | 1.21E−03 | −1.42E−04 | 1.08E−04 | 0.00E+00 | 0.00E+00 |
| | S15 | 1.47E−03 | −2.10E−05 | 1.08E−04 | 0.00E+00 | 0.00E+00 |

FIG. 7A illustrates a longitudinal aberration curve of the optical system 200 in the first state in Embodiment 2, representing deviations of focal points of light of different wavelengths converged after passing through the optical system 200. FIG. 7B illustrates an astigmatic curve of the optical system 200 in the first state in Embodiment 2, representing a curvature of a tangential image plane and a curvature of a sagittal image plane corresponding to different image heights. FIG. 7C illustrates a distortion curve of the optical system 200 in the first state in Embodiment 2, representing amounts of distortion corresponding to different image heights. It can be seen from FIG. 7A, FIG. 7B and FIG. 7C that the optical system 200 in Embodiment 2 can achieve a good imaging quality in the first state.

### Embodiment 3

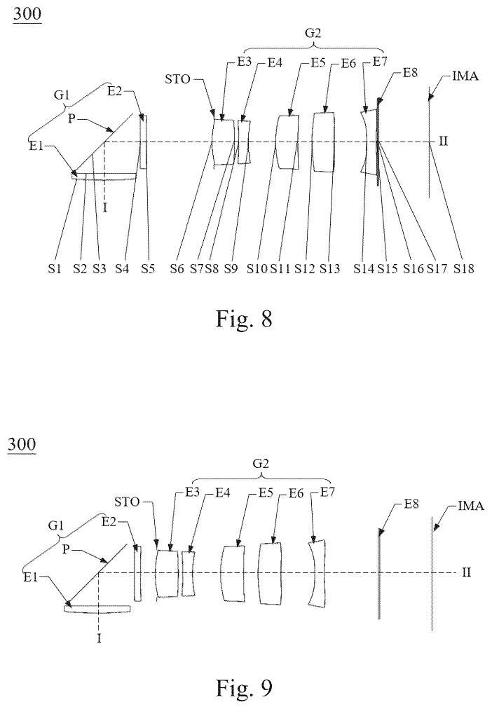

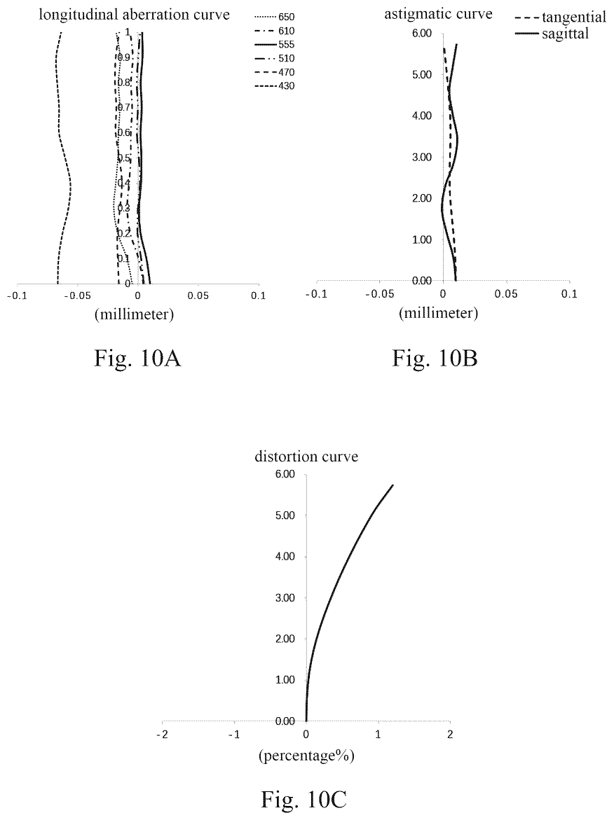

An optical system according to Embodiment 3 is described below with reference to FIG. 8, FIG. 9, FIG. 10A, FIG. 10B, and FIG. 10C.

As shown in FIG. 8 and FIG. 9, the optical system 300 may include a first element group G1 and a second element group G2 arranged sequentially from an object side to an image side. The image side may be provided with, for example, an image plane IMA. The range of imaging object distances of the optical system 300 may be from 18 cm to infinity. A magnification of the optical system 300 may be 5×.

The first element group G1 may include a first lens E1, a reflective element P and a second lens E2. The second element group G2 may include a diaphragm STO, a third lens E3, a fourth lens E4, a fifth lens E5, a sixth lens E6 and a seventh lens E7. In particular, the first lens E1 is located on the optical axis I and is disposed between the object side and the reflective element P. The second lens E2, the diaphragm STO, the third lens E3, the fourth lens E4, the fifth lens E5, the sixth lens E6, and the seventh lens E7 are arranged sequentially along an optical axis II from the reflective element P to the image side. In an example, an optical filter E8 may be provided between the seventh lens E7 and the image plane IMA.

The first element group G1 is fixed in a position relative to the image plane IMA on the optical axis II. The second element group G2 may move along the optical axis II relative to the first element group G1. When the distance between a photographed object and the optical system 300 is decreased, adjusting the distance between the second element group G2 and the first element group G1 on the optical axis II enables the optical system 300 to switch between a first state and a second state to achieve a focusing function of the optical system 300. During the focusing of the optical system 300, a maximal travelling distance of the second element group G2 may be 6.9378 mm.

The first lens E1 may have a positive refractive power, an object-side surface S1 of the first lens E1 is a convex surface, and an image-side surface S2 of the first lens E1 is a convex surface. The reflective element P may have a reflective surface S3, and the reflective surface S3 is a planar surface. The second lens E2 may have a negative refractive power, an object-side surface S4 of the second lens E2 is a concave surface, and an image-side surface S5 of the second lens E2 is a concave surface. The third lens E3 may have a positive refractive power, an object-side surface S6 of the third lens E3 is a convex surface, and an image-side surface S7 of the third lens E3 is a convex surface. The fourth lens E4 may have a negative refractive power, an object-side surface S8 of the fourth lens E4 is a concave surface, and an image-side surface S9 of the fourth lens E4 is a concave surface. The fifth lens E5 may have a positive refractive power, an object-side surface S10 of the fifth lens E5 is a convex surface, and an image-side surface S11 of the fifth lens E5 is a concave surface. The sixth lens E6 may have a positive refractive power, an object-side surface S12 of the sixth lens E6 is a convex surface, and an image-side surface S13 of the sixth lens E6 is a concave surface. The seventh lens E7 may have a negative refractive power, an object-side surface S14 of the seventh lens E7 is a concave surface, and an image-side surface S15 of the seventh lens E7 is a concave surface. The optical filter E8 may have an object-side surface S16 and an image-side surface S17. Light from an object sequentially passes through the surfaces S1-S17 and finally forms an image on an image plane S18.

Table 5 shows a table of basic parameters of the optical system 300 in Embodiment 3. Here, the units of a radius of curvature and a thickness/distance are millimeters (mm).

TABLE 5

| | | | | | | material | |
|---|---|---|---|---|---|---|---|
| surface | | surface | radius of | thickness/ | | refractive | abbe |
| number | element | type | curvature | distance | texture | index | number |
| S1 | first lens | aspheric | 47.7250 | 0.9327 | plastic | 1.5350 | 55.7290 |
| S2 | | aspheric | −2177.1375 | 4.1845 | | | |
| S3 | reflective | | infinite | −4.8524 | | | |
| | element | | | | | | |
| S4 | second | aspheric | 135.6502 | −0.8000 | plastic | 1.5500 | 44.4681 |
| | lens | | | | | | |
| S5 | | aspheric | −747.8458 | W1 | | | |
| STO | aperture | | infinite | 0.5266 | | | |
| S6 | third lens | aspheric | −13.1092 | −3.0000 | plastic | 1.5350 | 55.7290 |
| S7 | | aspheric | 33.7391 | −0.5658 | | | |
| S8 | fourth | aspheric | 61.1801 | −1.2686 | plastic | 1.6134 | 26.2688 |
| | lens | | | | | | |
| S9 | | aspheric | −10.4288 | −3.6760 | | | |
| S10 | fifth lens | aspheric | −11.7746 | −3.0000 | plastic | 1.5350 | 55.7290 |
| S11 | | aspheric | −38.2207 | −1.8801 | | | |
| S12 | sixth | aspheric | −15.3621 | −2.9955 | plastic | 1.6151 | 25.2099 |
| | lens | | | | | | |
| S13 | | aspheric | −59.1205 | −4.3844 | | | |
| S14 | seventh | aspheric | 36.8519 | −1.2296 | plastic | 1.5440 | 51.4068 |
| | lens | | | | | | |
| S15 | | aspheric | −13.5169 | W2 | | | |
| S16 | optical | | infinite | −0.2100 | glass | 1.5168 | 64.2124 |
| | filter | | | | | | |
| S17 | | | infinite | −6.7700 | | | |
| S18 | image | | infinite | | | | |
| | plane | | | | | | |

In this embodiment, the positive or negative sign of the numerical value of the radius of curvature of each surface indicates only a bending direction of the surface. When a surface of a lens on the optical axis I and a surface of a lens on the optical axis II have the same bending direction, the numerical signs (positive or negative) of the radii of curvature of the surfaces are opposite to each other. Similarly, the positive or negative sign of the numerical value of the thickness/distance for each surface indicates the direction only. The bending direction of each surface and the thickness/distance of each surface may be referred to in FIG. 8 and FIG. 9.

Here, an on-axis distance W1 from the first element group G1 to the second element group G2, and an on-axis distance W2 from the second element group G2 to the optical filter E8 are variables, which may change as the distance between the photographed object and the optical system 300 changes.

When the photographed object is at infinity from the optical system 300, the optical system 300 is in the first state, and a structural diagram of the optical system 300 may be referred to in FIG. 8, where, W1=−9.0597 mm, W2=−0.1463 mm, an effective focal length of the optical system 300 EFL=31.74 mm, an aperture value of the optical system 300 in a first direction Fnox=2.97, an aperture value of the optical system 300 in a second direction Fnoy=4.26, and a maximal field-of-view of the optical system 300 FOV=20.2178°. When the photographed object is at a preset distance from the optical system 300, the optical system 300 is in the second state, and a structural diagram of the optical system 300 may be referred to in FIG. 9.

In this embodiment, the object-side surface and the image-side surface of any lens in the first lens E1 to the seventh lens E7 are both aspheric surfaces. Table 6 gives the conic coefficient K and the high-order coefficients A₄, A₆, As, A₁₀, A₁₂, A₁₄, A₁₆, A₁₈ and A₂₀ applicable to the aspheric surfaces S1-S2, S4-S15 in Embodiment 3.

TABLE 6

| surface | | | | | | |
|---|---|---|---|---|---|---|
| number | K | A₄ | A₆ | A₈ | A₁₀ | |
| S1 | −35.9094 | 7.35E−03 | −3.22E−02 | 1.89E−03 | 1.04E−03 | |
| S2 | −99.0000 | −4.36E−02 | −3.02E−02 | 1.87E−03 | 6.61E−04 | |
| S4 | 99.0000 | −4.23E−01 | 1.38E−02 | −4.81E−03 | −4.90E−05 | |
| S5 | 99.0000 | −3.83E−01 | 1.21E−02 | −3.51E−03 | 5.55E−04 | |
| S6 | −3.0453 | 1.79E−01 | 5.14E−02 | 6.99E−04 | 4.60E−05 | |
| S7 | −9.6723 | 2.16E−01 | 6.62E−02 | −1.48E−02 | 5.02E−03 | |
| S8 | 65.8461 | 1.41E−01 | −4.91E−02 | 2.11E−02 | 2.65E−03 | |
| S9 | 8.7504 | 4.14E−02 | −7.09E−02 | 2.73E−02 | −3.10E−03 | |
| S10 | 2.3057 | 9.00E−02 | −9.05E−02 | 1.44E−02 | −1.30E−03 | |
| S11 | −60.3463 | −5.25E−02 | −1.06E−01 | 1.13E−02 | −7.21E−03 | |
| S12 | −0.3057 | 3.68E−01 | −9.27E−03 | 2.60E−02 | −1.05E−03 | |
| S13 | 50.0057 | 5.27E−01 | 2.01E−02 | 2.12E−02 | −6.65E−03 | |
| S14 | −63.9402 | 1.17E+00 | −1.79E−01 | 2.76E−02 | −8.58E−03 | |
| S15 | −50.1521 | 5.75E−01 | −1.56E−01 | 1.83E−02 | −9.84E−03 | |
| | surface | | | | | |
| | number | A₁₂ | A₁₄ | A₁₆ | A₁₈ | A₂₀ |
| | S1 | 3.66E−04 | 5.50E−05 | 0.00E+00 | 0.00E+00 | 0.00E+00 |
| | S2 | 1.91E−04 | 0.00E+00 | 0.00E+00 | 0.00E+00 | 0.00E+00 |
| | S4 | −2.95E−04 | −6.60E−05 | −1.01E−04 | −8.00E−06 | 0.00E+00 |
| | S5 | 1.04E−04 | 1.19E−04 | −4.20E−05 | 4.00E−06 | 0.00E+00 |
| | S6 | −3.60E−04 | 1.36E−04 | −9.70E−05 | −3.00E−05 | 0.00E+00 |
| | S7 | −2.01E−03 | 7.94E−04 | −1.54E−03 | 1.92E−04 | −7.40E−05 |
| | S8 | 6.58E−04 | 3.30E−04 | −1.83E−03 | 1.79E−04 | −2.47E−04 |
| | S9 | 1.73E−03 | 1.93E−04 | −1.60E−05 | 1.48E−04 | −5.20E−05 |
| | S10 | 2.58E−03 | 1.71E−04 | 3.41E−04 | 1.44E−04 | 2.60E−05 |
| | S11 | 1.58E−03 | −1.35E−03 | −3.30E−04 | −9.90E−05 | 0.00E+00 |
| | S12 | 3.40E−03 | −1.18E−04 | 4.60E−05 | 2.30E−05 | 5.00E−06 |
| | S13 | 1−1.50E−03 | −2.78E−03 | −4.00E−04 | −5.50E−05 | 9.00E−06 |
| | S14 | 8.80E−05 | −1.94E−03 | −5.60E−05 | 0.00E+00 | 0.00E+00 |
| | S15 | −8.01E−04 | −1.57E−03 | 2.28E−04 | 0.00E+00 | 0.00E+00 |

FIG. 10A illustrates a longitudinal aberration curve of the optical system 300 in the first state in Embodiment 3, representing deviations of focal points of light of different wavelengths converged after passing through the optical system 300. FIG. 10B illustrates an astigmatic curve of the optical system 300 in the first state in Embodiment 3, representing a curvature of a tangential image plane and a curvature of a sagittal image plane corresponding to different image heights. FIG. 10C illustrates a distortion curve of the optical system 300 in the first state in Embodiment 3, representing amounts of distortion corresponding to different image heights. It can be seen from FIG. 10A, FIG. 10B and FIG. 10C that the optical system 300 in Embodiment 3 can achieve a good imaging quality in the first state.

### Embodiment 4

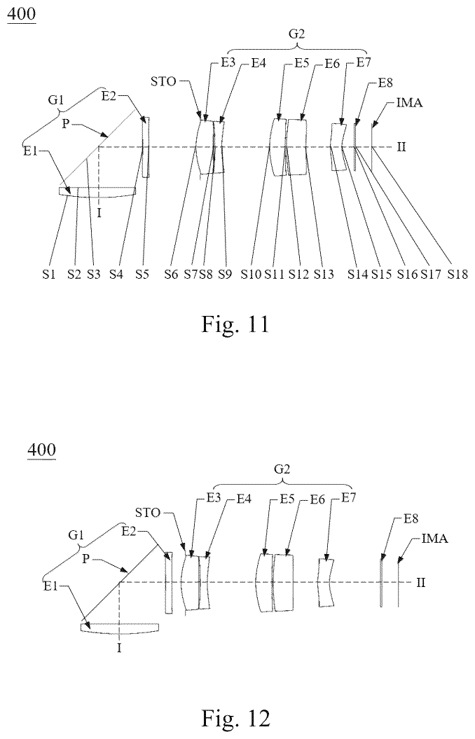

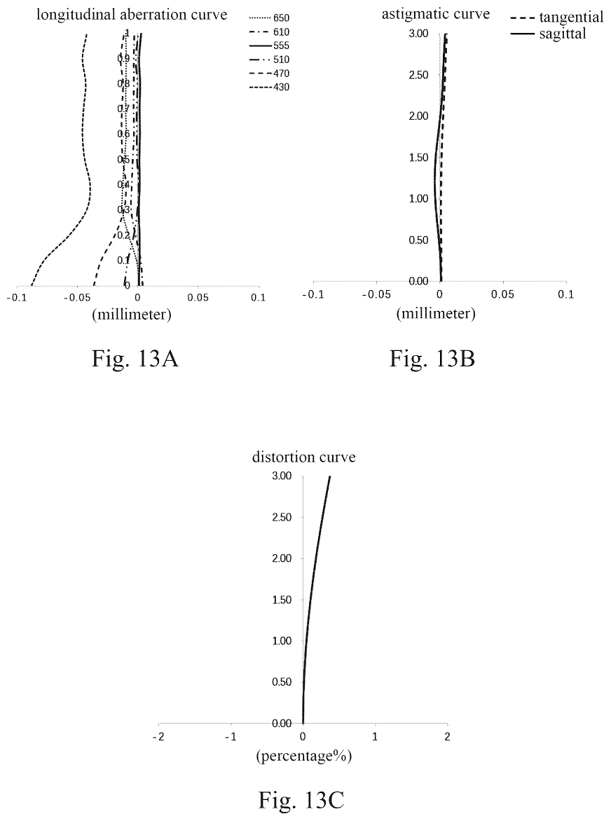

An optical system according to Embodiment 4 is described below with reference to FIG. 11, FIG. 12, FIG. 13A, FIG. 13B, and FIG. 13C.

As shown in FIG. 11 and FIG. 12, the optical system 400 may include a first element group G1 and a second element group G2 arranged sequentially from an object side to an image side. The image side may be provided with, for example, an image plane IMA. The range of imaging object distances of the optical system 400 may be from 15.4576 cm to infinity. A magnification of the optical system 400 may be 8×.

The first element group G1 may include a first lens E1, a reflective element P and a second lens E2. The second element group G2 may include a diaphragm STO, a third lens E3, a fourth lens E4, a fifth lens E5, a sixth lens E6 and a seventh lens E7. In particular, the first lens E1 is located on the optical axis I and is disposed between the object side and the reflective element P. The second lens E2, the diaphragm STO, the third lens E3, the fourth lens E4, the fifth lens E5, the sixth lens E6, and the seventh lens E7 are arranged sequentially along the optical axis II from the reflective element P to the image side. In an example, an optical filter E8 may be provided between the seventh lens E7 and the image plane IMA.

The first element group G1 is fixed in a position relative to the image plane IMA on the optical axis II. The second element group G2 may move along the optical axis II relative to the first element group G1. When a distance between a photographed object and the optical system 400 is decreased, adjusting the distance between the second element group G2 and the first element group G1 on the optical axis II enables the optical system 400 to switch between a first state and a second state to achieve a focusing function of the optical system 400. During the focusing of the optical system 400, a maximal travelling distance of the second element group G2 may be 5.7236 mm.

The first lens E1 may have a positive refractive power, an object-side surface S1 of the first lens E1 is a convex surface, and an image-side surface S2 of the first lens E1 is a concave surface. The reflective element P may have a reflective surface S3, and the reflective surface S3 is a planar surface. The second lens E2 may have a negative refractive power, an object-side surface S4 of the second lens E2 is a concave surface, and an image-side surface S5 of the second lens E2 is a convex surface. The third lens E3 may have a positive refractive power, an object-side surface S6 of the third lens E3 is a convex surface, and an image-side surface S7 of the third lens E3 is a concave surface. The fourth lens E4 may have a negative refractive power, an object-side surface S8 of the fourth lens E4 is a concave surface, and an image-side surface S9 of the fourth lens E4 is a concave surface. The fifth lens E5 may have a positive refractive power, an object-side surface S10 of the fifth lens E5 is a convex surface, and an image-side surface S11 of the fifth lens E5 is a concave surface. The sixth lens E6 may have a positive refractive power, an object-side surface S12 of the sixth lens E6 is a convex surface, and an image-side surface S13 of the sixth lens E6 is a concave surface. The seventh lens E7 may have a negative refractive power, an object-side surface S14 of the seventh lens E7 is a convex surface, and an image-side surface S15 of the seventh lens E7 is a concave surface. The optical filter E8 may have an object-side surface S16 and an image-side surface S17. Light from an object sequentially passes through the surfaces S1-S17 and finally forms an image on an image plane S18.

Table 7 shows a table of basic parameters of the optical system 400 in Embodiment 4. Here, the units of a radius of curvature and a thickness/distance are millimeters (mm).

TABLE 7

| | | | | | | material | |
|---|---|---|---|---|---|---|---|
| surface | | surface | radius of | thickness/ | | refractive | abbe |
| number | element | type | curvature | distance | texture | index | number |
| S1 | first lens | aspheric | 34.2194 | 1.4861 | plastic | 1.5351 | 55.6631 |
| S2 | | aspheric | 1055.7776 | 6.0440 | | | |
| S3 | reflective | | infinite | −6.7779 | | | |
| | element | | | | | | |
| S4 | second | aspheric | 57.9376 | −0.8984 | plastic | 1.5990 | 29.4340 |
| | lens | | | | | | |
| S5 | | aspheric | 129.0884 | W1 | | | |
| STO | aperture | | infinite | 0.7339 | | | |
| S6 | third lens | aspheric | −10.2244 | −2.5865 | plastic | 1.5350 | 55.7290 |
| S7 | | aspheric | −382.8131 | −0.2328 | | | |
| S8 | fourth lens | aspheric | 98.6854 | −1.0260 | plastic | 1.6373 | 23.7950 |
| S9 | | aspheric | −12.3327 | −7.1756 | | | |
| S10 | fifth lens | aspheric | −10.3536 | −2.3522 | plastic | 1.5431 | 49.5788 |
| S11 | | aspheric | −41.8351 | −0.1857 | | | |
| S12 | sixth lens | aspheric | −25.1624 | −2.9250 | plastic | 1.6700 | 19.4000 |
| S13 | | aspheric | −44.7753 | −3.6641 | | | |
| S14 | seventh | aspheric | −8.2470 | −1.7286 | plastic | 1.6079 | 27.8267 |
| | lens | | | | | | |
| S15 | | aspheric | −4.9698 | W2 | | | |
| S16 | optical | | infinite | −0.2100 | glass | 1.5168 | 51.4060 |
| | filter | | | | | | |
| S17 | | | infinite | −2.4459 | | | |
| S18 | image | | infinite | | | | |
| | plane | | | | | | |

In this embodiment, the positive or negative sign of the numerical value of the radius of curvature of each surface indicates only a bending direction of the surface. When a surface of a lens on the optical axis I and a surface of a lens on the optical axis II have the same bending direction, the numerical signs (positive or negative) of the radii of curvature of the surfaces are opposite to each other. Similarly, the positive or negative sign for the numerical value of the thickness/distance of each surface indicates the direction only. The bending direction of each surface and the thickness/distance of each surface may be referred to in FIG. 11 and FIG. 12.

Here, an on-axis distance W1 from the first element group G1 to the second element group G2, and an on-axis distance W2 from the second element group G2 to the optical filter E8 are variables, which may change as the distance between the photographed object and the optical system 400 changes.

When the photographed object is at infinity from the optical system 400, the optical system 400 is in the first state, and a structural diagram of the optical system 400 may be referred to in FIG. 11, where, W1=−7.7017 mm, W2=−1.8106 mm, an effective focal length of the optical system 400 EFL=27.74 mm, an aperture value of the optical system 400 in a first direction Fnox=1.7234, an aperture value of the optical system 400 in a second direction Fnoy=2.4582, and a maximal field-of-view of the optical system 400 FOV=12.298°. When the photographed object is at a preset distance from the optical system 400, the optical system 400 is in the second state, and a structural diagram of the optical system 400 may be referred to in FIG. 12.

In this embodiment, the object-side surface and the image-side surface of any lens in the first lens E1 to the seventh lens E7 are both aspheric surfaces. Table 8 gives the conic coefficient K and the high-order coefficients A₄, A₆, As, A₁₀, A₁₂, A₁₄, A₁₆, A₁₈ and A₂₀ applicable to the aspheric surfaces S1-S2, S4-S15 in Embodiment 4.

TABLE 8

| surface | | | | | | |
|---|---|---|---|---|---|---|
| number | K | A₄ | A₆ | A₈ | A₁₀ | |
| S1 | −9.9526 | 1.68E−02 | −1.63E−02 | −4.43E−03 | −8.65E−04 | |
| S2 | 99.0000 | −8.50E−02 | −1.30E−02 | −5.21E−03 | −9.21E−04 | |
| S4 | 15.2204 | −5.62E−01 | 7.66E−03 | 3.78E−04 | −4.90E−04 | |
| S5 | −32.0446 | −4.96E−01 | 4.20E−03 | 3.57E−04 | −4.43E−04 | |
| S6 | −1.6530 | 2.39E−01 | 6.18E−02 | −6.60E−03 | −2.07E−03 | |
| S7 | 13.6168 | 3.62E−01 | 1.02E−01 | −1.76E−02 | 7.31E−03 | |
| S8 | 86.5418 | 4.14E−01 | −7.82E−03 | 2.83E−02 | 1.28E−03 | |
| S9 | −17.4681 | 2.48E−01 | −1.47E−02 | 3.23E−02 | −6.64E−03 | |
| S10 | 1.8603 | 6.04E−01 | −1.13E−01 | −2.67E−03 | 9.05E−03 | |
| S11 | 48.5446 | −3.85E−02 | −1.93E−01 | −2.86E−02 | 4.10E−03 | |
| S12 | 5.4050 | 8.85E−02 | 1.38E−02 | 2.26E−03 | 9.96E−04 | |
| S13 | −90.9506 | 3.40E−01 | −2.29E−03 | −1.41E−03 | −6.39E−03 | |
| S14 | −9.4214 | 9.66E−01 | −2.33E−01 | 3.04E−02 | 9.48E−03 | |
| S15 | −5.2420 | 4.07E−01 | −1.57E−01 | 3.82E−02 | 3.63E−03 | |
| | surface | | | | | |
| | number | A₁₂ | A₁₄ | A₁₆ | A₁₈ | A₂₀ |
| | S1 | −3.62E−04 | −4.80E−05 | −2.10E−05 | 0.00E+00 | 0.00E+00 |
| | S2 | −4.03E−04 | −4.10E−05 | −1.90E−05 | 0.00E+00 | 0.00E+00 |
| | S4 | 1.03E−04 | 4.90E−05 | 4.00E−06 | 6.00E−06 | 0.00E+00 |
| | S5 | 7.00E−05 | −4.10E−05 | 1.00E−05 | 9.00E−06 | 0.00E+00 |
| | S6 | −1.44E−04 | 2.54E−04 | 2.00E−06 | 6.00E−05 | 0.00E+00 |
| | S7 | −3.77E−03 | 2.23E−03 | 1.05E−03 | 4.20E−04 | −1.16E−04 |
| | S8 | −3.20E−03 | 1.98E−03 | 1.18E−03 | 4.16E−04 | −1.23E−04 |
| | S9 | −7.05E−04 | 3.38E−04 | 2.56E−04 | 1.47E−04 | −4.00E−05 |
| | S10 | −6.46E−04 | −4.00E−05 | 3.20E−05 | −1.30E−05 | −8.00E−06 |
| | S11 | −5.36E−03 | 8.61E−04 | −8.89E−04 | 1.16E−04 | 0.00E+00 |
| | S12 | −1.86E−03 | 5.71E−04 | −1.77E−04 | 2.40E−05 | 6.00E−06 |
| | S13 | 1.26E−03 | 7.30E−05 | 5.10E−05 | 3.30E−05 | 4.00E−06 |
| | S14 | −1.38E−03 | −2.63E−03 | 8.81E−04 | 6.60E−05 | −2.40E−05 |
| | S15 | −4.98E−03 | −1.87E−03 | −4.90E−05 | −6.10E−05 | −2.57E−04 |

FIG. 13A illustrates a longitudinal aberration curve of the optical system 400 in the first state in Embodiment 4, representing deviations of focal points of light of different wavelengths converged after passing through the optical system 400. FIG. 13B illustrates an astigmatic curve of the optical system 400 in the first state in Embodiment 4, representing a curvature of a tangential image plane and a curvature of a sagittal image plane corresponding to different image heights. FIG. 13C illustrates a distortion curve of the optical system 400 in the first state in Embodiment 4, representing amounts of distortion corresponding to different image heights. It can be seen from FIG. 13A, FIG. 13B and FIG. 13C that the optical system 400 in Embodiment 4 can achieve a good imaging quality in the first state.

### Embodiment 5

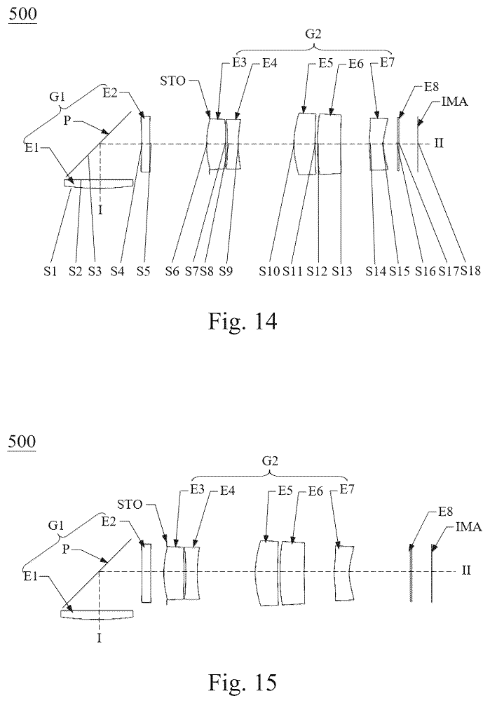

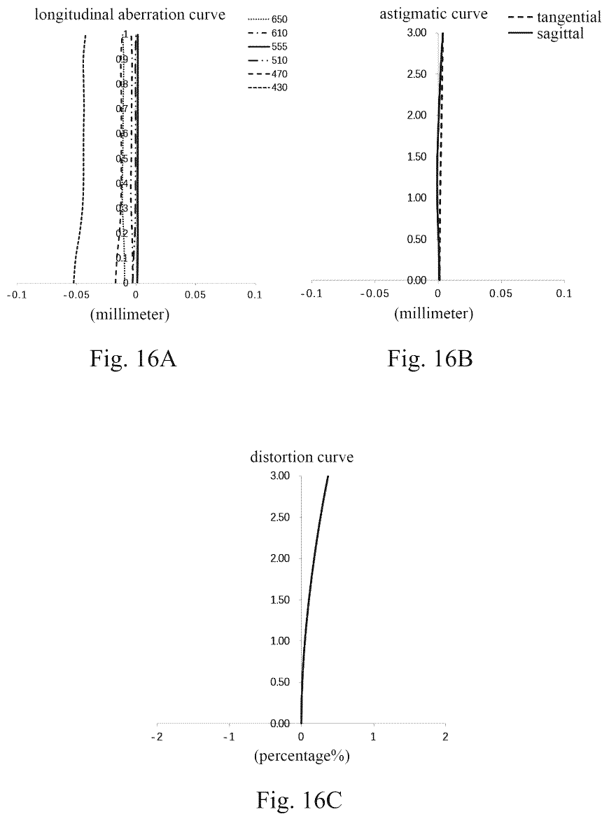

An optical system according to Embodiment 5 is described below with reference to FIG. 14, FIG. 15, FIG. 16A, FIG. 16B, and FIG. 16C.

As shown in FIG. 14 and FIG. 15, the optical system 500 may include a first element group G1 and a second element group G2 arranged sequentially from an object side to an image side. The image side may be provided with, for example, an image plane IMA. The range of imaging object distances of the optical system 500 may be from 16.0957 cm to infinity. A magnification of the optical system 500 may be 8×.

The first element group G1 may include a first lens E1, a reflective element P and a second lens E2. The second element group G2 may include a diaphragm STO, a third lens E3, a fourth lens E4, a fifth lens E5, a sixth lens E6 and a seventh lens E7. In particular, the first lens E1 is located on the optical axis I and is disposed between the object side and the reflective element P. The second lens E2, the diaphragm STO, the third lens E3, the fourth lens E4, the fifth lens E5, the sixth lens E6, and the seventh lens E7 are arranged sequentially along an optical axis II from the reflective element P to the image side. In an example, an optical filter E8 may be provided between the seventh lens E7 and the image plane IMA.

The first element group G1 is fixed in a position relative to the image plane IMA on the optical axis II. The second element group G2 may move along the optical axis II relative to the first element group G1. When the distance between a photographed object and the optical system 500 is decreased, adjusting the distance between the second element group G2 and the first element group G1 on the optical axis II enables the optical system 500 to switch between a first state and a second state to achieve a focusing function of the optical system 500. During the focusing of the optical system 500, a maximal travelling distance of the second element group G2 may be 5.7245 mm.

The first lens E1 may have a positive refractive power, an object-side surface S1 of the first lens E1 is a convex surface, and an image-side surface S2 of the first lens E1 is a concave surface. The reflective element P may have a reflective surface S3, and the reflective surface S3 is a planar surface. The second lens E2 may have a negative refractive power, an object-side surface S4 of the second lens E2 is a concave surface, and an image-side surface S5 of the second lens E2 is a convex surface. The third lens E3 may have a positive refractive power, an object-side surface S6 of the third lens E3 is a convex surface, and an image-side surface S7 of the third lens E3 is a convex surface. The fourth lens E4 may have a negative refractive power, an object-side surface S8 of the fourth lens E4 is a concave surface, and an image-side surface S9 of the fourth lens E4 is a concave surface. The fifth lens E5 may have a positive refractive power, an object-side surface S10 of the fifth lens E5 is a convex surface, and an image-side surface S11 of the fifth lens E5 is a concave surface. The sixth lens E6 may have a positive refractive power, an object-side surface S12 of the sixth lens E6 is a convex surface, and an image-side surface S13 of the sixth lens E6 is a concave surface. The seventh lens E7 may have a negative refractive power, an object-side surface S14 of the seventh lens E7 is a convex surface, and an image-side surface S15 of the seventh lens E7 is a concave surface. The optical filter E8 may have an object-side surface S16 and an image-side surface S17. Light from an object sequentially passes through the surfaces S1-S17 and finally forms an image on an image plane S18.

Table 9 shows a table of basic parameters of the optical system 500 in Embodiment 5. Here, the units of a radius of curvature and a thickness/distance are millimeters (mm).

TABLE 9

| | | | | | | material | |
|---|---|---|---|---|---|---|---|
| surface | | surface | radius of | thickness/ | | refractive | abbe |
| number | element | type | curvature | distance | texture | index | number |
| S1 | first lens | aspheric | 34.4708 | 1.0931 | plastic | 1.5350 | 55.7290 |
| S2 | | aspheric | 3000.9263 | 4.5692 | | | |
| S3 | reflective | | infinite | −5.5513 | | | |
| | element | | | | | | |
| S4 | second | aspheric | 65.9241 | −1.0926 | plastic | 1.5632 | 39.2685 |
| | lens | | | | | | |
| S5 | | aspheric | 195.5632 | W1 | | | |
| STO | aperture | | infinite | 0.3657 | | | |
| S6 | third lens | aspheric | −11.3404 | −2.4665 | plastic | 1.5350 | 55.7290 |
| S7 | | aspheric | 86.5774 | −0.2408 | | | |
| S8 | fourth | aspheric | 67.6560 | −1.3943 | plastic | 1.6198 | 25.9982 |
| | lens | | | | | | |
| S9 | | aspheric | −12.3183 | −7.1970 | | | |
| S10 | fifth lens | aspheric | −10.3739 | −2.7453 | plastic | 1.5350 | 55.7290 |
| S11 | | aspheric | −40.1111 | −0.2924 | | | |
| S12 | sixth | aspheric | −25.0525 | −3.0000 | plastic | 1.6762 | 19.4000 |
| | lens | | | | | | |
| S13 | | aspheric | −46.6121 | −3.7146 | | | |
| S14 | seventh | aspheric | −10.7072 | −1.8233 | plastic | 1.5825 | 31.7455 |
| | lens | | | | | | |
| S15 | | aspheric | −5.5225 | W2 | | | |
| S16 | optical | | infinite | −0.2100 | glass | 1.5168 | 51.4060 |
| | filter | | | | | | |
| S17 | | | infinite | −2.4459 | | | |
| S18 | image | | infinite | | | | |
| | plane | | | | | | |

In this embodiment, the positive or negative sign of the numerical value of the radius of curvature of each surface indicates only a bending direction of the surface. When a surface of a lens on the optical axis I and a surface of a lens on the optical axis II have the same bending direction, the numerical signs (positive or negative) of the radii of curvature of the surfaces are opposite to each other. Similarly, the positive or negative sign of the numerical value of the thickness/distance of each surface indicates the direction only. The bending direction of each surface and the thickness/distance of each surface may be referred to in FIG. 14 and FIG. 15.

Here, an on-axis distance W1 from the first element group G1 to the second element group G2, and an on-axis distance W2 from the second element group G2 to the optical filter E8 are variables, which may change as the distance between the photographed object and the optical system 500 changes.

When the photographed object is at infinity from the optical system 500, the optical system 500 is in the first state, and a structural diagram of the optical system 500 may be referred to in FIG. 14, where, W1=−7.6881 mm, W2=−1.8116 mm, an effective focal length of the optical system 500 EFL=27.74 mm, an aperture value of the optical system 500 in a first direction Fnox=2.3469, an aperture value of the optical system 500 in a second direction Fnoy=3.33543, and a maximal field-of-view of the optical system 500 FOV=12.2987°. When the photographed object is at a preset distance from the optical system 500, the optical system 500 is in the second state, and a structural diagram of the optical system 500 may be referred to in FIG. 15.

In this embodiment, the object-side surface and the image-side surface of any lens in the first lens E1 to the seventh lens E7 are both aspheric surfaces. Table 10 gives the conic coefficient K and the high-order coefficients A₄, A₆, A₈, A₁₀, A₁₂, A₁₄, A₁₆, A₁₈ and A₂₀ applicable to the aspheric surfaces S1-S2, S4-S15 in Embodiment 5.

TABLE 10

| surface | | | | | | |
|---|---|---|---|---|---|---|
| number | K | A₄ | A₆ | A₈ | A₁₀ | |
| S1 | −10.4903 | 1.11E−02 | −1.69E−02 | −2.33E−03 | 4.58E−04 | |
| S2 | 99.0000 | −7.64E−02 | −1.78E−02 | −5.36E−03 | −8.90E−04 | |
| S4 | 14.3575 | −5.61E−01 | 5.78E−03 | −5.50E−05 | 2.41E−04 | |
| S5 | 99.0000 | −4.98E−01 | 1.90E−03 | 8.10E−05 | 3.45E−04 | |
| S6 | −1.6454 | 2.38E−01 | 5.61E−02 | −1.82E−03 | −1.28E−03 | |
| S7 | 87.1680 | 3.66E−01 | 7.62E−02 | −9.91E−04 | 1.53E−03 | |
| S8 | 89.8126 | 4.16E−01 | −1.82E−02 | 3.26E−02 | 4.90E−05 | |
| S9 | −16.6964 | 2.35E−01 | −4.96E−03 | 3.06E−02 | −5.38E−03 | |
| S10 | 1.9046 | 5.88E−01 | −1.03E−01 | −3.96E−03 | 7.77E−03 | |
| S11 | 31.7295 | 3.28E−03 | −2.05E−01 | −2.81E−02 | 1.75E−03 | |
| S12 | 4.4211 | 9.43E−02 | 2.82E−03 | 6.95E−03 | −3.43E−04 | |
| S13 | −36.9785 | 3.03E−01 | 1.90E−03 | 3.34E−03 | −8.52E−03 | |
| S14 | −10.3315 | 1.01E+00 | −2.31E−01 | 3.78E−02 | 1.71E−03 | |
| S15 | −5.1713 | 3.81E−01 | −1.76E−01 | 4.21E−02 | 2.84E−03 | |
| | surface | | | | | |
| | number | A₁₂ | A₁₄ | A₁₆ | A₁₈ | A₂₀ |
| | S1 | 5.30E−05 | 1.22E−07 | −1.80E−05 | 0.00E+00 | 0.00E+00 |
| | S2 | −7.61E−04 | −2.61E−04 | −7.10E−05 | 0.00E+00 | 0.00E+00 |
| | S4 | 5.12E−04 | 6.00E−05 | 1.00E−06 | −1.50E−05 | 0.00E+00 |
| | S5 | 5.53E−04 | 1.07E−04 | 1.60E−05 | −1.10E−05 | 0.00E+00 |
| | S6 | −3.89E−04 | 1.50E−05 | 1.70E−05 | 2.20E−05 | 0.00E+00 |
| | S7 | −1.93E−03 | −2.69E−04 | −1.82E−04 | 5.13E−04 | −2.10E−05 |
| | S8 | −8.51E−04 | −7.40E−04 | −4.64E−04 | 3.58E−04 | −6.80E−05 |
| | S9 | −2.32E−03 | −1.37E−03 | −3.16E−04 | 3.00E−06 | −6.80E−05 |
| | S10 | −5.18E−04 | −6.48E−04 | −1.44E−04 | 4.90E−05 | 1.70E−05 |
| | S11 | −1.99E−03 | −4.22E−04 | −5.71E−04 | 7.10E−05 | 0.00E+00 |
| | S12 | −4.15E−04 | 1.63E−04 | −5.70E−05 | 3.30E−05 | 8.00E−06 |
| | S13 | 9.48E−04 | −2.02E−04 | −2.09E−04 | −1.00E−04 | −6.00E−06 |
| | S14 | −1.12E−04 | −1.51E−03 | −8.28E−04 | −8.50E−05 | 6.00E−06 |
| | S15 | −1.16E−03 | −3.48E−03 | −1.86E−03 | −5.69E−04 | −1.19E−04 |

FIG. 16A illustrates a longitudinal aberration curve of the optical system 500 in the first state in Embodiment 5, representing deviations of focal points of light of different wavelengths converged after passing through the optical system 500. FIG. 16B illustrates an astigmatic curve of the optical system 500 in the first state in Embodiment 5, representing a curvature of a tangential image plane and a curvature of a sagittal image plane corresponding to different image heights. FIG. 16C illustrates a distortion curve of the optical system 500 in the first state in Embodiment 5, representing amounts of distortion corresponding to different image heights. It can be seen from FIG. 16A, FIG. 16B and FIG. 16C that the optical system 500 in Embodiment 5 can achieve a good imaging quality in the first state.

### Embodiment 6

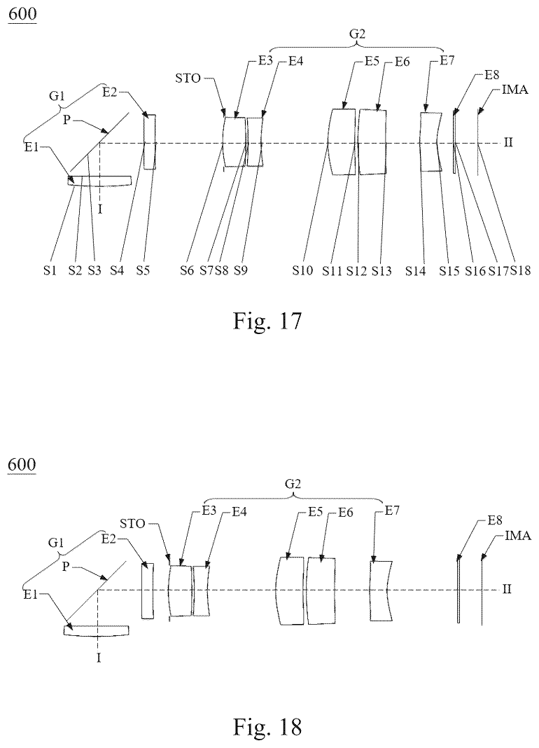

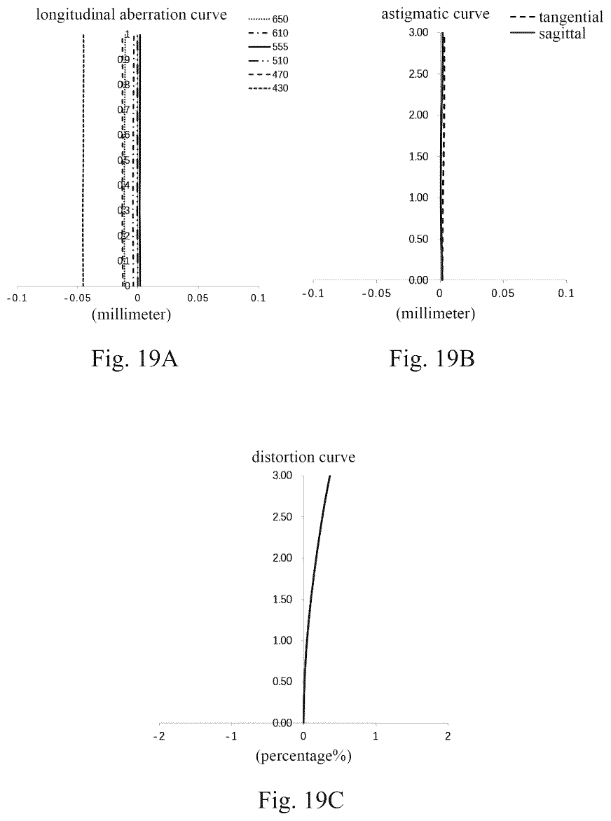

An optical system according to Embodiment 6 is described below with reference to FIG. 17, FIG. 18, FIG. 19A, FIG. 19B, and FIG. 19C.

As shown in FIG. 17 and FIG. 18, the optical system 600 may include a first element group G1 and a second element group G2 arranged sequentially from an object side to an image side. The image side may be provided with, for example, an image plane IMA. The range of imaging object distances of the optical system 600 may be from 16.4123 cm to infinity. A magnification of the optical system 600 may be 8×.

The first element group G1 may include a first lens E1, a reflective element P and a second lens E2. The second element group G2 may include a diaphragm STO, a third lens E3, a fourth lens E4, a fifth lens E5, a sixth lens E6 and a seventh lens E7. In particular, the first lens E1 is located on the optical axis I and is disposed between the object side and the reflective element P. The second lens E2, the diaphragm STO, the third lens E3, the fourth lens E4, the fifth lens E5, the sixth lens E6, and the seventh lens E7 are arranged sequentially along the optical axis II from the reflective element P to the image side. In an example, an optical filter E8 may be provided between the seventh lens E7 and the image plane IMA.

The first element group G1 is fixed in a position relative to the image plane IMA on the optical axis II. The second element group G2 may move along the optical axis II relative to the first element group G1. When a distance between a photographed object and the optical system 600 is decreased, adjusting a distance between the second element group G2 and the first element group G1 on the optical axis II enables the optical system 600 to switch between a first state and a second state to achieve a focusing function of the optical system 600. During the focusing of the optical system 600, a maximal travelling distance of the second element group G2 may be 5.7243 mm.

The first lens E1 may have a positive refractive power, an object-side surface S1 of the first lens E1 is a convex surface, and an image-side surface S2 of the first lens E1 is a concave surface. The reflective element P may have a reflective surface S3, and the reflective surface S3 is a planar surface. The second lens E2 may have a negative refractive power, an object-side surface S4 of the second lens E2 is a concave surface, and an image-side surface S5 of the second lens E2 is a concave surface. The third lens E3 may have a positive refractive power, an object-side surface S6 of the third lens E3 is a convex surface, and an image-side surface S7 of the third lens E3 is a convex surface. The fourth lens E4 may have a negative refractive power, an object-side surface S8 of the fourth lens E4 is a concave surface, and an image-side surface S9 of the fourth lens E4 is a concave surface. The fifth lens E5 may have a positive refractive power, an object-side surface S10 of the fifth lens E5 is a convex surface, and an image-side surface S11 of the fifth lens E5 is a concave surface. The sixth lens E6 may have a positive refractive power, an object-side surface S12 of the sixth lens E6 is a convex surface, and an image-side surface S13 of the sixth lens E6 is a concave surface. The seventh lens E7 may have a negative refractive power, an object-side surface S14 of the seventh lens E7 is a convex surface, and an image-side surface S15 of the seventh lens E7 is a concave surface. The optical filter E8 may have an object-side surface S16 and an image-side surface S17. Light from an object sequentially passes through the surfaces S1-S17 and finally forms an image on an image plane S18.

Table 11 shows a table of basic parameters of the optical system 600 in Embodiment 6. Here, the units of a radius of curvature and a thickness/distance are millimeters (mm).

TABLE 11

| | | | | | | material | |
|---|---|---|---|---|---|---|---|
| surface | | surface | radius of | thickness/ | | refractive | abbe |
| number | element | type | curvature | distance | texture | index | number |
| S1 | first lens | aspheric | 34.1655 | 1.0947 | plastic | 1.5350 | 55.7290 |
| S2 | | aspheric | 2960.9604 | 3.7055 | | | |
| S3 | reflective | | infinite | −4.8485 | | | |
| | element | | | | | | |
| S4 | second | aspheric | 206.5098 | −1.1921 | plastic | 1.5437 | 49.1953 |
| | lens | | | | | | |
| S5 | | aspheric | −189.5933 | W1 | | | |
| STO | aperture | | infinite | 0.1171 | | | |
| S6 | third lens | aspheric | −11.7721 | −2.5055 | plastic | 1.5350 | 55.7290 |
| S7 | | aspheric | 57.4414 | −0.2586 | | | |
| S8 | fourth | aspheric | 57.6443 | −1.4067 | plastic | 1.6158 | 26.5745 |
| | lens | | | | | | |
| S9 | | aspheric | −12.2889 | −7.2750 | | | |
| S10 | fifth lens | aspheric | −10.4044 | −2.9301 | plastic | 1.5350 | 55.7290 |
| S11 | | aspheric | −41.8329 | −0.3426 | | | |
| S12 | sixth lens | aspheric | −26.3892 | −3.0000 | plastic | 1.6700 | 19.4000 |
| S13 | | aspheric | −47.0006 | −3.7325 | | | |
| S14 | seventh | aspheric | −11.6858 | −1.8508 | plastic | 1.5807 | 33.6281 |
| | lens | | | | | | |
| S15 | | aspheric | −5.7369 | W2 | | | |
| S16 | optical | | infinite | −0.2100 | glass | 1.5168 | 51.4060 |
| | filter | | | | | | |
| S17 | | | infinite | −2.4459 | | | |
| S18 | image | | infinite | | | | |
| | plane | | | | | | |

In this embodiment, the positive or negative sign of the numerical value of the radius of curvature of each surface indicates only the bending direction of the surface. When a surface of a lens on the optical axis I and a surface of a lens on the optical axis II have the same bending direction, the numerical signs (positive or negative) of the radii of curvature of the surfaces are opposite to each other. Similarly, the positive or negative sign of the numerical value of the thickness/distance of each surface indicates the direction only. The direction of curvature of each surface and the thickness/distance of each surface may be referred to in FIG. 17 and FIG. 18.

Here, an on-axis distance W1 from the first element group G1 to the second element group G2, and an on-axis distance W2 from the second element group G2 to the optical filter E8 are variables, which may change as the distance between the photographed object and the optical system 600 changes.

When the photographed object is at infinity from the optical system 600, the optical system 600 is in the first state, and a structural diagram of the optical system 600 may be referred to in FIG. 17, where, W1=−7.4737 mm, W2=−1.8124 mm, an effective focal length of the optical system 600 EFL=27.74 mm, an aperture value of the optical system 600 in a first direction Fnox=2.9764, an aperture value of the optical system 600 in a second direction Fnoy=4.2546, and a maximal field-of-view of the optical system 600 FOV=12.2987°. When the photographed object is at a preset distance from the optical system 600, the optical system 600 is in the second state, and a structural diagram of the optical system 600 may be referred to in FIG. 18.

In this embodiment, the object-side surface and the image-side surface of any lens in the first lens E1 to the seventh lens E7 are both aspheric surfaces. Table 12 gives the conic coefficient K and the high-order coefficients A₄, A₆, A₈, A₁₀, A₁₂, A₁₄, A₁₆, A₁₈ and A₂₀ applicable to the aspheric surfaces S1-S2, S4-S15 in Embodiment 6.

TABLE 12

| surface | | | | | | |
|---|---|---|---|---|---|---|
| number | K | A₄ | A₆ | A₈ | A₁₀ | |
| S1 | 10.7769 | 7.83E−03 | −1.64E−02 | −1.26E−03 | −8.30E−05 | |
| S2 | 99.0000 | −7.18E−02 | −1.96E−02 | −4.58E−03 | −1.12E−03 | |
| S4 | 60.1272 | −5.60E−01 | 5.11E−03 | 7.80E−05 | 4.74E−04 | |
| S5 | 38.3237 | −4.99E−01 | 1.49E−03 | 5.51E−04 | 6.33E−04 | |
| S6 | −1.6520 | 2.38E−01 | 5.43E−02 | 1.04E−03 | −2.09E−03 | |
| S7 | 71.2864 | 3.61E−01 | 7.47E−02 | 3.73E−03 | −1.68E−03 | |
| S8 | 87.4443 | 4.14E−01 | −1.78E−02 | 3.37E−02 | −1.31E−03 | |
| S9 | −16.4692 | 2.26E−01 | −3.65E−03 | 3.07E−02 | −5.04E−03 | |
| S10 | 1.8811 | 5.89E−01 | −1.01E−01 | −5.74E−03 | 8.20E−03 | |
| S11 | 21.7045 | 1.85E−02 | −2.07E−01 | −2.97E−02 | 2.69E−03 | |
| S12 | 5.1607 | 9.14E−02 | 3.48E−03 | 7.69E−03 | −1.03E−03 | |
| S13 | −422.125 | 2.91E−01 | 4.58E−03 | 4.02E−03 | −9.70E−03 | |
| S14 | −10.3339 | 1.01E+00 | −2.37E−01 | 4.06E−02 | 2.18E−03 | |
| S15 | −5.1589 | 3.64E−01 | −1.76E−01 | 4.58E−02 | 2.60E−03 | |
| | surface | | | | | |
| | number | A₁₂ | A₁₄ | A₁₆ | A₁₈ | A₂₀ |
| | S1 | −2.22E−04 | −1.20E−05 | −3.20E−05 | 0.00E+00 | 0.00E+00 |
| | S2 | −6.57E−04 | −1.50E−04 | −1.07E−04 | 0.00E+00 | 0.00E+00 |
| | S4 | 3.11E−04 | −9.00E−06 | 1.90E−05 | −2.50E−05 | 0.00E+00 |
| | S5 | 3.37E−04 | −5.00E−06 | 1.00E−05 | −2.80E−05 | 0.00E+00 |
| | S6 | −7.22E−04 | 1.32E−04 | 1.73E−04 | 7.00E−06 | 0.00E+00 |
| | S7 | −7.73E−04 | −3.46E−04 | −3.20E−04 | −1.78E−04 | 3.50E−05 |
| | S8 | −4.51E−04 | −7.21E−04 | −7.90E−05 | 7.40E−05 | 3.70E−05 |
| | S9 | −3.08E−03 | −1.05E−03 | −7.80E−05 | −9.10E−05 | −1.21E−04 |
| | S10 | −6.02E−04 | −4.69E−04 | 7.70E−05 | 1.71E−04 | 2.60E−05 |
| | S11 | −1.70E−03 | −9.50E−04 | −5.99E−04 | 3.03E−04 | 0.00E+00 |
| | S12 | 2.15E−04 | 2.08E−04 | −1.72E−04 | 3.70E−05 | 5.00E−06 |
| | S13 | 1.69E−03 | −3.89E−04 | −8.40E−05 | 8.80E−05 | 7.10E−05 |
| | S14 | 1.10E−04 | −2.06E−03 | −5.60E−04 | 2.34E−04 | 1.45E−04 |
| | S15 | −2.66E−03 | −3.97E−03 | −3.07E−04 | 6.82E−04 | 3.15E−04 |

FIG. 19A illustrates a longitudinal aberration curve of the optical system 600 in the first state in Embodiment 6, representing deviations of focal points of light of different wavelengths converged after passing through the optical system 600. FIG. 19B illustrates an astigmatic curve of the optical system 600 in the first state in Embodiment 6, representing a curvature of a tangential image plane and a curvature of a sagittal image plane corresponding to different image heights. FIG. 19C illustrates a distortion curve of the optical system 600 in the first state in Embodiment 6, representing amounts of distortion corresponding to different image heights. It can be seen from FIG. 19A, FIG. 19B and FIG. 19C that the optical system 600 in Embodiment 6 can achieve a good imaging quality in the first state.

### Embodiment 7

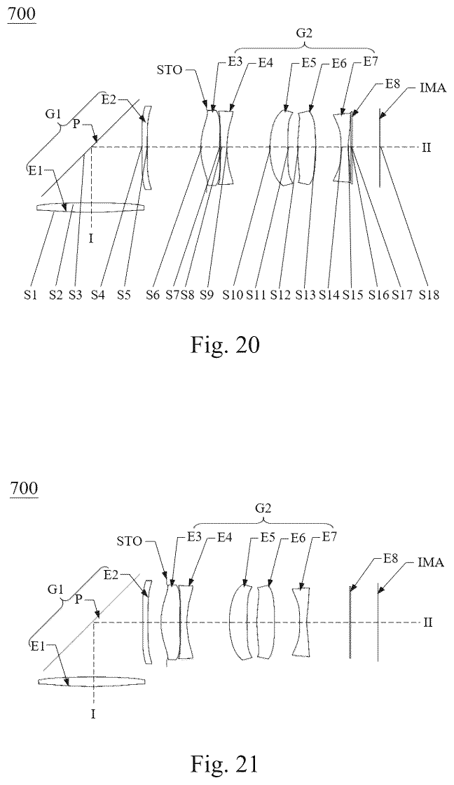

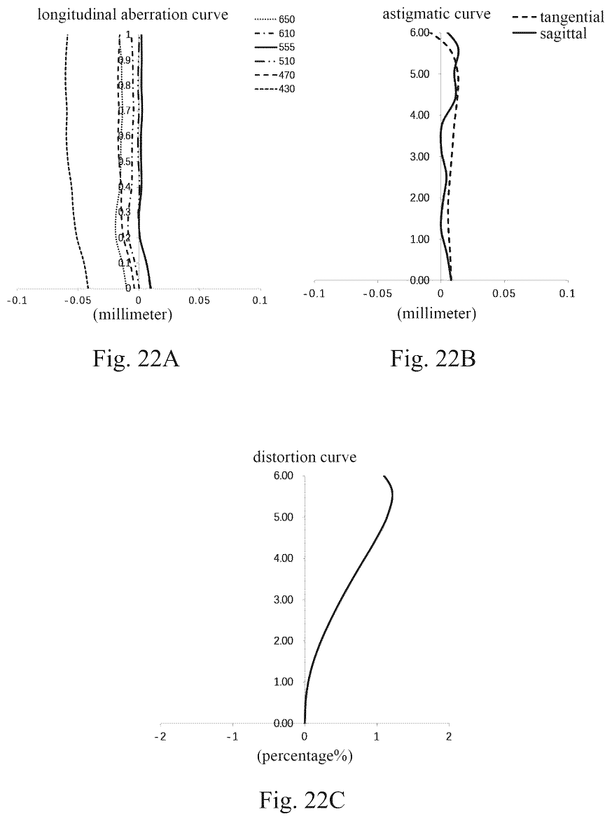

An optical system according to Embodiment 7 is described below with reference to FIG. 20, FIG. 21, FIG. 22A, FIG. 22B, and FIG. 22C.

As shown in FIG. 20 and FIG. 21, the optical system 700 may include a first element group G1 and a second element group G2 arranged sequentially from an object side to an image side. The image side may be provided with, for example, an image plane IMA. The range of imaging object distances of the optical system 700 may be from 18 cm to infinity. A magnification of the optical system 700 may be 5×.

The first element group G1 may include a first lens E1, a reflective element P and a second lens E2. The second element group G2 may include a diaphragm STO, a third lens E3, a fourth lens E4, a fifth lens E5, a sixth lens E6 and a seventh lens E7. In particular, the first lens E1 is located on the optical axis I and is disposed between the object side and the reflective element P. The second lens E2, the diaphragm STO, the third lens E3, the fourth lens E4, the fifth lens E5, the sixth lens E6, and the seventh lens E7 are arranged sequentially along the optical axis II from the reflective element P to the image side. In an example, an optical filter E8 may be provided between the seventh lens E7 and the image plane IMA.

The first element group G1 is fixed in a position relative to the image plane IMA on the optical axis II. The second element group G2 may move along the optical axis II relative to the first element group G1. When the distance between a photographed object and the optical system 700 is decreased, adjusting the distance between the second element group G2 and the first element group G1 on the optical axis II enables the optical system 700 to switch between a first state and a second state to achieve a focusing function of the optical system 700. During the focusing of the optical system 700, a maximal travelling distance of the second element group G2 may be 6.3982 mm.

The first lens E1 may have a positive refractive power, an object-side surface S1 of the first lens E1 is a convex surface, and an image-side surface S2 of the first lens E1 is a convex surface. The reflective element P may have a reflective surface S3, and the reflective surface S3 is a planar surface. The second lens E2 may have a negative refractive power, an object-side surface S4 of the second lens E2 is a concave surface, and an image-side surface S5 of the second lens E2 is a convex surface. The third lens E3 may have a positive refractive power, an object-side surface S6 of the third lens E3 is a convex surface, and an image-side surface S7 of the third lens E3 is a concave surface. The fourth lens E4 may have a negative refractive power, an object-side surface S8 of the fourth lens E4 is a concave surface, and an image-side surface S9 of the fourth lens E4 is a concave surface. The fifth lens E5 may have a positive refractive power, an object-side surface S10 of the fifth lens E5 is a convex surface, and an image-side surface S11 of the fifth lens E5 is a concave surface. The sixth lens E6 may have a positive refractive power, an object-side surface S12 of the sixth lens E6 is a convex surface, and an image-side surface S13 of the sixth lens E6 is a convex surface. The seventh lens E7 may have a negative refractive power, an object-side surface S14 of the seventh lens E7 is a convex surface, and an image-side surface S15 of the seventh lens E7 is a concave surface. The optical filter E8 may have an object-side surface S16 and an image-side surface S17. Light from an object sequentially passes through the surfaces S1-S17 and finally forms an image on an image plane S18.

Table 13 shows a table of basic parameters of the optical system 700 in Embodiment 7. Here, the units of a radius of curvature and a thickness/distance are millimeters (mm).

TABLE 13

| | | | | | | material | |
|---|---|---|---|---|---|---|---|
| surface | | surface | radius of | thickness/ | | refractive | abbe |
| number | element | type | curvature | distance | texture | index | number |
| S1 | first lens | aspheric | 62.2915 | 1.5223 | plastic | 1.5350 | 55.7290 |
| S2 | | aspheric | −125.9256 | 8.7547 | | | |
| S3 | reflective | | infinite | −8.2130 | | | |
| | element | | | | | | |
| S4 | second | aspheric | 88.8990 | −0.8175 | plastic | 1.5567 | 40.9164 |
| | lens | | | | | | |
| S5 | | aspheric | 887.0243 | W1 | | | |
| STO | aperture | | infinite | 0.8902 | | | |
| S6 | third lens | aspheric | −10.8535 | −2.9986 | plastic | 1.5350 | 55.7290 |
| S7 | | aspheric | −178.5396 | −0.1567 | | | |
| S8 | fourth | aspheric | 739.5396 | −1.0000 | plastic | 1.6461 | 21.4465 |
| | lens | | | | | | |
| S9 | | aspheric | −11.9757 | −6.8061 | | | |
| S10 | fifth lens | aspheric | −12.0675 | −2.8409 | plastic | 1.5350 | 55.7290 |
| S11 | | aspheric | −35.6194 | −1.5816 | | | |
| S12 | sixth | aspheric | −18.7654 | −2.8409 | plastic | 1.6600 | 20.5610 |
| | lens | | | | | | |
| S13 | | aspheric | 171.1863 | −4.0167 | | | |
| S14 | seventh | aspheric | −55.2352 | −1.1585 | plastic | 1.6029 | 27.2318 |
| | lens | | | | | | |
| S15 | | aspheric | −7.8919 | W2 | | | |
| S16 | optical | | infinite | −0.2100 | glass | 1.5168 | 51.4060 |
| | filter | | | | | | |
| S17 | | | infinite | −4.3680 | | | |
| S18 | image | | infinite | | | | |
| | plane | | | | | | |

In this embodiment, the positive or negative sign of the numerical value of the radius of curvature of each surface indicates only the bending direction of the surface. When a surface of a lens on the optical axis I and a surface of a lens on the optical axis II have the same bending direction, the numerical signs (positive or negative) of the radii of curvature of the surfaces are opposite to each other. Similarly, the positive or negative sign of the numerical value of the thickness/distance of each surface indicates the direction only. The bending direction of each surface and the thickness/distance of each surface may be referred to in FIG. 20 and FIG. 21.

Here, an on-axis distance W1 from the first element group G1 to the second element group G2, and an on-axis distance W2 from the second element group G2 to the optical filter E8 are variables, which may change as the distance between the photographed object and the optical system 700 changes.

When the photographed object is at infinity from the optical system 700, the optical system 700 is in the first state, and a structural diagram of the optical system 700 may be referred to in FIG. 20, where, W1=−9.3856 mm, W2=−0.4627 mm, an effective focal length of the optical system 700 EFL=31.6999 mm, an aperture value of the optical system 700 in a first direction Fnox=1.8982, an aperture value of the optical system 700 in a second direction Fnoy=1.8982, and a maximal field-of-view of the optical system 700 FOV=20.2102°. When the photographed object is at a preset distance from the optical system 700, the optical system 700 is in the second state, and a structural diagram of the optical system 700 may be referred to in FIG. 21.

In this embodiment, the object-side surface and the image-side surface of any lens in the first lens E1 to the seventh lens E7 are both aspheric surfaces. Table 14 gives the conic coefficient K and the high-order coefficients A₄, A₆, A₈, A₁₀, A₁₂, A₁₄, A₁₆, A₁₈ and A₂₀ applicable to the aspheric surfaces S1-S2, S4-S15 in Embodiment 7.

TABLE 14

| surface | | | | | | | | | | |
|---|---|---|---|---|---|---|---|---|---|---|
| number | K | A₄ | A₆ | A₈ | A₁₀ | A₁₂ | A₁₄ | A₁₆ | A₁₈ | A₂₀ |
| S1 | −50.6807 | −6.82E−02 | −2.47E−02 | −3.28E−03 | −6.63E−04 | −1.55E−04 | −9.00E−06 | −1.30E−05 | 0.00E+00 | 0.00E+00 |
| S2 | 73.2486 | −1.13E−01 | −1.74E−02 | −3.21E−03 | −5.35E−04 | −1.28E−04 | −6.00E−06 | −9.00E−06 | 0.00E+00 | 0.00E+00 |
| S4 | 94.7704 | −8.34E−01 | 1.51E−02 | −4.88E−03 | −2.00E−06 | −4.90E−05 | 6.20E−05 | −2.70E−05 | 7.00E−06 | 0.00E+00 |
| S5 | −99.0000 | −7.27E−01 | 1.22E−02 | −4.40E−03 | −7.50E−05 | −4.40E−05 | 6.60E−05 | −2.80E−05 | 1.10E−05 | 0.00E+00 |
| S6 | −1.8666 | 3.15E−01 | 9.33E−02 | −4.54E−03 | 5.10E−05 | 1.70E−03 | 5.75E−04 | −9.20E−05 | −2.40E−05 | 0.00E+00 |
| S7 | −39.7322 | 5.06E−01 | 1.28E−01 | −1.56E−02 | 7.11E−03 | −3.31E−03 | 5.19E−04 | −4.25E−04 | 3.39E−04 | −3.60E−05 |
| S8 | 99.0000 | 2.57E−01 | −8.41E−03 | 5.04E−02 | −7.93E−03 | −2.45E−03 | −6.60E−05 | −2.90E−04 | 1.40E−04 | 2.70E−05 |
| S9 | −8.3872 | 5.17E−02 | −2.13E−02 | 5.83E−02 | −1.66E−02 | −6.20E−05 | 2.12E−04 | 2.89E−04 | −1.18E−04 | 1.60E−05 |
| S10 | 1.8102 | 2.95E−02 | −1.37E−01 | 1.78E−02 | 2.03E−03 | −3.08E−04 | −1.81E−04 | 6.30E−05 | −3.80E−05 | 1.00E−06 |
| S11 | −74.2761 | −3.14E−01 | −1.69E−01 | 3.42E−02 | 1.16E−02 | 3.72E−03 | −2.41E−04 | 2.70E−05 | −7.10E−05 | 0.00E+00 |
| S12 | 4.6116 | 6.20E−01 | 2.77E−02 | 3.39E−02 | 7.87E−03 | 3.83E−03 | 5.78E−04 | 3.40E−04 | 8.20E−05 | 1.30E−05 |
| S13 | 99.0000 | 7.88E−01 | 2.62E−02 | 2.27E−02 | 1.08E−03 | 7.24E−04 | −6.81E−04 | 1.82E−04 | 8.00E−06 | 0.00E+00 |
| S14 | −75.3630 | 1.58E+00 | −3.26E−01 | 6.29E−02 | −1.06E−02 | 2.00E−03 | −5.44E−04 | 2.60E−04 | 0.00E+00 | 0.00E+00 |
| S15 | −15.5846 | 6.44E−01 | −1.75E−01 | 3.98E−02 | −6.67E−03 | 1.34E−03 | −3.68E−04 | 9.20E−05 | 0.00E+00 | 0.00E+00 |

FIG. 22A illustrates a longitudinal aberration curve of the optical system 700 in the first state in Embodiment 7, representing deviations of focal points of light of different wavelengths converged after passing through the optical system 700. FIG. 22B illustrates an astigmatic curve of the optical system 700 in the first state in Embodiment 7, representing a curvature of a tangential image plane and a curvature of a sagittal image plane corresponding to different image heights. FIG. 22C illustrates a distortion curve of the optical system 700 in the first state in Embodiment 7, representing amounts of distortion corresponding to different image heights. It can be seen from FIG. 22A, FIG. 22B and FIG. 22C that the optical system 700 in Embodiment 7 can achieve a good imaging quality in the first state.

### Embodiment 8

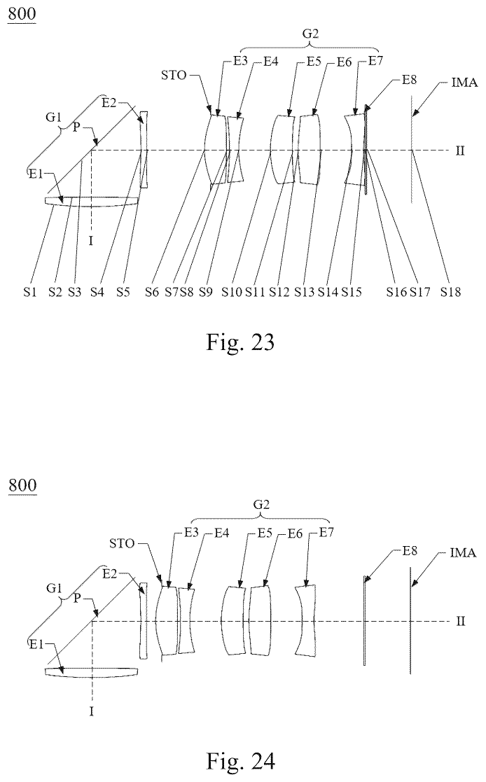

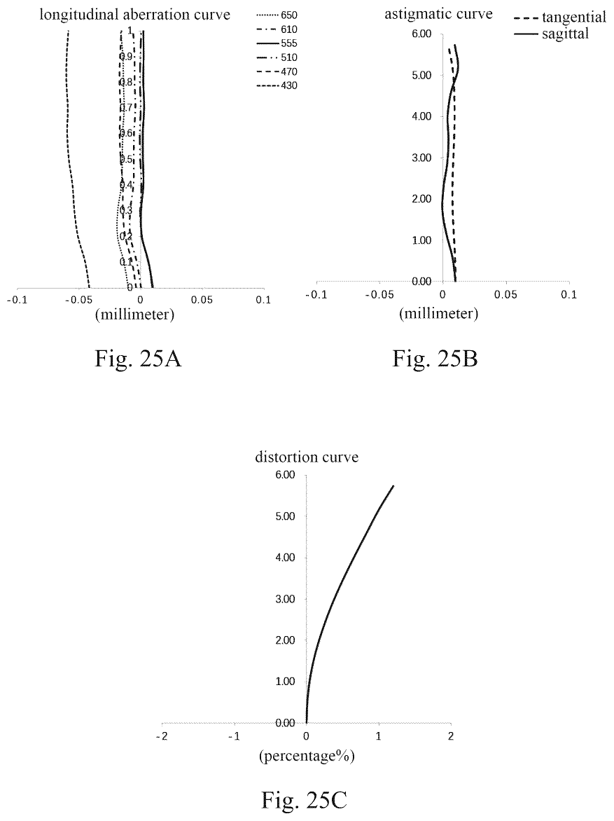

An optical system according to Embodiment 8 is described below with reference to FIG. 23, FIG. 24, FIG. 25A, FIG. 25B, and FIG. 25C.

As shown in FIG. 23 and FIG. 24, the optical system 800 may include a first element group G1 and a second element group G2 arranged sequentially from an object side to an image side. The image side may be provided with, for example, an image plane IMA. The range of imaging object distances of the optical system 800 may be from 18 cm to infinity. A magnification of the optical system 800 may be 5×.

The first element group G1 may include a first lens E1, a reflective element P and a second lens E2. The second element group G2 may include a diaphragm STO, a third lens E3, a fourth lens E4, a fifth lens E5, a sixth lens E6 and a seventh lens E7. In particular, the first lens E1 is located on the optical axis I and is disposed between the object side and the reflective element P. The second lens E2, the diaphragm STO, the third lens E3, the fourth lens E4, the fifth lens E5, the sixth lens E6, and the seventh lens E7 are arranged sequentially along the optical axis II from the reflective element P to the image side. In an example, an optical filter E8 may be provided between the seventh lens E7 and the image plane IMA.

The first element group G1 is fixed in a position relative to the image plane IMA on the optical axis II. The second element group G2 may move along the optical axis II relative to the first element group G1. When the distance between a photographed object and the optical system 800 is decreased, adjusting the distance between the second element group G2 and the first element group G1 on the optical axis II enables the optical system 800 to switch between a first state and a second state to achieve a focusing function of the optical system 800. During the focusing of the optical system 800, a maximal travelling distance of the second element group G2 may be 6.6394 mm.

The first lens E1 may have a positive refractive power, an object-side surface S1 of the first lens E1 is a convex surface, and an image-side surface S2 of the first lens E1 is a convex surface. The reflective element P may have a reflective surface S3, and the reflective surface S3 is a planar surface. The second lens E2 may have a negative refractive power, an object-side surface S4 of the second lens E2 is a concave surface, and an image-side surface S5 of the second lens E2 is a convex surface. The third lens E3 may have a positive refractive power, an object-side surface S6 of the third lens E3 is a convex surface, and an image-side surface S7 of the third lens E3 is a convex surface. The fourth lens E4 may have a negative refractive power, an object-side surface S8 of the fourth lens E4 is a concave surface, and an image-side surface S9 of the fourth lens E4 is a concave surface. The fifth lens E5 may have a positive refractive power, an object-side surface S10 of the fifth lens E5 is a convex surface, and an image-side surface S11 of the fifth lens E5 is a concave surface. The sixth lens E6 may have a positive refractive power, an object-side surface S12 of the sixth lens E6 is a convex surface, and an image-side surface S13 of the sixth lens E6 is a concave surface. The seventh lens E7 may have a negative refractive power, an object-side surface S14 of the seventh lens E7 is a concave surface, and an image-side surface S15 of the seventh lens E7 is a concave surface. The optical filter E8 may have an object-side surface S16 and an image-side surface S17. Light from an object sequentially passes through the surfaces S1-S17 and finally forms an image on an image plane S18.

Table 15 shows a table of basic parameters of the optical system 800 in Embodiment 8. Here, the units of a radius of curvature and a thickness/distance are millimeters (mm).

TABLE 15

| | | | | | | material | |
|---|---|---|---|---|---|---|---|
| surface | | | radius of | thickness/ | | refractive | abbe |
| number | element | surface type | curvature | distance | texture | index | number |
| S1 | first lens | aspheric | 46.5472 | 1.3002 | plastic | 1.5350 | 55.7290 |
| S2 | | aspheric | −598.9614 | 6.5201 | | | |
| S3 | reflective | | infinite | −6.7696 | | | |
| | element | | | | | | |
| S4 | second lens | aspheric | 39.9580 | −0.8205 | plastic | 1.5612 | 38.8756 |
| S5 | | aspheric | 73.1746 | W1 | | | |
| STO | aperture | | infinite | 0.8511 | | | |
| S6 | third lens | aspheric | −10.2574 | −2.0000 | plastic | 1.5350 | 55.7290 |
| S7 | | aspheric | 108.6662 | −0.4178 | | | |
| S8 | fourth lens | aspheric | 59.7708 | −1.2551 | plastic | 1.6210 | 25.3723 |
| S9 | | aspheric | −10.2619 | −4.3415 | | | |
| S10 | fifth lens | aspheric | −11.7281 | −3.0000 | plastic | 1.5350 | 55.7290 |
| S11 | | aspheric | −30.5233 | −0.8001 | | | |
| S12 | sixth lens | aspheric | −16.5236 | −3.0000 | plastic | 1.6349 | 24.0741 |
| S13 | | aspheric | −207.2523 | −4.2925 | | | |
| S14 | seventh lens | aspheric | 490.4357 | −1.6304 | plastic | 1.5538 | 43.4060 |
| S15 | | aspheric | −10.8154 | W2 | | | |
| S16 | optical filter | | infinite | −0.2100 | glass | 1.5168 | 51.4060 |
| S17 | | | infinite | −6.1792 | | | |
| S18 | image plane | | infinite | | | | |

In this embodiment, the positive or negative sign of the numerical value of the radius of curvature of each surface indicates only the bending direction of the surface. When a surface of a lens on the optical axis I and a surface of a lens on the optical axis II have the same bending direction, the numerical signs (positive or negative) of the radii of curvature of the surfaces are opposite to each other. Similarly, the positive or negative sign of the numerical value of the thickness/distance for each surface indicates the direction only. The bending direction of each surface and the thickness/distance of each surface may be referred to in FIG. 23 and FIG. 24.

Here, an on-axis distance W1 from the first element group G1 to the second element group G2, and an on-axis distance W2 from the second element group G2 to the optical filter E8 are variables, which may change as the distance between the photographed object and the optical system 800 changes.

When the photographed object is at infinity from the optical system 800, the optical system 800 is in the first state, and a structural diagram of the optical system 800 may be referred to in FIG. 23, where, W1=−8.7190 mm, W2=−0.2139 mm, an effective focal length of the optical system 800 EFL=31.7401 mm, an aperture value of the optical system 800 in a first direction Fnox=2.6, an aperture value of the optical system 800 in a second direction Fnoy=2.6, and a maximal field-of-view of the optical system 800 FOV=20.2178°. When the photographed object is at a preset distance from the optical system 800, the optical system 800 is in the second state, and a structural diagram of the optical system 800 may be referred to in FIG. 24.

In this embodiment, the object-side surface and the image-side surface of any lens in the first lens E1 to the seventh lens E7 are both aspheric surfaces. Table 16 gives the conic coefficient K and the high-order coefficients A₄, A₆, A₈, A₁₀, A₁₂, A₁₄, A₁₆, A₁₈ and A₂₀ applicable to the aspheric surfaces S1-S2, S4-S15 in Embodiment 8.

TABLE 16

| surface | | | | | | | | | | |
|---|---|---|---|---|---|---|---|---|---|---|
| number | K | A₄ | A₆ | A₈ | A₁₀ | A₁₂ | A₁₄ | A₁₆ | A₁₈ | A₂₀ |
| S1 | −23.8932 | 2.65E−02 | −1.14E−02 | 7.70E−04 | 5.02E−04 | 7.00E−05 | 8.00E−06 | 0.00E+00 | 0.00E+00 | 0.00E+00 |
| S2 | 99.0000 | −4.23E−02 | −6.39E−03 | 4.74E−04 | 3.66E−04 | 3.50E−05 | 0.00E+00 | 0.00E+00 | 0.00E+00 | 0.00E+00 |
| S4 | 7.7574 | −4.09E−01 | 8.66E−03 | −1.03E−03 | 6.17E−04 | 4.15E−04 | 2.52E−04 | 8.80E−05 | 4.20E−05 | 0.00E+00 |
| S5 | 91.4308 | −3.84E−01 | 4.01E−03 | −1.31E−03 | 3.72E−04 | 2.84E−04 | 2.04E−04 | 6.70E−05 | 3.80E−05 | 0.00E+00 |
| S6 | −1.8195 | 1.35E−01 | 5.76E−02 | 2.30E−03 | 2.08E−04 | 1.87E−04 | 4.03E−04 | 1.58E−04 | 6.10E−05 | 0.00E+00 |
| S7 | 3.2307 | 2.07E−01 | 7.07E−02 | −1.00E−02 | 8.36E−04 | −2.03E−03 | 1.55E−04 | −8.86E−04 | −3.51E−04 | −3.00E−04 |
| S8 | 57.4044 | 1.36E−01 | −4.42E−02 | 2.44E−02 | −2.77E−03 | −3.20E−05 | 4.33E−04 | −2.30E−04 | −8.00E−05 | −2.05E−04 |
| S9 | −8.5233 | 3.60E−02 | −6.46E−02 | 2.78E−02 | −3.12E−03 | 3.49E−04 | −3.07E−04 | 1.43E−04 | 5.40E−05 | −7.00E−06 |
| S10 | 2.0916 | 1.18E−01 | −1.04E−01 | 8.97E−04 | 5.41E−04 | 1.64E−04 | −4.58E−04 | 1.40E−04 | 4.60E−05 | 2.50E−05 |
| S11 | −61.9765 | −5.48E−02 | −1.12E−01 | 4.73E−03 | −1.96E−03 | 1.88E−03 | −1.56E−03 | −1.40E−04 | −1.48E−04 | 0.00E+00 |
| S12 | 0.3010 | 3.69E−01 | −6.98E−03 | 2.57E−02 | 1.85E−03 | 2.80E−03 | −7.60E−04 | 3.30E−05 | −7.00E−05 | −7.00E−06 |
| S13 | 35.5880 | 4.55E−01 | 9.28E−03 | 1.63E−02 | −2.51E−03 | −1.91E−04 | −6.82E−04 | 9.50E−05 | −5.00E−06 | 0.00E+00 |
| S14 | −99.0000 | 1.15E+00 | −1.86E−01 | 1.85E−02 | −5.83E−03 | 2.10E−05 | −3.20E−05 | 1.52E−04 | 4.90E−05 | 1.00E−05 |
| S15 | −23.6068 | 6.14E−01 | −1.31E−01 | 1.62E−02 | −5.29E−03 | 2.52E−04 | −1.21E−04 | 5.20E−05 | 2.10E−05 | 9.00E−06 |

FIG. 25A illustrates a longitudinal aberration curve of the optical system 800 in the first state in Embodiment 8, representing deviations of focal points of light of different wavelengths converged after passing through the optical system 800. FIG. 25B illustrates an astigmatic curve of the optical system 800 in the first state in Embodiment 8, representing a curvature of a tangential image plane and a curvature of a sagittal image plane corresponding to different image heights. FIG. 25C illustrates a distortion curve of the optical system 800 in the first state in Embodiment 8, representing amounts of distortion corresponding to different image heights. It can be seen from FIG. 25A, FIG. 25B and FIG. 25C that the optical system 800 in Embodiment 8 can achieve a good imaging quality in the first state.

### Embodiment 9

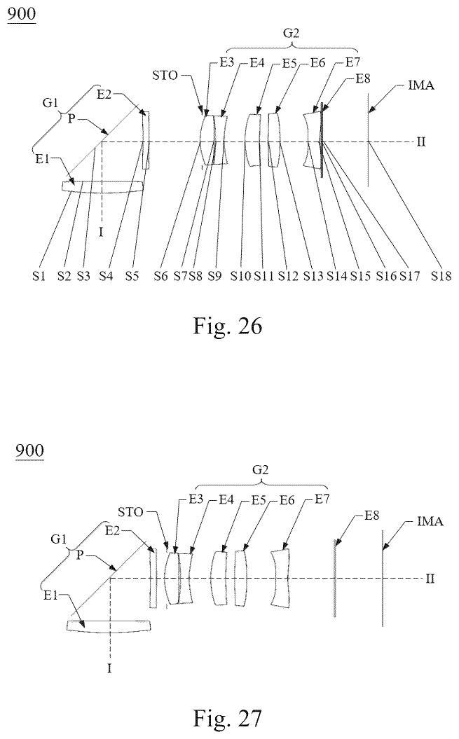

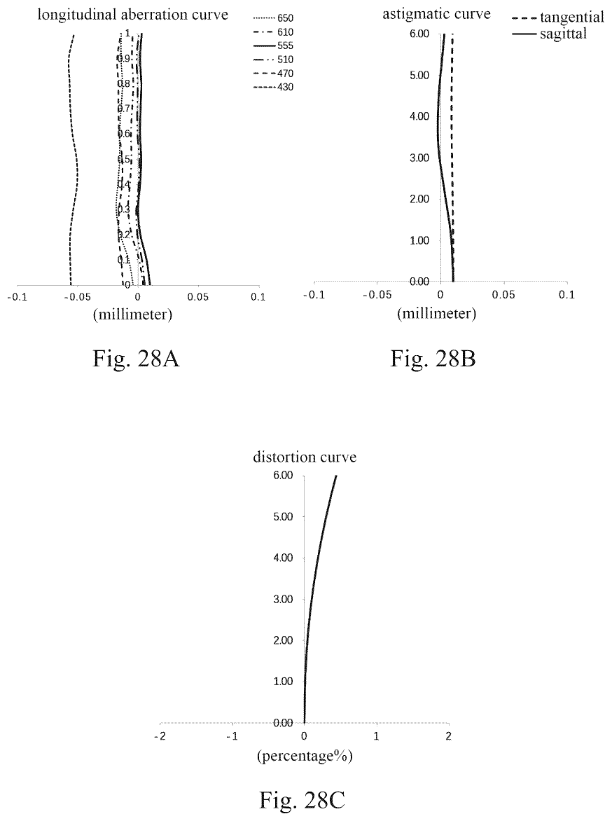

An optical system according to Embodiment 9 is described below with reference to FIG. 26, FIG. 27, FIG. 28A, FIG. 28B, and FIG. 28C.

As shown in FIG. 26 and FIG. 27, the optical system 900 may include a first element group G1 and a second element group G2 arranged sequentially from an object side to an image side. The image side may be provided with, for example, an image plane IMA. The range of imaging object distances of the optical system 900 may be from 18 cm to infinity. A magnification of the optical system 900 may be 5×.

The first element group G1 may include a first lens E1, a reflective element P and a second lens E2. The second element group G2 may include a diaphragm STO, a third lens E3, a fourth lens E4, a fifth lens E5, a sixth lens E6 and a seventh lens E7. In particular, the first lens E1 is located on the optical axis I and is disposed between the object side and the reflective element P. The second lens E2, the diaphragm STO, the third lens E3, the fourth lens E4, the fifth lens E5, the sixth lens E6, and the seventh lens E7 are arranged sequentially along the optical axis II from the reflective element P to the image side. In an example, an optical filter E8 may be provided between the seventh lens E7 and the image plane IMA.

The first element group G1 is fixed in a position relative to the image plane IMA on the optical axis II. The second element group G2 may move along the optical axis II relative to the first element group G1. When the distance between a photographed object and the optical system 900 is decreased, adjusting the distance between the second element group G2 and the first element group G1 on the optical axis II enables the optical system 900 to switch between a first state and a second state to achieve a focusing function of the optical system 900. During the focusing of the optical system 900, a maximal travelling distance of the second element group G2 may be 6.7480 mm.

The first lens E1 may have a positive refractive power, an object-side surface S1 of the first lens E1 is a convex surface, and an image-side surface S2 of the first lens E1 is a convex surface. The reflective element P may have a reflective surface S3, and the reflective surface S3 is a planar surface. The second lens E2 may have a negative refractive power, an object-side surface S4 of the second lens E2 is a concave surface, and an image-side surface S5 of the second lens E2 is a convex surface. The third lens E3 may have a positive refractive power, an object-side surface S6 of the third lens E3 is a convex surface, and an image-side surface S7 of the third lens E3 is a convex surface. The fourth lens E4 may have a negative refractive power, an object-side surface S8 of the fourth lens E4 is a concave surface, and an image-side surface S9 of the fourth lens E4 is a concave surface. The fifth lens E5 may have a positive refractive power, an object-side surface S10 of the fifth lens E5 is a convex surface, and an image-side surface S11 of the fifth lens E5 is a concave surface. The sixth lens E6 may have a positive refractive power, an object-side surface S12 of the sixth lens E6 is a convex surface, and an image-side surface S13 of the sixth lens E6 is a convex surface. The seventh lens E7 may have a negative refractive power, an object-side surface S14 of the seventh lens E7 is a convex surface, and an image-side surface S15 of the seventh lens E7 is a concave surface. The optical filter E8 may have an object-side surface S16 and an image-side surface S17. Light from an object sequentially passes through the surfaces S1-S17 and finally forms an image on an image plane S18.

Table 17 shows a table of basic parameters of the optical system 900 in Embodiment 9. Here, the units of a radius of curvature and a thickness/distance are millimeters (mm).

TABLE 17

| | | | | | | material | |
|---|---|---|---|---|---|---|---|
| surface | | | radius of | thickness/ | | refractive | abbe |
| number | element | surface type | curvature | distance | texture | index | number |
| S1 | first lens | aspheric | 42.8571 | 1.8000 | plastic | 1.5350 | 55.7290 |
| S2 | | aspheric | −1208.0457 | 6.4072 | | | |
| S3 | reflective | | infinite | −6.2842 | | | |
| | element | | | | | | |
| S4 | second lens | aspheric | 44.3147 | −0.9096 | plastic | 1.5875 | 30.4611 |
| S5 | | aspheric | 71.8634 | W1 | | | |
| STO | aperture | | infinite | 0.3003 | | | |
| S6 | third lens | aspheric | −9.1823 | −2.1299 | plastic | 1.5350 | 55.7290 |
| S7 | | aspheric | 216.2940 | −0.2372 | | | |
| S8 | fourth lens | aspheric | 42.6276 | −1.3309 | plastic | 1.6163 | 25.4218 |
| S9 | | aspheric | −9.8530 | −3.2472 | | | |
| S10 | fifth lens | aspheric | −10.8443 | −2.2551 | plastic | 1.5350 | 55.7290 |
| S11 | | aspheric | −35.7269 | −1.3290 | | | |
| S12 | sixth lens | aspheric | −27.8748 | −1.8269 | plastic | 1.6605 | 20.5014 |
| S13 | | aspheric | 63.5086 | −4.3643 | | | |
| S14 | seventh lens | aspheric | −1036.6970 | −1.8212 | plastic | 1.5562 | 42.2841 |
| S15 | | aspheric | −9.9605 | W2 | | | |
| S16 | optical filter | | infinite | −0.2100 | glass | 1.5168 | 51.4060 |
| S17 | | | infinite | −7.0786 | | | |
| S18 | image plane | | infinite | | | | |

In this embodiment, the positive or negative sign of the numerical value of the radius of curvature of each surface indicates only the bending direction of the surface. When a surface of a lens on the optical axis I and a surface of a lens on the optical axis II have the same bending direction, the numerical signs (positive or negative) of the radii of curvature of the surfaces are opposite to each other. Similarly, the positive or negative sign of the numerical value of the thickness/distance for each surface indicates the direction only. The bending direction of each surface and the thickness/distance of each surface may be referred to in FIG. 26 and FIG. 27.

Here, an on-axis distance W1 from the first element group G1 to the second element group G2, and an on-axis distance W2 from the second element group G2 to the optical filter E8 are variables, which may change as the distance between the photographed object and the optical system 900 changes.

When the photographed object is at infinity from the optical system 900, the optical system 900 is in the first state, and a structural diagram of the optical system 900 may be referred to in FIG. 26, where, W1=−8.2483 mm, W2=−0.2217 mm, an effective focal length of the optical system 900 EFL=31.7401 mm, an aperture value of the optical system 900 in a first direction Fnox=3.3063, an aperture value of the optical system 900 in a second direction Fnoy=3.3063, and a maximal field-of-view of the optical system 900 FOV=20.2178°. When the photographed object is at a preset distance from the optical system 900, the optical system 900 is in the second state, and a structural diagram of the optical system 900 may be referred to in FIG. 27.

In this embodiment, the object-side surface and the image-side surface of any lens in the first lens E1 to the seventh lens E7 are both aspheric surfaces. Table 18 gives the conic coefficient K and the high-order coefficients A₄, A₆, As, A₁₀, A₁₂, A₁₄, A₁₆, A₁₈ and A₂₀ applicable to the aspheric surfaces S1-S2, S4-S15 in Embodiment 9.

TABLE 18

| surface | | | | | | | | | | |
|---|---|---|---|---|---|---|---|---|---|---|
| number | K | A₄ | A₆ | A₈ | A₁₀ | A₁₂ | A₁₄ | A₁₆ | A₁₈ | A₂₀ |
| S1 | −25.6163 | 1.91E−02 | −7.23E−03 | 2.61E−03 | 7.86E−04 | 1.21E−04 | 1.40E−05 | 0.00E+00 | 0.00E+00 | 0.00E+00 |
| S2 | 99.0000 | −5.92E−02 | −9.37E−04 | 3.72E−04 | 1.93E−04 | 1.60E−05 | 0.00E+00 | 0.00E+00 | 0.00E+00 | 0.00E+00 |
| S4 | 11.0637 | −4.02E−01 | 1.21E−03 | −1.19E−03 | 5.00E−06 | −1.62E−04 | −2.02E−04 | −8.60E−05 | −1.00E−06 | 0.00E+00 |
| S5 | 92.6755 | −3.81E−01 | −4.18E−03 | −1.73E−03 | 2.88E−04 | 3.54E−04 | 1.88E−04 | 7.60E−05 | 3.60E−05 | 0.00E+00 |
| S6 | −1.7710 | 1.33E−01 | 7.84E−02 | −5.14E−03 | −1.93E−03 | 1.32E−03 | 1.05E−03 | 2.87E−04 | 6.50E−05 | 0.00E+00 |
| S7 | 99.0000 | 2.57E−01 | 6.15E−02 | −1.65E−02 | 1.98E−03 | −3.22E−04 | −3.28E−04 | −2.65E−03 | −1.33E−03 | −6.72E−04 |
| S8 | 55.1178 | 1.37E−01 | −5.94E−02 | 2.73E−02 | −2.18E−03 | 1.56E−03 | 1.45E−03 | −1.37E−03 | −7.77E−04 | −5.85E−04 |
| S9 | −8.3812 | 2.94E−02 | −6.55E−02 | 3.50E−02 | −6.15E−03 | −1.53E−03 | −7.10E−05 | −1.42E−04 | −4.70E−05 | −1.12E−04 |
| S10 | 2.1511 | 1.26E−01 | −1.31E−01 | 5.20E−05 | 4.15E−03 | −4.91E−04 | 7.17E−04 | 1.94E−04 | 1.38E−04 | 5.40E−05 |
| S11 | −39.9196 | −7.50E−02 | −1.20E−01 | −5.57E−03 | 1.75E−03 | 1.00E−04 | 8.05E−04 | −1.67E−04 | −1.08E−04 | 0.00E+00 |
| S12 | −3.6553 | 3.78E−01 | 1.36E−03 | 2.88E−02 | 5.32E−04 | 9.88E−04 | 1.10E−03 | 3.20E−05 | −8.40E−05 | 6.00E−06 |
| S13 | 99.0000 | 4.69E−01 | −4.63E−03 | 2.42E−02 | −6.72E−03 | 2.56E−04 | −1.11E−04 | −5.68E−04 | −2.43E−04 | 0.00E+00 |
| S14 | 99.0000 | 1.28E+00 | −1.59E−01 | 1.78E−02 | −2.97E−03 | 3.65E−03 | 1.47E−03 | 2.78E−04 | 6.00E−05 | 1.80E−05 |
| S15 | −26.6635 | 6.66E−01 | −1.07E−01 | 9.65E−04 | −9.53E−03 | −3.81E−03 | −2.23E−03 | −1.40E−03 | −4.10E−04 | −1.35E−04 |

FIG. 28A illustrates a longitudinal aberration curve of the optical system 900 in the first state in Embodiment 9, representing deviations of focal points of light of different wavelengths converged after passing through the optical system 900. FIG. 28B illustrates an astigmatic curve of the optical system 900 in the first state in Embodiment 9, representing a curvature of a tangential image plane and a curvature of a sagittal image plane corresponding to different image heights. FIG. 28C illustrates a distortion curve of the optical system 900 in the first state in Embodiment 9, representing amounts of distortion corresponding to different image heights. It can be seen from FIG. 28A, FIG. 28B and FIG. 28C that the optical system 900 in Embodiment 9 can achieve a good imaging quality in the first state.

### Embodiment 10

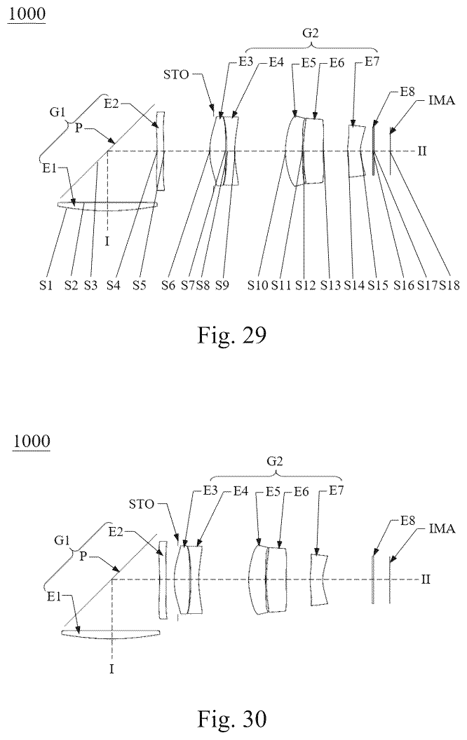

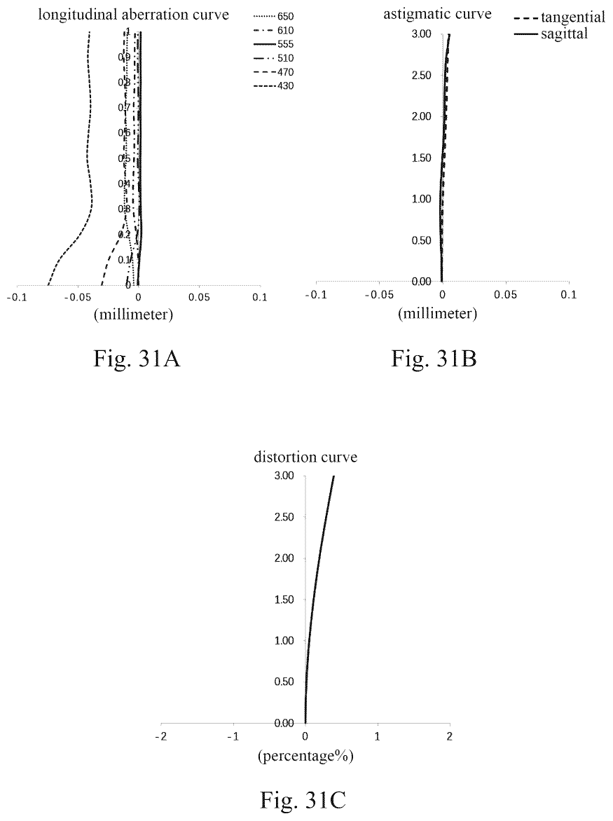

An optical system according to Embodiment 10 is described below with reference to FIG. 29, FIG. 30, FIG. 31A, FIG. 31B, and FIG. 31C.

As shown in FIG. 29 and FIG. 30, the optical system 1000 may include a first element group G1 and a second element group G2 arranged sequentially from an object side to an image side. The image side may be provided with, for example, an image plane IMA. The range of imaging object distances of the optical system 1000 may be from 15.0920 cm to infinity. A magnification of the optical system 1000 may be 8×.

The first element group G1 may include a first lens E1, a reflective element P and a second lens E2. The second element group G2 may include a diaphragm STO, a third lens E3, a fourth lens E4, a fifth lens E5, a sixth lens E6 and a seventh lens E7. In particular, the first lens E1 is located on the optical axis I and is disposed between the object side and the reflective element P. The second lens E2, the diaphragm STO, the third lens E3, the fourth lens E4, the fifth lens E5, the sixth lens E6, and the seventh lens E7 are arranged sequentially along the optical axis II from the reflective element P to the image side. In an example, an optical filter E8 may be provided between the seventh lens E7 and the image plane IMA.

The first element group G1 is fixed in a position relative to the image plane IMA on the optical axis II. The second element group G2 may move along the optical axis II relative to the first element group G1. When a distance between a photographed object and the optical system 1000 is decreased, adjusting a distance between the second element group G2 and the first element group G1 on the optical axis II enables the optical system 1000 to switch between a first state and a second state to achieve a focusing function of the optical system 1000. During the focusing of the optical system 1000, a maximal travelling distance of the second element group G2 may be 5.6995 mm.

The first lens E1 may have a positive refractive power, an object-side surface S1 of the first lens E1 is a convex surface, and an image-side surface S2 of the first lens E1 is a concave surface. The reflective element P may have a reflective surface S3, and the reflective surface S3 is a planar surface. The second lens E2 may have a negative refractive power, an object-side surface S4 of the second lens E2 is a concave surface, and an image-side surface S5 of the second lens E2 is a convex surface. The third lens E3 may have a positive refractive power, an object-side surface S6 of the third lens E3 is a convex surface, and an image-side surface S7 of the third lens E3 is a convex surface. The fourth lens E4 may have a negative refractive power, an object-side surface S8 of the fourth lens E4 is a concave surface, and an image-side surface S9 of the fourth lens E4 is a concave surface. The fifth lens E5 may have a positive refractive power, an object-side surface S10 of the fifth lens E5 is a convex surface, and an image-side surface S11 of the fifth lens E5 is a concave surface. The sixth lens E6 may have a positive refractive power, an object-side surface S12 of the sixth lens E6 is a convex surface, and an image-side surface S13 of the sixth lens E6 is a concave surface. The seventh lens E7 may have a negative refractive power, an object-side surface S14 of the seventh lens E7 is a convex surface, and an image-side surface S15 of the seventh lens E7 is a concave surface. The optical filter E8 may have an object-side surface S16 and an image-side surface S17. Light from an object sequentially passes through the surfaces S1-S17 and finally forms an image on an image plane S18.

Table 19 shows a table of basic parameters of the optical system 1000 in Embodiment 10. Here, the units of a radius of curvature and a thickness/distance are millimeters (mm).

TABLE 19

| | | | | | | material | |
|---|---|---|---|---|---|---|---|
| surface | | | radius of | thickness/ | | refractive | abbe |
| number | element | surface type | curvature | distance | texture | index | number |
| S1 | first lens | aspheric | 38.5599 | 1.2656 | plastic | 1.5350 | 55.7920 |
| S2 | | aspheric | 1878.9006 | 7.7168 | | | |
| S3 | reflective | | infinite | −7.4247 | | | |
| | element | | | | | | |
| S4 | second lens | aspheric | 42.3668 | −1.0000 | plastic | 1.5627 | 38.2219 |
| S5 | | aspheric | 62.4612 | W1 | | | |
| STO | aperture | | infinite | 0.5722 | | | |
| S6 | third lens | aspheric | −10.6066 | −2.3316 | plastic | 1.5350 | 55.7290 |
| S7 | | aspheric | 268.4032 | −0.2137 | | | |
| S8 | fourth lens | aspheric | 76.0532 | −1.1733 | plastic | 1.6373 | 23.7950 |
| S9 | | aspheric | −12.2917 | −7.6045 | | | |
| S10 | fifth lens | aspheric | −10.3206 | −2.5365 | plastic | 1.5431 | 49.5788 |
| S11 | | aspheric | −39.3571 | −0.1412 | | | |
| S12 | sixth lens | aspheric | −23.9985 | −3.0000 | plastic | 1.6700 | 19.4000 |
| S13 | | aspheric | −53.5585 | −3.6354 | | | |
| S14 | seventh lens | aspheric | −8.7198 | −1.9242 | plastic | 1.6079 | 27.8267 |
| S15 | | aspheric | −5.0330 | W2 | | | |
| S16 | optical filter | | infinite | −0.2100 | glass | 1.5168 | 51.4060 |
| S17 | | | infinite | −2.4459 | | | |
| S18 | image plane | | infinite | | | | |

In this embodiment, the positive or negative sign of the numerical value of the radius of curvature of each surface indicates only the bending direction of the surface. When a surface of a lens on the optical axis I and a surface of a lens on the optical axis II have the same bending direction, the numerical signs (positive or negative) of the radii of curvature of the surfaces are opposite to each other. Similarly, the positive or negative sign of the numerical value of the thickness/distance of each surface indicates the direction only. The bending direction of each surface and the thickness/distance of each surface may be referred to in FIG. 29 and FIG. 30.

Here, an on-axis distance W1 from the first element group G1 to the second element group G2, and an on-axis distance W2 from the second element group G2 to the optical filter E8 are variables, which may change as the distance between the photographed object and the optical system 1000 changes.

When the photographed object is at infinity from the optical system 1000, the optical system 1000 is in the first state, and a structural diagram of the optical system 1000 may be referred to in FIG. 29, where, W1=−7.4717 mm, W2=−1.8133 mm, an effective focal length of the optical system 1000 EFL=27.74 mm, an aperture value of the optical system 1000 in a first direction Fnox=1.9, an aperture value of the optical system 1000 in a second direction Fnoy=1.9, and a maximal field-of-view of the optical system 1000 FOV=12.2982°. When the photographed object is at a preset distance from the optical system 1000, the optical system 1000 is in the second state, and a structural diagram of the optical system 1000 may be referred to in FIG. 30.

In this embodiment, the object-side surface and the image-side surface of any lens in the first lens E1 to the seventh lens E7 are both aspheric surfaces. Table 20 gives the conic coefficient K and the high-order coefficients A₄, A₆, As, A₁₀, A₁₂, A₁₄, A₁₆, A₁₈ and A₂₀ applicable to the aspheric surfaces S1-S2, S4-S15 in Embodiment 10.

TABLE 20

| surface | | | | | | | | | | |
|---|---|---|---|---|---|---|---|---|---|---|
| number | K | A₄ | A₆ | A₈ | A₁₀ | A₁₂ | A₁₄ | A₁₆ | A₁₈ | A₂₀ |
| S1 | −10.9376 | 1.02E−02 | −1.60E−02 | −4.50E−03 | −1.01E−03 | −4.06E−04 | −3.80E−05 | −3.40E−05 | 0.00E+00 | 0.00E+00 |
| S2 | 99.0000 | −7.42E−02 | −1.58E−02 | −5.76E−03 | −1.35E−03 | −5.35E−04 | −6.80E−05 | −5.20E−05 | 0.00E+00 | 0.00E+00 |
| S4 | 14.9232 | −5.62E−01 | 4.61E−03 | −4.40E−04 | −1.98E−04 | 1.43E−04 | 2.00E−05 | 6.10E−05 | 9.00E−06 | 0.00E+00 |
| S5 | 20.5830 | −4.87E−01 | 2.54E−03 | −3.18E−04 | −1.71E−04 | 1.47E−04 | 4.00E−05 | 7.00E−05 | 1.30E−05 | 0.00E+00 |
| S6 | −1.7379 | 2.46E−01 | 6.46E−02 | −5.00E−03 | −2.57E−03 | −3.80E−04 | 5.41E−04 | 2.98E−04 | 1.52E−04 | 0.00E+00 |
| S7 | 99.0000 | 3.69E−01 | 9.62E−02 | −9.22E−03 | 4.04E−03 | −3.67E−03 | 5.98E−04 | −2.84E−03 | −2.23E−04 | −5.20E−04 |
| S8 | 98.7994 | 4.18E−01 | −1.25E−02 | 3.09E−02 | 1.02E−03 | −2.93E−03 | −3.56E−04 | −3.08E−03 | −2.40E−04 | −5.50E−04 |
| S9 | −16.9095 | 2.42E−01 | −1.10E−02 | 3.05E−02 | −5.86E−03 | −1.67E−03 | −9.26E−04 | −5.31E−04 | 4.00E−05 | −1.60E−04 |
| S10 | 1.8990 | 5.87E−01 | −1.05E−01 | −9.62E−04 | 9.18E−03 | 2.80E−04 | 1.20E−05 | 4.30E−05 | 5.40E−05 | 1.10E−05 |
| S11 | 38.8318 | −7.43E−03 | −2.01E−01 | −3.34E−02 | 3.04E−03 | −3.49E−03 | 6.23E−04 | −8.28E−04 | 1.68E−04 | 0.00E+00 |
| S12 | 4.6642 | 9.32E−02 | 9.21E−03 | 1.59E−03 | 6.34E−04 | −1.27E−03 | 4.80E−04 | −1.58E−04 | 2.30E−05 | 3.00E−06 |
| S13 | −80.9897 | 3.33E−01 | −8.30E−03 | 2.01E−03 | −5.69E−03 | 1.47E−03 | 2.06E−04 | 7.60E−05 | 1.80E−05 | 1.40E−05 |
| S14 | −9.7939 | 1.01E+00 | −2.22E−01 | 3.20E−02 | 6.29E−03 | −2.41E−03 | −1.98E−03 | −2.94E−04 | 3.97E−04 | 9.80E−05 |
| S15 | −5.2826 | 4.23E−01 | −1.51E−01 | 3.85E−02 | 1.54E−03 | −4.35E−03 | −9.51E−04 | 3.62E−04 | 1.92E−04 | −1.67E−04 |

FIG. 31A illustrates a longitudinal aberration curve of the optical system 1000 in the first state in Embodiment 10, representing deviations of focal points of light of different wavelengths converged after passing through the optical system 1000. FIG. 31B illustrates an astigmatic curve of the optical system 1000 in the first state in Embodiment 10, representing a curvature of a tangential image plane and a curvature of a sagittal image plane corresponding to different image heights. FIG. 31C illustrates a distortion curve of the optical system 1000 in the first state in Embodiment 10, representing amounts of distortion corresponding to different image heights. It can be seen from FIG. 31A, FIG. 31B and FIG. 31C that the optical system 1000 in Embodiment 10 can achieve a good imaging quality in the first state.

### Embodiment 11

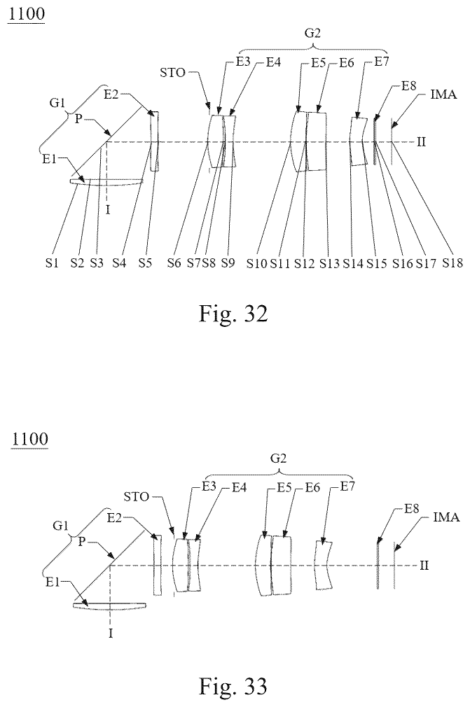

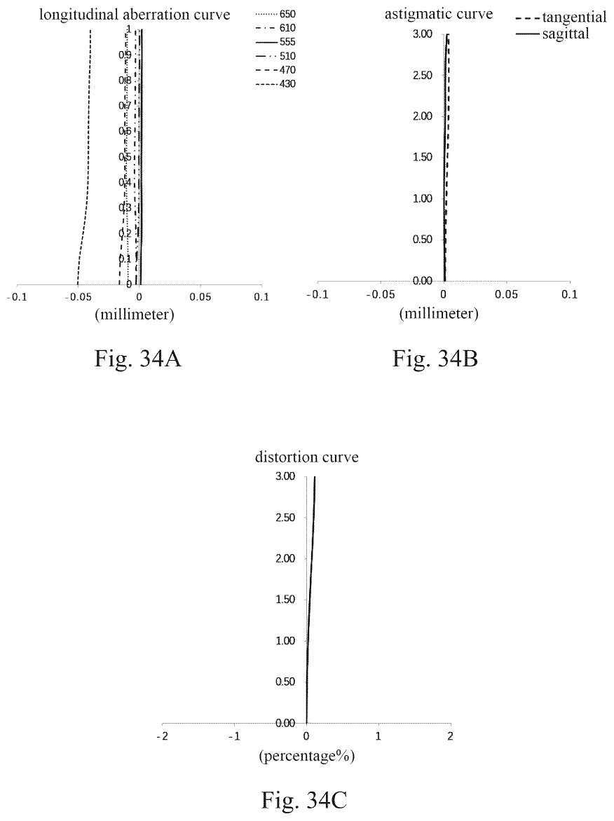

An optical system according to Embodiment 11 is described below with reference to FIG. 32, FIG. 33, FIG. 34A, FIG. 34B, and FIG. 34C.

As shown in FIG. 32 and FIG. 33, the optical system 1100 may include a first element group G1 and a second element group G2 arranged sequentially from an object side to an image side. The image side may be provided with, for example, an image plane IMA. The range of imaging object distances of the optical system 1100 may be from 15.0920 cm to infinity. A magnification of the optical system 1100 may be 8×.

The first element group G1 may include a first lens E1, a reflective element P and a second lens E2. The second element group G2 may include a diaphragm STO, a third lens E3, a fourth lens E4, a fifth lens E5, a sixth lens E6 and a seventh lens E7. In particular, the first lens E1 is located on the optical axis I and is disposed between the object side and the reflective element P. The second lens E2, the diaphragm STO, the third lens E3, the fourth lens E4, the fifth lens E5, the sixth lens E6, and the seventh lens E7 are arranged sequentially along the optical axis II from the reflective element P to the image side. In an example, an optical filter E8 may be provided between the seventh lens E7 and the image plane IMA.

The first element group G1 is fixed in a position relative to the image plane IMA on the optical axis II. The second element group G2 may move along the optical axis II relative to the first element group G1. When the distance between a photographed object and the optical system 1100 is decreased, adjusting the distance between the second element group G2 and the first element group G1 on the optical axis II enables the optical system 1100 to switch between a first state and a second state to achieve a focusing function of the optical system 1100. During the focusing of the optical system 1100, a maximal travelling distance of the second element group G2 may be 5.7738 mm.

The first lens E1 may have a positive refractive power, an object-side surface S1 of the first lens E1 is a convex surface, and an image-side surface S2 of the first lens E1 is a concave surface. The reflective element P may have a reflective surface S3, and the reflective surface S3 is a planar surface. The second lens E2 may have a negative refractive power, an object-side surface S4 of the second lens E2 is a concave surface, and an image-side surface S5 of the second lens E2 is a convex surface. The third lens E3 may have a positive refractive power, an object-side surface S6 of the third lens E3 is a convex surface, and an image-side surface S7 of the third lens E3 is a convex surface. The fourth lens E4 may have a negative refractive power, an object-side surface S8 of the fourth lens E4 is a concave surface, and an image-side surface S9 of the fourth lens E4 is a concave surface. The fifth lens E5 may have a positive refractive power, an object-side surface S10 of the fifth lens E5 is a convex surface, and an image-side surface S11 of the fifth lens E5 is a concave surface. The sixth lens E6 may have a positive refractive power, an object-side surface S12 of the sixth lens E6 is a convex surface, and an image-side surface S13 of the sixth lens E6 is a concave surface. The seventh lens E7 may have a negative refractive power, an object-side surface S14 of the seventh lens E7 is a convex surface, and an image-side surface S15 of the seventh lens E7 is a concave surface. The optical filter E8 may have an object-side surface S16 and an image-side surface S17. Light from an object sequentially passes through the surfaces S1-S17 and finally forms an image on an image plane S18.

Table 21 shows a table of basic parameters of the optical system 1100 in Embodiment 11. Here, the units of a radius of curvature and a thickness/distance are millimeters (mm).

TABLE 21

| | | | | | | material | |
|---|---|---|---|---|---|---|---|
| surface | | | radius of | thickness/ | | refractive | abbe |
| number | element | surface type | curvature | distance | texture | index | number |
| S1 | first lens | aspheric | 36.5604 | 0.9519 | plastic | 1.5355 | 55.3302 |
| S2 | | aspheric | 1589.1615 | 5.7696 | | | |
| S3 | reflective | | infinite | −6.7285 | | | |
| | element | | | | | | |
| S4 | second lens | aspheric | 63.0375 | −1.0692 | plastic | 1.5427 | 49.8105 |
| S5 | | aspheric | 127.6232 | W1 | | | |
| STO | aperture | | infinite | 0.2327 | | | |
| S6 | third lens | aspheric | −11.0590 | −2.3628 | plastic | 1.5350 | 55.7290 |
| S7 | | aspheric | 93.0082 | −0.3056 | | | |
| S8 | fourth lens | aspheric | 61.6079 | −1.1737 | plastic | 1.6242 | 25.3990 |
| S9 | | aspheric | −12.1261 | −8.6981 | | | |
| S10 | fifth lens | aspheric | −10.2602 | −2.3334 | plastic | 1.5350 | 55.7290 |
| S11 | | aspheric | −42.1395 | −0.0644 | | | |
| S12 | sixth lens | aspheric | −42.1395 | −2.9591 | plastic | 1.6700 | 19.4000 |
| S13 | | aspheric | −23.5863 | −3.6105 | | | |
| S14 | seventh lens | aspheric | −8.4021 | −1.8923 | plastic | 1.6137 | 25.4194 |
| S15 | | aspheric | −4.9258 | W2 | | | |
| S16 | optical filter | | infinite | −0.2100 | glass | 1.5168 | 51.4060 |
| S17 | | | infinite | −2.4459 | | | |
| S18 | image plane | | infinite | | | | |

In this embodiment, the positive or negative sign of the numerical value of the radius of curvature of each surface indicates only the bending direction of the surface. When a surface of a lens on the optical axis I and a surface of a lens on the optical axis II have the same bending direction, the numerical signs (positive or negative) of the radii of curvature of the surfaces are opposite to each other. Similarly, the positive or negative sign of the numerical value of the thickness/distance for each surface indicates the direction only. The bending direction of each surface and the thickness/distance of each surface may be referred to in FIG. 32 and FIG. 33.

Here, an on-axis distance W1 from the first element group G1 to the second element group G2, and an on-axis distance W2 from the second element group G2 to the optical filter E8 are variables, which may change as the distance between the photographed object and the optical system 1100 changes.

When the photographed object is at infinity from the optical system 1100, the optical system 1100 is in the first state, and a structural diagram of the optical system 1100 may be referred to in FIG. 32, where, W1=−7.7487 mm, W2=−1.8034 mm, an effective focal length of the optical system 1100 EFL=27.72 mm, an aperture value of the optical system 1100 in a first direction Fnox=2.5979, an aperture value of the optical system 1100 in a second direction Fnoy=2.5979, and a maximal field-of-view of the optical system 1100 FOV=12.2982°. When the photographed object is at a preset distance from the optical system 1100, the optical system 1100 is in the second state, and a structural diagram of the optical system 1100 may be referred to in FIG. 33.

In this embodiment, the object-side surface and the image-side surface of any lens in the first lens E1 to the seventh lens E7 are both aspheric surfaces. Table 22 gives the conic coefficient K and the high-order coefficients A₄, A₆, A₈, A₁₀, A₁₂, A₁₄, A₁₆, A₁₈ and A₂₀ applicable to the aspheric surfaces S1-S2, S4-S15 in Embodiment 11.

TABLE 22

| surface | | | | | | | | | | |
|---|---|---|---|---|---|---|---|---|---|---|
| number | K | A₄ | A₆ | A₈ | A₁₀ | A₁₂ | A₁₄ | A₁₆ | A₁₈ | A₂₀ |
| S1 | −10.7296 | 1.15E−02 | −1.61E−02 | −5.21E−03 | −7.04E−04 | −3.51E−04 | −2.44E−04 | −1.19E−04 | 0.00E+00 | 0.00E+00 |
| S2 | −99.0000 | −7.26E−02 | −1.56E−02 | −7.29E−03 | −1.32E−03 | −7.36E−04 | −4.27E−04 | −1.69E−04 | 0.00E+00 | 0.00E+00 |
| S4 | 26.9508 | −5.55E−01 | 1.86E−03 | 2.37E−04 | −8.00E−05 | 6.60E−05 | 8.90E−05 | 8.50E−05 | 1.40E−05 | 0.00E+00 |
| S5 | 65.1422 | −4.87E−01 | 1.29E−04 | 6.32E−04 | −1.07E−04 | −1.64E−04 | −1.03E−04 | 1.00E−06 | −4.00E−06 | 0.00E+00 |
| S6 | −1.7072 | 2.43E−01 | 6.38E−02 | −1.69E−03 | −4.39E−03 | −1.99E−04 | 1.04E−03 | 6.00E−04 | 1.66E−04 | 0.00E+00 |
| S7 | 97.4157 | 3.72E−01 | 8.94E−02 | 2.04E−03 | −1.65E−03 | −1.21E−03 | 5.30E−05 | −1.63E−03 | −9.32E−04 | −4.90E−04 |
| S8 | 90.0151 | 4.18E−01 | −1.59E−02 | 3.65E−02 | −7.18E−04 | −2.56E−03 | −1.32E−03 | −1.95E−03 | −8.13E−04 | −4.51E−04 |
| S9 | −16.5626 | 2.35E−01 | −7.41E−03 | 2.75E−02 | −4.67E−03 | −2.13E−03 | −4.57E−04 | −6.69E−04 | −3.76E−04 | −2.33E−04 |
| S10 | 1.8035 | 6.00E−01 | −1.02E−01 | −5.28E−03 | 1.04E−02 | 2.83E−04 | 2.68E−04 | 2.33E−04 | 7.00E−05 | 5.00E−06 |
| S11 | 29.2531 | 6.01E−03 | −2.01E−01 | −3.44E−02 | 2.59E−03 | −2.10E−03 | 2.30E−04 | −5.07E−04 | −8.10E−05 | 0.00E+00 |
| S12 | 2.6108 | 1.02E−01 | 5.86E−03 | 3.53E−03 | −1.08E−03 | −3.85E−04 | 1.59E−04 | 9.00E−06 | −3.00E−06 | −1.00E−06 |
| S13 | −73.8325 | 3.30E−01 | −5.66E−03 | 2.73E−03 | −6.73E−03 | 1.41E−03 | −5.32E−04 | −1.75E−04 | −7.30E−05 | −3.53E−07 |
| S14 | −7.5671 | 8.26E−01 | −2.03E−01 | 3.98E−02 | 4.20E−03 | −2.19E−03 | −2.54E−03 | −5.95E−04 | 3.80E−05 | −2.00E−05 |
| S15 | −4.7427 | 1.73E−01 | −9.57E−02 | 4.21E−02 | −1.59E−03 | −5.06E−03 | 4.06E−04 | 2.13E−03 | 8.47E−04 | 1.30E−05 |

FIG. 34A illustrates a longitudinal aberration curve of the optical system 1100 in the first state in Embodiment 11, representing deviations of focal points of light of different wavelengths converged after passing through the optical system 1100. FIG. 34B illustrates an astigmatic curve of the optical system 1100 in the first state in Embodiment 11, representing a curvature of a tangential image plane and a curvature of a sagittal image plane corresponding to different image heights. FIG. 34C illustrates a distortion curve of the optical system 1100 in the first state in Embodiment 11, representing amounts of distortion corresponding to different image heights. It can be seen from FIG. 34A, FIG. 34B and FIG. 34C that the optical system 1100 in Embodiment 11 can achieve a good imaging quality in the first state.

### Embodiment 12

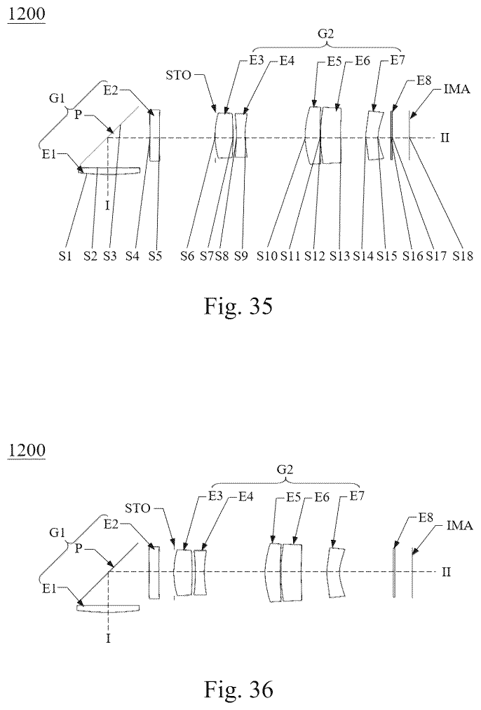

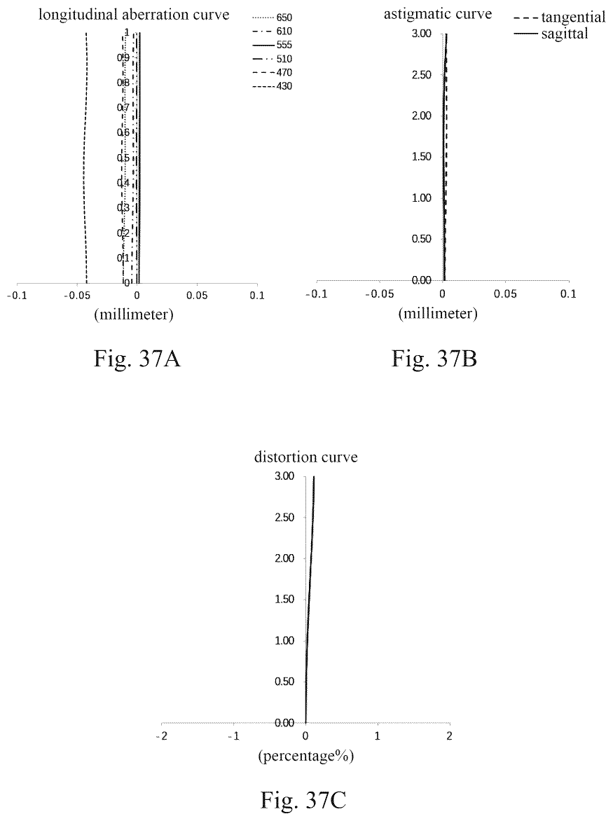

An optical system according to Embodiment 12 is described below with reference to FIG. 35, FIG. 36, FIG. 37A, FIG. 37B, and FIG. 37C.

As shown in FIG. 35 and FIG. 36, the optical system 1200 may include a first element group G1 and a second element group G2 arranged sequentially from an object side to an image side. The image side may be provided with, for example, an image plane IMA. The range of imaging object distances of the optical system 1200 may be from 15.0920 cm to infinity. A magnification of the optical system 1200 may be 8×.

The first element group G1 may include a first lens E1, a reflective element P and a second lens E2. The second element group G2 may include a diaphragm STO, a third lens E3, a fourth lens E4, a fifth lens E5, a sixth lens E6 and a seventh lens E7. In particular, the first lens E1 is located on the optical axis I and is disposed between the object side and the reflective element P. The second lens E2, the diaphragm STO, the third lens E3, the fourth lens E4, the fifth lens E5, the sixth lens E6, and the seventh lens E7 are arranged sequentially along the optical axis II from the reflective element P to the image side. In an example, an optical filter E8 may be provided between the seventh lens E7 and the image plane IMA.

The first element group G1 is fixed in a position relative to the image plane IMA on the optical axis II. The second element group G2 may move along the optical axis II relative to the first element group G1. When the distance between a photographed object and the optical system 1200 is decreased, adjusting the distance between the second element group G2 and the first element group G1 on the optical axis II enables the optical system 1200 to switch between a first state and a second state to achieve a focusing function of the optical system 1200. During the focusing of the optical system 1200, a maximal travelling distance of the second element group G2 may be 5.8577 mm.

The first lens E1 may have a positive refractive power, an object-side surface S1 of the first lens E1 is a convex surface, and an image-side surface S2 of the first lens E1 is a convex surface. The reflective element P may have a reflective surface S3, and the reflective surface S3 is a planar surface. The second lens E2 may have a negative refractive power, an object-side surface S4 of the second lens E2 is a concave surface, and an image-side surface S5 of the second lens E2 is a concave surface. The third lens E3 may have a positive refractive power, an object-side surface S6 of the third lens E3 is a convex surface, and an image-side surface S7 of the third lens E3 is a convex surface. The fourth lens E4 may have a negative refractive power, an object-side surface S8 of the fourth lens E4 is a concave surface, and an image-side surface S9 of the fourth lens E4 is a concave surface. The fifth lens E5 may have a positive refractive power, an object-side surface S10 of the fifth lens E5 is a convex surface, and an image-side surface S11 of the fifth lens E5 is a concave surface. The sixth lens E6 may have a positive refractive power, an object-side surface S12 of the sixth lens E6 is a convex surface, and an image-side surface S13 of the sixth lens E6 is a concave surface. The seventh lens E7 may have a negative refractive power, an object-side surface S14 of the seventh lens E7 is a convex surface, and an image-side surface S15 of the seventh lens E7 is a concave surface. The optical filter E8 may have an object-side surface S16 and an image-side surface S17. Light from an object sequentially passes through the surfaces S1-S17 and finally forms an image on an image plane S18.

Table 23 shows a table of basic parameters of the optical system 1200 in Embodiment 12. Here, the units of a radius of curvature and a thickness/distance are millimeters (mm).

TABLE 23

| | | | | | | material | |
|---|---|---|---|---|---|---|---|
| surface | | | radius of | thickness/ | | refractive | abbe |
| number | element | surface type | curvature | distance | texture | index | number |
| S1 | first lens | aspheric | 37.5978 | 0.9826 | plastic | 1.5350 | 55.7290 |
| S2 | | aspheric | −2634.3316 | 4.6418 | | | |
| S3 | reflective | | infinite | −5.8116 | | | |
| | element | | | | | | |
| S4 | second lens | aspheric | 125.2372 | −1.3682 | plastic | 1.5361 | 54.6572 |
| S5 | | aspheric | −4938.4942 | W1 | | | |
| STO | aperture | | infinite | 0.0485 | | | |
| S6 | third lens | aspheric | −10.9307 | −2.5797 | plastic | 1.5350 | 55.7290 |
| S7 | | aspheric | 54.3265 | −0.4688 | | | |
| S8 | fourth lens | aspheric | 42.4402 | −1.2533 | plastic | 1.6169 | 26.4088 |
| S9 | | aspheric | −11.8317 | −8.5988 | | | |
| S10 | fifth lens | aspheric | −10.0312 | −2.1138 | plastic | 1.5350 | 55.7290 |
| S11 | | aspheric | −33.0009 | −0.1177 | | | |
| S12 | sixth lens | aspheric | −20.9626 | −2.8548 | plastic | 1.6700 | 19.4000 |
| S13 | | aspheric | −30.3451 | −3.6330 | | | |
| S14 | seventh lens | aspheric | −7.3093 | −1.7801 | plastic | 1.6114 | 25.7777 |
| S15 | | aspheric | −4.6925 | W2 | | | |
| S16 | optical filter | | infinite | −0.2100 | glass | 1.5168 | 51.4060 |
| S17 | | | infinite | −2.4459 | | | |
| S18 | image plane | | infinite | | | | |

In this embodiment, the positive or negative sign of the numerical value of the radius of curvature of each surface indicates only a direction of curvature of the surface. When a surface of a lens on the optical axis I and a surface of a lens on the optical axis II have the same bending direction, the numerical signs (positive or negative) of the radii of curvature of the surfaces are opposite to each other. Similarly, the positive or negative sign of the numerical value of the thickness/distance for each surface indicates the direction only. The bending direction of each surface and the thickness/distance of each surface may be referred to in FIG. 35 and FIG. 36.

Here, an on-axis distance W1 from the first element group G1 to the second element group G2, and an on-axis distance W2 from the second element group G2 to the optical filter E8 are variables, which may change as the distance between the photographed object and the optical system 1200 changes.

When the photographed object is at infinity from the optical system 1200, the optical system 1200 is in the first state, and a structural diagram of the optical system 1200 may be referred to in FIG. 35, where, W1=−8.0062 mm, W2=−1.7798 mm, an effective focal length of the optical system 1200 EFL=27.72 mm, an aperture value of the optical system 1200 in a first direction Fnox=3.3, an aperture value of the optical system 1200 in a second direction Fnoy=3.3, and a maximal field-of-view of the optical system 1200 FOV=12.2982°. When the photographed object is at a preset distance from the optical system 1200, the optical system 1200 is in the second state, and a structural diagram of the optical system 1200 may be referred to in FIG. 36.

In this embodiment, the object-side surface and the image-side surface of any lens in the first lens E1 to the seventh lens E7 are both aspheric surfaces. Table 24 gives the conic coefficient K and the high-order coefficients A₄, A₆, A₈, A₁₀, A₁₂, A₁₄, A₁₆, A₁₈ and A₂₀ applicable to the aspheric surfaces S1-S2, S4-S15 in Embodiment 12.

TABLE 24

| surface | | | | | | | | | | |
|---|---|---|---|---|---|---|---|---|---|---|
| number | K | A₄ | A₆ | A₈ | A₁₀ | A₁₂ | A₁₄ | A₁₆ | A₁₈ | A₂₀ |
| S1 | −10.5349 | 8.80E−03 | −1.34E−02 | −7.17E−03 | −1.28E−03 | 2.51E−04 | 4.50E−05 | −1.00E−06 | 0.00E+00 | 0.00E+00 |
| S2 | −99.0000 | −6.14E−02 | −1.68E−02 | −8.55E−03 | 5.13E−04 | −8.01E−04 | −1.13E−03 | −2.22E−04 | 0.00E+00 | 0.00E+00 |
| S4 | 95.0582 | −5.27E−01 | −3.91E−03 | 7.45E−04 | 8.26E−04 | 1.17E−04 | −6.90E−05 | −8.70E−05 | −1.20E−05 | 0.00E+00 |
| S5 | −99.0000 | −4.63E−01 | −5.08E−03 | 1.45E−03 | 7.30E−04 | −3.06E−04 | −3.71E−04 | −1.76E−04 | −2.20E−05 | 0.00E+00 |
| S6 | −1.4691 | 2.20E−01 | 6.99E−02 | −3.12E−03 | −6.08E−03 | 1.16E−03 | 9.81E−04 | 4.23E−04 | 1.00E−04 | 0.00E+00 |
| S7 | 52.6154 | 3.56E−01 | 9.18E−02 | 3.23E−03 | −5.70E−03 | 2.41E−03 | −1.45E−03 | −1.61E−03 | −9.49E−04 | 4.40E−05 |
| S8 | 72.9475 | 4.00E−01 | −1.29E−02 | 3.72E−02 | −3.34E−03 | −8.58E−04 | −1.97E−03 | −1.56E−03 | −8.46E−04 | 1.37E−04 |
| S9 | −16.3800 | 2.35E−01 | −5.14E−03 | 2.48E−02 | −2.25E−03 | −2.66E−03 | −1.02E−03 | −6.76E−04 | 3.12E−04 | 3.82E−04 |
| S10 | 1.5936 | 6.21E−01 | −1.01E−01 | −1.02E−02 | 1.51E−02 | −2.64E−03 | −1.10E−04 | 1.32E−03 | 4.75E−04 | 4.10E−05 |
| S11 | 15.3188 | 2.82E−02 | −2.01E−01 | −4.30E−02 | 8.56E−03 | −4.40E−03 | 1.15E−04 | 1.73E−04 | 2.54E−04 | 0.00E+00 |
| S12 | 1.7084 | 1.06E−01 | 1.53E−03 | 6.87E−03 | −1.51E−03 | −1.82E−04 | 6.19E−04 | 1.70E−04 | 9.70E−05 | 1.50E−05 |
| S13 | −70.6913 | 3.21E−01 | −6.07E−03 | 8.76E−03 | −1.03E−02 | 3.14E−03 | −1.12E−03 | −9.73E−04 | −2.18E−04 | 1.40E−05 |
| S14 | −7.2776 | 7.87E−01 | −2.11E−01 | 3.89E−02 | 6.58E−03 | −1.05E−03 | −3.78E−03 | −1.08E−03 | 4.20E−04 | 1.11E−04 |
| S15 | −4.5980 | 2.22E−01 | −9.60E−02 | 4.22E−02 | −1.31E−03 | −6.09E−03 | −7.49E−04 | 2.84E−03 | 1.79E−03 | 2.59E−04 |

FIG. 37A illustrates a longitudinal aberration curve of the optical system 1200 in the first state in Embodiment 12, representing deviations of focal points of light of different wavelengths converged after passing through the optical system 1200. FIG. 37B illustrates an astigmatic curve of the optical system 1200 in the first state in Embodiment 12, representing a curvature of a tangential image plane and a curvature of a sagittal image plane corresponding to different image heights. FIG. 37C illustrates a distortion curve of the optical system 1200 in the first state in Embodiment 12, representing amounts of distortion corresponding to different image heights. It can be seen from FIG. 37A, FIG. 37B and FIG. 37C that the optical system 1200 in Embodiment 12 can achieve a good imaging quality in the first state.

Tables 25-1 and 25-2 show values of the parameters f1, f2, f3, f4, f5, f6, f7, SL, SH, GH, or the like for each of the embodiments in Embodiments 1-12, respectively. Here, SL, SH, GH may be obtained by measuring according to the labelling method shown in FIG. 1.

TABLE 25-1

| | embodiment | | | | | |
|---|---|---|---|---|---|---|
| parameter | 1 | 2 | 3 | 4 | 5 | 6 |
| f1 (mm) | 77.1221 | 76.8496 | 87.0197 | 65.8451 | 64.9589 | 64.3869 |
| f2 (mm) | −225.9280 | −137.8570 | −207.8570 | −175.2440 | −176.2880 | −180.9590 |
| f3 (mm) | 23.6632 | 18.0527 | 17.9914 | 19.5241 | 18.8466 | 18.4349 |
| f4 (mm) | −21.5733 | −14.4183 | −14.3305 | −17.0109 | −16.5870 | −16.2132 |
| f5 (mm) | 22.1484 | 35.3269 | 30.4953 | 24.5946 | 25.2552 | 24.9874 |
| f6 (mm) | 4116.2700 | 27.9308 | 32.6474 | 80.1344 | 75.8460 | 84.0590 |
| f7 (mm) | −26.1597 | −19.4464 | −18.0793 | −25.5576 | −22.3752 | −21.8049 |
| SL (mm) | 53.5611 | 49.0801 | 48.4290 | 48.5172 | 46.9704 | 45.9676 |
| SH (mm) | 13.8935 | 10.7302 | 8.7403 | 12.2000 | 9.3943 | 7.7953 |
| GH (mm) | 9.0929 | 7.4316 | 6.1008 | 7.8600 | 6.1284 | 4.9602 |
| D1 (mm) | 9.2000 | 6.9508 | 5.4000 | 8.1500 | 6.2100 | 5.0000 |
| FG1 (mm) | 106.3360 | 146.6390 | 138.5530 | 93.9952 | 94.0086 | 92.2894 |
| FG2 (mm) | 37.7409 | 36.4879 | 39.7568 | 31.4506 | 34.4920 | 36.2548 |
| D2x (mm) | 18.4000 | 13.5339 | 10.6554 | 16.0958 | 11.8200 | 9.3200 |
| D2y (mm) | 12.9000 | 9.4745 | 7.4500 | 11.2845 | 8.2700 | 6.5200 |
| fs1 (mm) | 107.4510 | 174.2620 | 136.6390 | 97.9627 | 98.6918 | 97.8178 |
| fs2 (mm) | −737.3080 | 236.8130 | 4056.1300 | −1966.6900 | −5590.8900 | −5516.4300 |

TABLE 25-2

| | embodiment | | | | | |
|---|---|---|---|---|---|---|
| parameter | 7 | 8 | 9 | 10 | 11 | 12 |
| f1 (mm) | 77.8657 | 80.5233 | 77.1483 | 73.3269 | 69.6413 | 69.0700 |
| f2 (mm) | −176.7620 | −157.5340 | −198.0440 | −237.1811 | −230.0270 | −227.0380 |
| f3 (mm) | 21.3987 | 17.6170 | 16.4647 | 18.4349 | 18.5613 | 17.1907 |
| f4 (mm) | −18.0783 | −13.9073 | −12.7714 | −16.2132 | −16.0201 | −14.7649 |
| f5 (mm) | 32.6274 | 33.6107 | 28.1184 | 24.9874 | 24.6375 | 26.0142 |
| f6 (mm) | 25.5556 | 27.9011 | 29.3130 | 84.0590 | 73.4117 | 89.3049 |
| f7 (mm) | −15.3134 | −19.0059 | −18.0174 | −21.8049 | −24.3189 | −28.7373 |
| SL (mm) | 56.2537 | 51.6190 | 49.4010 | 51.3362 | 49.8946 | 48.5976 |
| SH (mm) | 17.0000 | 13.0006 | 12.8826 | 14.8989 | 11.2745 | 9.3763 |
| GH (mm) | 11.2481 | 9.1843 | 7.0970 | 10.0004 | 7.5936 | 6.1762 |
| D1 (mm) | 8.6061 | 6.4857 | 6.2815 | 7.4500 | 5.5000 | 4.4000 |
| FG1 (mm) | 118.1690 | 140.2460 | 114.2010 | 97.4520 | 92.6844 | 92.7496 |
| FG2 (mm) | 34.7450 | 35.8844 | 39.0957 | 30.4538 | 31.4675 | 32.3824 |
| D2x (mm) | 16.7000 | 12.1923 | 9.6000 | 14.6000 | 10.6700 | 8.4000 |
| D2y (mm) | 16.7000 | 12.1923 | 9.6000 | 14.6000 | 10.6700 | 8.4000 |
| fs1 (mm) | 178.3440 | 133.2670 | 122.7020 | 110.3990 | 104.6140 | 107.6450 |
| fs2 (mm) | 234.6060 | 1115.9000 | 2250.6600 | −3500.5000 | −2958.0700 | 4907.9100 |

Tables 26-1 and 26-2 show values of the conditional expressions for each embodiment in Embodiments 1-12, respectively. It should be noted that the values of the conditional expressions involving FOV, EFL, EPDx, and EPDy in Tables 26-1 and 26-2 are all obtained by calculating the FOV, EFL, EPDx, and EPDy of the optical system in the first state.

TABLE 26-1

| conditional | embodiment | | | | | |
|---|---|---|---|---|---|---|
| expression | 1 | 2 | 3 | 4 | 5 | 6 |
| Tan(FOV/2) | 0.1784 | 0.1783 | 0.1783 | 0.1077 | 0.1077 | 0.1077 |
| D1/CT1 | 5.5569 | 5.8204 | 5.7896 | 5.4842 | 5.6811 | 4.5675 |
| f1/f2 | −0.3414 | −0.5575 | −0.4187 | −0.3757 | −0.3685 | −0.3558 |
| FG1/EFL | 3.3545 | 4.6258 | 4.3652 | 3.3884 | 3.3889 | 3.3270 |
| FG1/FG2 | 2.8175 | 4.0189 | 3.4850 | 2.9887 | 2.7255 | 2.5456 |
| EFL/(FG1/FG2) | 11.2509 | 7.8878 | 9.1076 | 9.2817 | 10.1779 | 10.8973 |
| D2x/EPDx/d12 | 0.0557 | 0.0771 | 0.0992 | 0.0623 | 0.0833 | 0.1009 |
| D2y/EPDy/d12 | 0.0556 | 0.0766 | 0.0989 | 0.0621 | 0.0828 | 0.1005 |
| fs1/fs2 | −0.1457 | 0.7359 | 0.0337 | −0.0498 | −0.0177 | −0.0177 |
| EFL/SL | 0.5918 | 0.6459 | 0.6554 | 0.5718 | 0.5906 | 0.6035 |
| OBJmin | 18.0000 | 18.0000 | 18.0000 | 15.4576 | 16.0957 | 16.4123 |
| f1/FG2 | 2.043462 | 2.106167 | 2.1888 | 2.093604 | 1.883303 | 1.775855 |

TABLE 26-2

| conditional | embodiment | | | | | |
|---|---|---|---|---|---|---|
| expression | 7 | 8 | 9 | 10 | 11 | 12 |
| Tan(FOV/2) | 0.1782 | 0.1783 | 0.1783 | 0.1077 | 0.1077 | 0.1077 |
| D1/CT1 | 5.6165 | 4.9883 | 3.4897 | 5.8866 | 5.7781 | 4.4780 |
| f1/f2 | −0.4405 | −0.5111 | −0.3896 | −0.3092 | −0.3028 | −0.3042 |
| FG1/EFL | 3.7277 | 4.4186 | 3.5980 | 3.5131 | 3.3436 | 3.3459 |
| FG1/FG2 | 3.4010 | 3.9083 | 2.9211 | 3.2000 | 2.9454 | 2.8642 |
| EFL/(FG1/FG2) | 9.3207 | 8.1212 | 10.8659 | 8.6688 | 9.4113 | 9.6781 |
| D2x/EPDx/d12 | 0.0460 | 0.0625 | 0.0650 | 0.0522 | 0.0654 | 0.0808 |
| D2y/EPDy/d12 | 0.0460 | 0.0625 | 0.0650 | 0.0522 | 0.0654 | 0.0808 |
| fs1/fs2 | 0.7602 | 0.1194 | 0.0545 | −0.0315 | −0.0354 | 0.0219 |
| EFL/SL | 0.5635 | 0.6149 | 0.6425 | 0.5404 | 0.5556 | 0.5704 |
| OBJmin | 18.0000 | 18.0000 | 18.0000 | 15.0920 | 15.0920 | 15.0920 |
| f1/FG2 | 2.241062 | 2.243964 | 1.973319 | 2.407808 | 2.213118 | 2.132949 |

The present disclosure also provides a camera module, the camera module may be, for example, a periscope camera module. The camera module may include the optical system as described above and an imaging element for converting an optical image formed by the optical system into an electrical signal.

The foregoing is only a description for the preferred embodiments of the present disclosure and the applied technical principles. It should be appreciated by those skilled in the art that the scope of protection of the present disclosure is not limited to the technical solution formed by the particular combination of the above technical features. The scope should also cover other technical solutions formed by any combination of the above technical features or equivalent features thereof without departing from the concept of the present disclosure, for example, technical solutions formed by replacing the features disclosed in the present disclosure with (but not limited to) technical features with similar functions.

What is claimed is:

1. An optical system, along an optical axis from an object side to an image side sequentially comprising:
a first element group, the first element group comprising,
a first lens, having a positive refractive power, the first lens being configured to converge incident light propagating along a first optical axis,
a reflective element, configured to redirect the light emitting from the first lens from propagating along the first optical axis to propagating along a second optical axis, the light remaining in a converged state after being reflected by the reflective element; and
a second element group, the second element group having a positive refractive power, the second element group comprising at least one lens arranged sequentially from the object side to the image side along the second optical axis;
wherein the optical system satisfies: 1.7<f1/FG2<2.5, wherein f1 is an effective focal length of the first lens, and FG2 is an effective focal length of the second element group.

2. The optical system according to claim 1, wherein there is a spacing distance along the first optical axis between the first lens and the reflective element.

3. The optical system according to claim 1, wherein the first element group further comprises a second lens having a negative refractive power, the second lens is located on the second optical axis and disposed between the reflective element and the second element group, and the second lens is configured to diverge the light propagating along the second optical axis.

4. The optical system according to claim 3, wherein there is a spacing distance along the second optical axis between the second lens and the reflective element.

5. The optical system according to claim 1, wherein the optical system further satisfies:
$$Tan ( FOV / 2 ) < 0.38 ,$$
wherein FOV is a maximal field-of-view of the optical system.

6. The optical system according to claim 1, wherein the optical system further satisfies:
$$3. < D 1 / CT 1 < 6. ,$$
wherein D1 is a maximal effective half diameter of the first lens, and CT1 is a center thickness of the first lens on the optical axis.

7. The optical system according to claim 3, wherein the optical system further satisfies:
$$3. < FG 1 / EFL < 5. ,$$
wherein FG1 is an effective focal length of the first element group, and EFL is an effective focal length of the optical system.

8. The optical system according to claim 3, wherein the optical system further satisfies:
$$2.5 < FG 1 / FG 2 < 4.5 ,$$
wherein FG1 is an effective focal length of the first element group.

9. The optical system according to claim 3, wherein the optical system further satisfies:
$$7.5 mm < EFL / ( FG 1 / FG 2 ) < 11.5 mm ,$$
wherein FG1 is an effective focal length of the first element group, and EFL is an effective focal length of the optical system.

10. The optical system according to claim 3, wherein the optical system further satisfies:
$$0.04 {mm}^{- 1} < D 2 x / EPDx / d 12 < 0.12 {mm}^{- 1} ,$$
wherein D2x is a maximal effective half diameter of the second lens in a first direction, EPDx is an entrance pupil diameter of the optical system in the first direction, and d12 is an on-axis distance from an image-side surface of the first lens to an object-side surface of the second lens.

11. The optical system according to claim 3, wherein the optical system further satisfies:
$$0.04 {mm}^{- 1} < D 2 y / EPDy / d 12 < 0.12 {mm}^{- 1} ,$$
wherein D2y is a maximal effective half diameter of the second lens in a second direction, EPDy is an entrance pupil diameter of the optical system in the second direction, and d12 is an on-axis distance from an image-side surface of the first lens to an object-side surface of the second lens.

12. The optical system according to claim 3, wherein the optical system further satisfies:
$$- 0.15 < fs 1 / fs 2 < 0.8 ,$$
wherein fs1 is an effective focal length of an object-side surface of the first lens, and fs2 is an effective focal length of an image-side surface of the first lens.

13. The optical system according to claim 3, wherein the optical system further satisfies:
$$0.5 < EFL / SL < 0.7 ,$$
wherein EFL is an effective focal length of the optical system, and SL is a total length of the optical system along a direction of a preset principle optical axis.

14. The optical system according to claim 3, wherein the optical system further satisfies:
OBJmin≥15.0 cm,
wherein OBJmin is a minimal value of an object distance of the optical system.

15. The optical system according to claim 3, wherein the first element group is fixed in a position relative to an image plane disposed on the image side, and a distance between the second element group and the first element group on the optical axis is adjustable, enabling the optical system to switch between a first state and a second state.

16. The optical system according to claim 3, wherein the second element group comprises a third lens having a positive refractive power, a fourth lens having a negative refractive power, a fifth lens having a positive refractive power, a sixth lens having a positive refractive power, and a seventh lens having a negative refractive power.

17. The optical system according to claim 3, wherein the optical system further comprises a lens barrel assembly, the lens barrel assembly comprises a first lens barrel and a second lens barrel, the first element group is fixed within the first lens barrel, and the second element group is fixed within the second lens barrel; during focusing of the optical system, the first lens barrel and the first element group are fixed in a position on the second optical axis relative to an image plane, and the second lens barrel and the second element group move along the second optical axis towards a direction close to or away from the first element group.

18. The optical system according to claim 1, wherein the optical axis comprises the first optical axis and the second optical axis, the first optical axis is at a preset angle to the second optical axis.

19. A camera module, comprising the optical system according to claim 1 and an imaging element for converting an optical image formed by the optical system into an electrical signal.
